(19) United States
(12) Patent Application Publication
(10) Pub. No.: US 2025/0149570 A1
(43) Pub. Date: May 8, 2025

(54) ELECTROCHEMICAL CELL

(71) Applicant: Echion Technologies Limited, Cambridge (GB)

(72) Inventors: Harry Geary, Cambridge, Cambridgeshire (GB); Loubna El Ouatani, Cambridge, Cambridgeshire (GB); Prince Babbar, Cambridge, Cambridgeshire (GB); Alexander Groombridge, Cambridge, Cambridgeshire (GB)

(73) Assignee: Echion Technologies Limited, Cambridge (GB)

(21) Appl. No.: 18/836,883

(22) PCT Filed: Feb. 10, 2023
(86) PCT No.: PCT/GB2023/050307

§ 371 Date: Aug. 8, 2024

(30) Foreign Application Priority Data
Feb. 10, 2022 (GB) 2201720.6

(51) Int. Cl. H01M 4/485; H01M 4/02; H01M 4/525; H01M 10/0525; H01M 10/054

(52) U.S. Cl. CPC H01M 4/485; H01M 4/525; H01M 10/0525; H01M 10/054; H01M 2004/021; H01M 2004/027; H01M 2004/028

(57) ABSTRACT

The invention provides an electrochemical cell, such as a lithium-ion battery, comprising an anode, a cathode, and an electrolyte disposed between the anode and cathode; wherein the anode comprises an oxide comprising niobium as an active anode material, wherein the crystal structure of the oxide comprising niobium corresponds to the crystal structure of M^{II}₂Nb₃₄O₈₇, M^{III}Nb₁₁O₂₉, M^{III}Nb₄₉O₁₂₄, M^{IV}Nb₂₄O₆₂, M^{V}Nb₉O₂₅, M^{VI}Nb₁₂O₃₃, H—Nb₂O₅, or N—Nb₂O₅; wherein the cell has an N/P ratio >1 as defined in the specification.

### FIELD OF THE INVENTION

The present invention relates to electrochemical cells comprising oxides comprising niobium as active anode materials. Such cells are of interest as metal-ion batteries, such as lithium-ion or sodium-ion batteries.

### BACKGROUND

Lithium-ion (Li-ion) batteries are a commonly used type of rechargeable battery with a global market predicted to grow to $200bn by 2030. Li-ion batteries are the technology of choice for electric vehicles that have multiple demands across technical performance to environmental impact, providing a viable pathway for a green automotive industry.

A typical lithium-ion battery is composed of multiple cells connected in series or in parallel. Each individual cell is usually composed of an anode (negative polarity electrode) and a cathode (positive polarity electrode), separated by a porous, electrically insulating membrane (called a separator), immersed into a liquid (called an electrolyte) enabling lithium ions transport.

In most systems, the electrodes are composed of an active electrode material—meaning that it is able to chemically react with lithium ions to store and release them reversibly in a controlled manner—mixed if necessary with an electrically conductive additive (such as carbon) and a polymeric binder. A slurry of these components is coated as a thin film on a current collector (typically a thin foil of copper or aluminium), thus forming the electrode upon drying. Active anode materials and active cathode materials can be formulated into electrochemical cells with a wide range of N/P ratios—this ratio calculated from the capacity of the individual half-cells of the active anode material on its first lithiation and the active cathode material on its first delithiation. N/P is believed to affect at least cell lifetime and safety. However, deriving the optimum N/P ratio is a complex process, depending on the nature of each active material.

In the known Li-ion battery technology, the safety limitations of graphite anodes upon battery charging is a serious impediment to its application in high-power electronics, automotive and industry. Among a wide range of potential alternatives proposed recently, lithium titanate (LTO) and oxides comprising niobium are the main contenders to replace graphite as the active material of choice for high power, fast-charge applications.

Oxides comprising niobium have been known in academic literature for some time but have only recently gained interest for use in Li-ion cells. For example WO2021/074593, WO2021/074594, WO2021/245411, and WO2021/245410 disclose various substituted and/or oxygen-deficient oxides comprising niobium which were found to have good properties for use as active anode materials. However, there remains a need to optimise electrochemical cells which utilise oxides comprising niobium to aid the uptake of these promising active anode materials by the market.

### SUMMARY OF THE INVENTION

In a first aspect, the invention provides an electrochemical cell comprising an anode, a cathode, and an electrolyte disposed between the anode and cathode;
wherein the anode comprises an oxide comprising niobium as an active anode material, wherein the crystal structure of the oxide comprising niobium corresponds to the crystal structure of M^{II}₂Nb₃₄O₈₇, M^{III}Nb₁₁O₂₉, M^{III}Nb₄₉O₁₂₄, M^{IV}Nb₂₄O₆₂, M^{V}Nb₉O₂₅, M^{VI}Nb₁₂O₃₃, H—Nb₂O₅, or N—Nb₂O₅;
wherein the cell has an N/P ratio >1, wherein N/P is defined as:

$$\frac{\begin{matrix}areal loading ( {mgcm}^{- 2} ) ( anode ) \times active fraction ( wt \% ) ( anode ) \times \\ first lithiation capacity ( {mAhg}^{- 1} ) ( anode )\end{matrix}}{\begin{matrix}areal loading ( {mgcm}^{- 2} ) ( cathode ) \times active fraction ( wt \% ) \\ ( cathode ) \times first delithiation capacity ( {mAhg}^{- 1} ) ( cathode )\end{matrix}}$$

wherein:
areal loading (mgcm⁻²) is the dry loading of the electrode composition, not taking into account the current collector;
active fraction (wt %) is the percentage of the dry electrode composition that is active material;
first lithiation/delithiation capacity (mAhg⁻¹) is the specific capacity at C/10 at 25° C. for the first lithiation cycle for the anode or the first delithiation cycle for the cathode measured on an equivalent half-cell with a Li-metal counter electrode.

The inventors have found that having N/P>1 for an electrochemical cell comprising the specified active anode material provides surprisingly improved stability and lifetime as compared to N/P<1, as shown by the examples. It is theorised that designing the cell in this way offers full utilisation of the available cathode capacity, which can allow control over the full cell voltage limitations to prevent the active cathode material potential (i.e. the local voltage during full cell operation) from undesirable increases. An increased cathode voltage can result in over-lithiating the active material resulting in material degradation, and may exceed the stability limits of the electrolyte in use leading to further electrolyte degradation reactions at the surface of the cathode material. Moreover, designing the cell with N/P>1 is believed to improve lifetime and performance by minimising side reactions which may occur at low voltages between the electrolyte and the specified class of active anode material.

Preferably the electrochemical cell is a metal-ion battery such as a lithium-ion or a sodium-ion battery; most preferably a lithium-ion battery.

### SUMMARY OF THE FIGURES

FIG. 1 shows capacity fade as a function of 1C/1C cycle number for Example 1.

FIG. 2 shows DCIR growth as a function of cycle number for Example 1.

FIG. 3 shows reference capacity fade as a function of cycle number for Example 1.

FIG. 4 shows 1^{st} cycle formation data for Example 1.

FIG. 5 shows a 10C charge rate test for Example 1.

FIG. 6 shows a 10C discharge rate test for Example 1.

FIG. 7 shows 1^{st} cycle formation data for Example 2.

FIG. 8 shows a 10C charge rate test for Example 2.

FIG. 9 shows a 10C discharge rate test for Example 2.

FIG. 10 shows 1^{st} cycle formation data for Example 3.

FIG. 11 shows a 10C charge rate test for Example 3.

FIG. 12 shows a 10C discharge rate test for Example 3.

FIG. 13 shows 1^{st} cycle formation data for Example 4.

FIG. 14 shows a 10C charge rate test for Example 4.

FIG. 15 shows a 10C discharge rate test for Example 4.

FIG. E1 shows powder XRD of Samples E1-E4.

FIG. E2 shows powder XRD of Samples E5-E12.

FIG. F1 shows powder XRD of Samples F1-F4.

FIG. F2 shows powder XRD of Samples F5-F9.

FIG. G1 shows powder XRD of Samples G1-G9.

FIG. G2 shows powder XRD of Samples G10-G17.

FIG. H1 shows powder XRD of Samples H1, H2, H5, H10, H13, H14, and H17.

FIG. H2 shows confocal Raman spectra of Samples H2, H13, H15, H16, and H17. To collect the spectra, a laser excitation of 532 nm, attenuation of 10% and magnification of 50 was used on a Horiba Xplora Plus Raman microscope, with samples pressed into pellets at 10 MPa pressure, and placed on a glass slide. Spectra were recorded with on average an acquisition time of 15 s per scan, 3 repeats and 3 different sample locations in the spectral range of 0-2500 cm⁻¹.

FIG. I1 shows powder XRD of Samples I1, I2, I4, I5, I8, I9, I10, I11, and I12.

FIG. I2 shows powder XRD of Samples I6 and I7.

### DETAILED DESCRIPTION OF THE INVENTION

N/P is defined as:

$$\frac{\begin{matrix}areal loading ( {mgcm}^{- 2} ) ( anode ) \times active fraction ( wt \% ) ( anode ) \times \\ first lithiation capacity ( {mAhg}^{- 1} ) ( anode )\end{matrix}}{\begin{matrix}areal loading ( {mgcm}^{- 2} ) ( cathode ) \times active fraction ( wt \% ) \\ ( cathode ) \times first delithiation capacity ( {mAhg}^{- 1} ) ( cathode )\end{matrix}}$$

The areal loading (mgcm⁻²) is the dry loading of the electrode composition, not taking into account the current collector, for example not taking into account the aluminium foil used in the examples.

The active fraction (wt %) is the percentage of the dry electrode composition that is active material, for example 91 wt % NMC622 in the cathodes used in the examples.

The first lithiation/delithiation capacity (mAhg⁻¹) is the specific capacity at C/10 at 25° C. for the first lithiation cycle for the anode or the first delithiation cycle for the cathode measured on an equivalent half-cell with a Li-metal counter electrode. An equivalent half-cell can be understood to utilise the same electrode composition deposited at the same areal loading and active fraction as the full cell.

Cell charge rate is typically expressed as a “C-rate”. A 1C charge rate means a charge current such that the cell is fully charged in 1 h, 10C charge means that the battery is fully charged in 1/10th of an hour (6 minutes). C-rate may be defined from the reversible capacity of the cell within appropriate voltage limits, e.g. for a cell that exhibits 1.0 mAh cm⁻² capacity within the voltage limits of 1.2-3.15 V, a 1C-rate corresponds to a current density applied of 1.0 mA cm⁻².

The first lithiation/delithiation capacity is measured on an equivalent half-cell. For the anode, the first constant current C/10 lithiation (discharge, negative current) capacity (vs Li/Li+) at 25° C. is measured. For the cathode, the first constant current C/10 delithiation (charge, positive current) capacity (vs Li/Li+) at 25° C. is measured.

N/P is greater than one, e.g. ≥1.01. N/P may be in the range of >1-2, or 1.01-1.5, or preferably 1.05-1.3.

Active anode materials and active cathode materials are able to chemically react with metal ions, preferably lithium ions, to store and release them reversibly in a controlled manner. Oxides comprising niobium have a high redox voltage vs. Lithium >0.8V, enabling safe and long lifetime operation, crucial for fast charging battery cells. Moreover, niobium cations can have two redox reactions per atom, resulting in higher theoretical capacities than, for example, LTO. An oxide comprising niobium and at least one other cation may be referred to as a mixed niobium oxide.

The crystal structures of the oxides comprising niobium utilised in the invention can be classed as Wadsley-Roth crystal structures. These are considered to be a crystallographic off-stoichiometry of the MO₃ (ReO₃) crystal structure containing crystallographic shear, with simplified formula of MO₃₋ₓ. As a result, these structures typically contain [MO₆] octahedral subunits. The materials with these structures are believed to have advantageous properties for use as active electrode materials, e.g. in lithium-ion batteries. For instance, the open tunnel-like MO₃ crystal structure of these materials makes them ideal candidates for having high capacity for Li ion storage and high rate intercalation/de-intercalation.

The crystal structure of a material may be determined by analysis of X-ray diffraction (XRD) patterns, as is widely known. For instance, XRD patterns obtained from a given material can be compared to known XRD patterns to confirm the crystal structure, e.g. via public databases such as the ICDD crystallography database. Rietveld analysis and Pawley analysis can also be used to determine the crystal structure of materials, in particular for the unit cell parameters. Therefore, the oxide comprising niobium may have a crystal structure corresponding the specified crystal structure, as determined by X-ray diffraction. The term ‘corresponds’ may be understood to reflect that peaks in an X-ray diffraction pattern may be shifted by no more than 0.5 degrees (preferably shifted by no more than 0.25 degrees, more preferably shifted by no more than 0.1 degrees) from corresponding peaks in an X-ray diffraction pattern of the reference pattern for the crystal structure.

Reference patterns for the crystal structures utilised in the invention are available at:
M^{II}₂Nb₃₄O₈₇: e.g. Zn₂Nb₃₄O₈₇, ICDD crystallography database entry JCPDS 28-1478
M^{III}Nb₁₁O₂₉: e.g. AlNb₁₁O₂₉, ICDD crystallography database entry JCPDS 22-009
M^{III}Nb₄₉O₁₂₄: e.g. FeNb₄₉O₁₂₄, ICDD crystallography database entry JCPDS 22-0351
M^{IV}Nb₂₄O₆₂: e.g. ZrNb₂₄O₆₂, ICDD crystallography database entry JCPDS 01-072-1655
M^{V}Nb₉O₂₅: e.g. PNb₉O₂₅, ICDD crystallography database entry JCPDS 81-1304
M^{VI}Nb₁₂O₃₃: e.g. WNb₁₂O₃₃, ICDD crystallography database entry JCPDS 73-1322
H—Nb₂O₅: ICDD crystallography database entry JCPDS 37-1468
N—Nb₂O₅: Andersson, S., Zeitschrift für anorganische und allgemeine Chemie 1967 Vol. 351; Iss. 1-2; The Crystal Structure of N—Nb₂O₅, prepared in the presence of small amounts of LiF

The crystal structure of the oxide comprising niobium optionally corresponds to M^{II}₂Nb₃₄O₈₇, M^{II}Nb₁₁O₂₉, M^{V}Nb₉O₂₅, or H—Nb₂O₅; or corresponds to the crystal structure of M^{II}₂Nb₃₄O₈₇, M^{III}Nb₁₁O₂₉, or H—Nb₂O₅. Most preferably the crystal structure of the oxide comprising niobium corresponds to the crystal structure of M^{II}₂Nb₃₄O₈₇, for example the crystal structure of Zn₂Nb₃₄O₈₇.

The oxide comprising niobium is preferably in particulate form. The oxide comprising niobium may have a D₅₀ particle diameter in the range of 0.1-100 μm, or 0.5-50 μm, or 1-20 μm. These particle sizes are advantageous because they are easy to process and fabricate into electrodes. Moreover, these particle sizes avoid the need to use complex and/or expensive methods for providing nanosized particles. Nanosized particles (e.g. particles having a D₅₀ particle diameter of 100 nm or less) are typically more complex to synthesise and require additional safety considerations.

The oxide comprising niobium may have a D₁₀ particle diameter of at least 0.05 μm, or at least 0.1 μm, or at least 0.5 μm, or at least 1 μm. By maintaining a D₁₀ particle diameter within these ranges, the potential for parasitic reactions in a Li ion cell is reduced from having reduced surface area, and it is easier to process with less binder in the electrode slurry.

The oxide comprising niobium may have a D₉₀ particle diameter of no more than 200 μm, no more than 100 μm, no more than 50 μm, or no more than 20 μm. By maintaining a D₉₀ particle diameter within these ranges, the proportion of the particle size distribution with large particle sizes is minimised, making the material easier to manufacture into a homogenous electrode.

The term “particle diameter” refers to the equivalent spherical diameter (esd), i.e. the diameter of a sphere having the same volume as a given particle, where the particle volume is understood to include the volume of any intra-particle pores. The terms “Dₙ” and “Dₙ particle diameter” refer to the diameter below which n% by volume of the particle population is found, i.e. the terms “D₅₀” and “D₅₀ particle diameter” refer to the volume-based median particle diameter below which 50% by volume of the particle population is found. Where a material comprises primary crystallites agglomerated into secondary particles, it will be understood that the particle diameter refers to the diameter of the secondary particles. Particle diameters can be determined by laser diffraction. Particle diameters can be determined in accordance with ISO 13320:2009, for example using Mie theory.

The oxide comprising niobium may have a BET surface area in the range of 0.1-100 m²/g, or 0.2-50 m²/g, or 0.5-20 m²/g. In general, a low BET surface area is preferred in order to minimise the reaction of the oxide comprising niobium with the electrolyte, e.g. minimising the formation of solid electrolyte interphase (SEI) layers during the first charge-discharge cycle of an electrode comprising the material. However, a BET surface area which is too low results in unacceptably low charging rate and capacity due to the inaccessibility of the bulk of the oxide comprising niobium to metal ions in the surrounding electrolyte.

The term “BET surface area” refers to the surface area per unit mass calculated from a measurement of the physical adsorption of gas molecules on a solid surface, using the Brunauer-Emmett-Teller theory. For example, BET surface areas can be determined in accordance with ISO 9277:2010.

The oxide comprising niobium may be coated with carbon, e.g. to improve its surface electronic conductivity and/or to prevent reactions with electrolyte.

The oxide comprising niobium may have a protective coating; optionally the protective coating comprises niobium oxide, aluminium oxide, zirconium oxide, organic or inorganic fluorides, organic or inorganic phosphates, titanium oxide, lithiated versions thereof, and mixtures thereof.

The anode and cathode are typically of the form of an electrode composition (i.e. an anode composition or a cathode composition) in electrical contact with a current collector. A current collector is typically a metal foil, e.g. copper or aluminium foil.

Optionally, the oxide comprising niobium forms at least 5 wt. %, 10 wt. %, 50 wt. %, or 75 wt. % of the total active anode material in the anode. The oxide comprising niobium may form the sole active anode material in the anode.

The electrode composition may further comprise at least one other component selected from a binder, a conductive additive, a different active electrode material, and mixtures thereof. For instance, one anode composition comprises about 92 wt % oxide comprising niobium, about 5 wt % conductive additive (e.g. carbon black), and about 3 wt % binder (e.g. poly(vinyldifluoride)), based on the total dry weight of the anode composition.

Examples of suitable binders include polyvinylidene fluoride and its copolymers (PVDF), polytetrafluoroethylene (PTFE) and its copolymers, polyacrylonitrile (PAN), poly(methyl)methacrylate or poly(butyl)methacrylate, polyvinyl chloride (PVC), polyvinyl formal, polyetheramide, polymethacrylic acid, polyacrylamide, polyitaconic acid, polystyrene sulfonic acid, polyacrylic acid (PAA) and alkali metal salts thereof, modified polyacrylic acid (mPAA) and alkali metal salts thereof, cellulose-based polymers, carboxymethylcellulose (CMC), modified carboxymethylcellulose (mCMC), sodium carboxymethylcellulose (Na-CMC), polyvinylalcohol (PVA), alginates and alkali metal salts thereof, butadieneacrylonitrile rubber (NBR), hydrogenated form of NBR (HNBR), styrene-butadiene rubber (SBR) and polyimide. The binder may be present in the electrode composition at 0-30 wt %, or 0.1-10 wt %, or 0.1-5 wt %, based on the total dry weight of the electrode composition.

Conductive additives are preferably non-active materials which are included so as to improve electrical conductivity between the active electrode material and between the active electrode material and the current collector. The conductive additives may suitably be selected from graphite, carbon black, carbon fibers, vapor-grown carbon fibres (VGCF), carbon nanotubes, graphene, acetylene black, ketjen black, metal fibers, metal powders and conductive metal oxides. Preferred conductive additives include carbon black and carbon nanotubes. Conductive additives may be present in the electrode composition at 0-20 wt %, 0.1-10 wt %, or 0.1-5 wt %, based on the total dry weight of the electrode composition.

The active electrode material may be present in the electrode composition at 100-50 wt %, 99.8-80 wt %, or 99.8-90 wt %, based on the total dry weight of the electrode composition. When the active electrode material is present at 100 wt. % of the electrode composition it may form a solid-state electrode.

When a different active anode material is present in addition to the oxide comprising niobium, it may be selected from lithium titanium oxide, titanium niobium oxide, a different mixed niobium oxide, graphite, hard carbon, soft carbon, silicon, doped versions thereof, and mixtures thereof.

The oxide comprising niobium may be synthesised by conventional ceramic techniques. For example, it may be made by one or more of solid-state synthesis or sol-gel synthesis. Oxide comprising niobium may additionally be synthesised by one or more of alternative techniques commonly used, such as hydrothermal or microwave hydrothermal synthesis, solvothermal or microwave solvothermal synthesis, coprecipitation synthesis, spark or microwave plasma synthesis, combustion synthesis, electrospinning, spray pyrolysis, chemical vapour deposition, atomic layer deposition, and mechanical alloying.

The oxide comprising niobium may be provided by a method comprising steps of: providing one or more precursor materials; mixing said precursor materials to form a precursor material mixture; and heat treating the precursor material mixture in a temperature range from 400° C.-1350° C. or 800-1250° C., thereby providing the oxide comprising niobium.

To provide an oxide comprising niobium and an additional electronegative anion than oxygen the method may further comprise the steps of: mixing the oxide comprising niobium with a precursor comprising an additional electronegative anion to provide a further precursor material mixture; and heat treating the further precursor material mixture in a temperature range from 300-1200° C. or 800-1100° C. optionally under reducing conditions, thereby providing the oxide comprising niobium and an additional electronegative anion.

For example, to provide an oxide comprising niobium and N, the method may further comprise the steps of: mixing the oxide comprising niobium with a precursor comprising N (for example melamine or urea) to provide a further precursor material mixture; and heat treating the further precursor material mixture in a temperature range from 300-1200° C. under reducing conditions (for example under N₂), thereby providing the oxide comprising niobium and N.

For example, to provide an oxide comprising niobium and F, the method may further comprise the steps of: mixing the oxide comprising niobium with a precursor comprising F (for example polyvinylidene fluoride or NH₄F) to provide a further precursor material mixture; and heat treating the further precursor material mixture in a temperature range from 300-1200° C. under oxidising conditions (for example in air), thereby providing the oxide comprising niobium and F.

The method may comprise the further step of heat treating the oxide comprising niobium in a temperature range from 400-1350° C. or 800-1250° C. under reducing conditions, thereby inducing oxygen vacancies in the oxide comprising niobium.

The precursor materials for making the oxide comprising niobium may include one or more metal oxides, metal hydroxides, metal salts or ammonium salts. For example, the precursor materials may include one or more metal oxides or metal salts of different oxidation states and/or of different crystal structure. Examples of suitable precursor materials include but are not limited to: Nb₂O₅, Nb(OH)₅, Niobic Acid, NbO, Ammonium Niobate Oxalate, NH₄H₂PO₄, (NH₄)₂PO₄, (NH₄)₃PO₄, P₂O₅, H₃PO₃, Ta₂O₅, WO₃, ZrO₂, TiO₂, MoO₃, V₂O₅, ZrO₂, CuO, ZnO, Al₂O₃, K₂O, KOH, CaO, GeO₂, Ga₂O₃, SnO₂, CoO, Co₂O₃, Fe₂O₃, Fe₃O₄, MnO, MnO₂, NiO, Ni₂O₃, H₃BO₃, ZnO, Li₂CO₃, Na₂CO₃, H₃BO₃, NiO, Mg₅(CO₃)₄(OH)₂·5H₂O, and and MgO. The precursor materials may not comprise a metal oxide, or may comprise ion sources other than oxides. For example, the precursor materials may comprise metal salts (e.g. NO₃⁻, SO₃⁻) or other compounds (e.g. oxalates, carbonates). For the substitution of the oxygen anion with other electronegative anions, the precursors may include one or more organic compounds, polymers, inorganic salts, organic salts, gases, or ammonium salts; examples include but are not limited to: melamine, NH₄HCO₃, NH₃, NH₄F, PVDF, PTFE, NH₄Cl, NH₄Br, NH₄I, Br₂, Cl₂, I₂, ammonium oxychloride amide, and hexamethylenetetramine.

Some or all of the precursor materials may be particulate materials. Where they are particulate materials, preferably they have a D₅₀ particle diameter of less than 20 μm in diameter, for example from 10 nm to 20 μm. Providing particulate materials with such a particle diameter can help to promote more intimate mixing of precursor materials, thereby resulting in more efficient solid-state reaction during the heat treatment step. However, it is not essential that the precursor materials have an initial particle size of <20 μm in diameter, as the particle size of the one or more precursor materials may be mechanically reduced during the step of mixing said precursor materials to form a precursor material mixture.

The step of mixing the precursor materials to form a precursor material mixture and/or further precursor material mixture may be performed by a process selected from: dry or wet/solvated planetary ball milling, rolling ball milling, high energy ball milling, bead milling, pin milling, a classification step, high shear milling, air jet milling, steam jet milling, planetary mixing, powder blending, and/or impact milling. The force used for mixing/milling may depend on the morphology of the precursor materials. For example, where some or all of the precursor materials have larger particle sizes (e.g. a D₅₀ particle diameter of greater than 20 μm), the milling force may be selected to reduce the particle diameter of the precursor materials such that the such that the particle diameter of the precursor material mixture is reduced to 20 μm in diameter or lower. When the particle diameter of particles in the precursor material mixture is 20 μm or less, this can promote a more efficient solid-state reaction of the precursor materials in the precursor material mixture during the heat treatment step. The solid-state synthesis may also be undertaken in pellets formed at high pressure (>10 MPa) from the precursor powders.

The step of heat treating the precursor material mixture and/or the further precursor material mixture may be performed for a time of from 1 hour to 24 hours, more preferably from 3 hours to 18 hours. For example, the heat treatment step may be performed for 1 hour or more, 2 hours or more, 3 hours or more, 6 hours or more, or 12 hours or more. The heat treatment step may be performed for 24 hours or less, 18 hours or less, 16 hours or less, or 12 hours or less.

The step of heat treating the precursor material mixture may be performed in a gaseous atmosphere, preferably air. Suitable gaseous atmospheres include: air, N₂, Ar, He, CO₂, CO, O₂, H₂, NH₃ and mixtures thereof. The gaseous atmosphere may be a reducing atmosphere. Where it is desired to make an oxygen-deficient material, preferably the step of heat treating the precursor material mixture is performed in an inert or reducing atmosphere.

The step of heat treating the further precursor material mixture may be performed under reducing conditions. Reducing conditions include under an inert gas such as nitrogen, helium, argon; or under a mixture of an inert gas and hydrogen; or under vacuum. Preferably, the step of heat treating the further precursor material mixture comprises heating under inert gas.

The further step of heat treating the oxide comprising niobium and/or the oxide comprising niobium and additional electronegative anions optionally under reducing conditions may be performed for a time of from 0.5 hour to 24 hours, more preferably from 2 hours to 18 hours. For example, the heat treatment step may be performed for 0.5 hour or more, 1 hours or more, 3 hours or more, 6 hours or more, or 12 hours or more. The further step heat treating may be performed for 24 hours or less, 18 hours or less, 16 hours or less, or 12 hours or less. Reducing conditions include under an inert gas such as nitrogen, helium, argon; or under a mixture of an inert gas and hydrogen; or under vacuum. Preferably heating under reducing conditions comprises heating under inert gas.

In some methods it may be beneficial to perform a two-step heat treatment. For example, the precursor material mixture and/or the further precursor material mixture may be heated at a first temperature for a first length of time, follow by heating at a second temperature for a second length of time. Preferably the second temperature is higher than the first temperature. Performing such a two-step heat treatment may assist the solid-state reaction to form the desired crystal structure. This may be carried out in sequence, or may be carried out with an intermediate re-grinding step.

The method may include one or more post-processing steps after formation of the oxide comprising niobium. In some cases, the method may include a post-processing step of heat treating the oxide comprising niobium, sometimes referred to as ‘annealing’. This post-processing heat treatment step may be performed in a different gaseous atmosphere to the step of heat treating the precursor material mixture to form the oxide comprising niobium. The post-processing heat treatment step may be performed in an inert or reducing gaseous atmosphere. Such a post-processing heat treatment step may be performed at temperatures of above 500° C., for example at about 900° C. Inclusion of a post-processing heat treatment step may be beneficial to e.g. form deficiencies or defects in the oxide comprising niobium, for example to induce oxygen deficiency; or to carry out anion exchange on the formed oxide comprising niobium e.g. N exchange for the O anion.

The method may include a step of milling and/or classifying the oxide comprising niobium (e.g. impact milling, jet milling, steam jet milling, high energy milling, high shear milling, pin milling, air classification, wheel classification, sieving, cyclonic separation, bead milling) to provide a material with any of the particle size parameters given above.

The cathode comprises an active cathode material which may be selected from nickel-based layered oxides of the class LiNi₁₋ₓMₓO₂ where M=Co, Mn, Al such as NMCs—lithium nickel manganese cobalt oxides, NCAs—lithium cobalt aluminium oxides, and LCOs—lithium cobalt oxides; and LNMOs—lithium nickel manganese oxides (e.g. LiNi_{0.5}Mn_{1.5}O₄). For example, the active cathode material may be a lithium nickel manganese cobalt oxide. NCA (lithium nickel cobalt aluminium oxide) is a preferred active cathode material. Active cathode materials are widely available from commercial suppliers. Active cathode materials may be doped with additional cations and/or anions.

The choice of the active electrode material can affect the appropriate voltage range, including for determining the first lithiation/delithiation capacity. For example, appropriate voltage ranges may be LNMO: 5.2-3V, upper cut off 5.2V; NCA, NMC, and LCO: 4.5-2.7V, upper cut off 4.5V; oxide comprising niobium: 3-0V, lower cut off 0V. Narrower ranges may be LNMO: 5-3V, upper cut off 5V; NCA, NMC, and LCO: 4.3-2.7V, upper cut off 4.3V; oxide comprising niobium: 3V-1.0V, lower cut off 1.0V.

An appropriate voltage range may be determined empirically. For example, the voltage profile correlates to the change in energy state of the anode and cathode materials associated with removal or insertion of electrons and ions. The cut-off voltage for the cell may be selected to fall before a specific inflection point in the voltage profile which corresponds to a rise in energy state of one or both electrodes beyond a critical level which leads the crystal structure to decay to a lower energy structure at a rate which is significantly harmful to the cell's performance. The absolute voltage at which this happens is a function of the electrode potentials of both electrodes, but can be calculated by use of a common reference electrode and need not be determined experimentally for well-established material families with reliable standard electrochemical behaviour.

The cathode active material is preferably in particulate form, e.g. having a D₅₀ particle diameter in the range of 0.1-100 μm, or 0.5-50 μm, or 1-20 μm.

The electrolyte may include any material suitable for metal-ion battery operation, preferably lithium-ion battery operation. For example, the electrolyte may be a non-aqueous solution (e.g., an organic electrolytic solution). The electrolyte may include one or more non-aqueous solvents and a salt that is at least partially dissolved in the solvent. For example, the solvent may include an organic solvent, such as, e.g., ethylene carbonate (EC) and/or other carbonate based solvents, or butyrate, or acetate, or mixtures thereof. The solvent may include 1 M LiPF₆ dissolved in an aprotic solvent mixture, such as a 1:1 by weight of a mixture of ethylene carbonate and other carbonate based solvents or butyrate or acetate. Salts suitable for use in the invention include LiPF₆, LiSbF₆, LiBF₄, LiTFSI, LiFSI, LiAlCl₄, LiAsF₆, LiCIO₄, LiGaCl₄, LiC(SO₂CF₃)₃, LiN(CF₃SO₂)₂, Li(CF₃SO₃), LiB(C₆H₄O₂)₂, LiBOB (lithium bis(oxalate) borate), and LiDFOB (lithium difluoro (oxalate) borate). Low-viscosity solvents (e.g., organic solvents) suitable for use in the electrolyte may include, but are not limited to ethyl methyl carbonate (EMC), dioxlane (DOL), ethyl acetate (EA); propylene acetate (PA); butyl acetate (BA); methyl butyrate (MB); ethyl butyrate (EB); dimethyl carbonate (DMC); diethyl carbonate (DEC); 1,2-dimethoxyethane (DME); tetrahydrofuran (THF); methyl acetate (MA); diglyme (DGL); triglyme; tetraglyme; cyclic carbonates; cyclic esters; cyclic amides; propylene carbonate (PC); methyl propyl carbonate (MPC); acetonitrile; dimethyl sulfoxide (DMS); dimethyl formamide; dimethyl acetamide; gamma-butyrolactone (GBL); and N-methyl-pyrrolidinone (NMP); as well as various mixtures or combinations thereof.

An electrode may be made by forming a slurry of the active electrode material and a solvent. The slurry may comprise at least one other component selected from a binder, a conductive additive, a different active electrode material, and mixtures thereof. The slurry may be deposited onto a current collector and the solvent removed, thereby forming an electrode composition on the current collector. Further steps, such as heat treatment to cure any binders and/or calendaring of the electrode layer may be carried out as appropriate. For example, the solvent may be removed by drying e.g. at temperatures of 30-100° C. The electrode may be calendared to a density of 2-3.5 or 2.6-2.9 g cm⁻³. The electrode layer may have a thickness in the range of from 5 μm to 2 mm, preferably 5 μm to 1 mm, preferably 5 μm to 500 μm, preferably 5 μm to 200 μm, preferably 5 μm to 100 μm, preferably 5 μm to 50 μm.

Alternatively, the slurry may be formed into a freestanding film or mat comprising the active electrode material, for instance by casting the slurry onto a suitable casting template, removing the solvent and then removing the casting template. The resulting film or mat is in the form of a cohesive, freestanding mass which may then be bonded to a current collector by known methods.

In a modification of the invention the N/P ratio may be <1, such as 0.7-0.95, when the anode comprises any of the oxides comprising niobium disclosed herein.

### Formula 1

In a preferred aspect, the oxide comprising niobium has the formula M1ₐM2₂₋ₐM3_{b}Nb_{34-b}O_{87-c-d}Q_{d} (Formula 1), wherein:
M1 and M2 are different;
M1 is selected from Mg, Ca, Sr, Y, La, Ce, Ti, Zr, Hf, V, Nb, Ta, Cr, Mo, W, Mn, Fe, Co, Ni, Cu, Zn, Cd, B, Al, Ga, In, Si, Ge, Sn, Pb, P, Sb, Bi and mixtures thereof;
M2 is Zn or Cu;
M3 is selected from Mg, Ca, Sr, Y, La, Ce, Ti, Zr, Hf, V, Ta, Cr, Mo, W, Mn, Fe, Co, Ni, Cu, Zn, Cd, B, Al, Ga, In, Si, Ge, Sn, Pb, P, Sb, Bi, and mixtures thereof;
Q is selected from F, Cl, Br, I, N, S, Se, and mixtures thereof;
0≤a<1.0; 0≤b≤3.4; −0.55≤c≤4.35; 0≤d≤4.35;
one or more of a, b, c, and d does not equal 0; and
when a, b, and d equal zero, c is greater than zero.

Formula 1 represents an example of an oxide comprising niobium having a crystal structure corresponding to the crystal structure of M¹²Nb₃₄O₈₇. Accordingly, this formula and the other formulas below may be used to define the active anode material used in the invention without the need to define the crystal structure.

It will be understood that Formula 1 does not correspond to stoichiometric Zn₂Nb₃₄O₈₇ or Cu₂Nb₃₄O₈₇. It has been found that modifying Zn₂Nb₃₄O₈₇ or Cu₂Nb₃₄O₈₇ by either incorporating further cations (M1 and/or M3), and/or by creating an induced oxygen deficiency or excess, and/or by forming mixed anion materials (comprising O and Q), the resulting material has improved electrochemical properties, and in particular improved electrochemical properties when used as an anode material. When a>0, Formula 1 is modified by partial substitution of M2 (Zn or Cu) by M1. When b>0 Formula 1 is modified by partial substitution of Nb by M3. When c≠0, the Formula 1 is modified by oxygen deficiency or excess. When d>0 the Formula 1 is modified by partial substitution of O by Q. The inventors have found that materials according to Formula 1 have improved electronic conductivity, and improved coulombic efficiency, and improved de-lithiation voltage at high C-rates, compared to unmodified ‘base’ Zn₂Nb₃₄O₈₇, as shown by the present examples.

Zn₂Nb₃₄O₈₇ or Cu₂Nb₃₄O₈₇ may be considered to have a ReO₃-derived MO₃₋ₓ crystal structure such as a Wadsley-Roth crystal structure. Wadsley-Roth crystal structures are considered to be a crystallographic off-stoichiometry of the MO₃ (ReO₃) crystal structure containing crystallographic shear, with simplified formula of MO₃₋ₓ. As a result, these structures typically contain [MO₆] octahedral subunits in their crystal structure. The materials with these structures are believed to have advantageous properties for use as active electrode materials, e.g. in lithium-ion batteries.

The open tunnel-like MO₃ crystal structure of these materials also makes them ideal candidates for having high capacity for Li ion storage and high rate intercalation/de-intercalation. The crystallographic off-stoichiometry present in crystal structure causes the Wadsley-Roth crystallographic superstructure. These superstructures, compounded by other qualities such as the Jahn-Teller effect and enhanced crystallographic disorder by making use of multiple mixed cations, stabilise the crystal and keep the tunnels open and stable during intercalation, enabling extremely high rate performance due to high Li-ion diffusion rates (reported as ˜10⁻¹³ cm² s⁻¹).

The crystal formulae of Zn₂Nb₃₄O₈₇ or Cu₂Nb₃₄O₈₇ can be described as having a 3×4×∞ crystallographic block structure composed of [MO₆] octahedra, where M is Cu, Zn, or Nb. The Cu and Zn octahedra may be randomly distributed in the structure or may have a preference for particular sites such as at the edge, or corner of the blocks. This equates to ⅔ of one Zn or Cu cation per block. The crystal formulae of Zn₂Nb₃₄O₈₇ can be described as an isostructural phase to Cu₂Nb₃₄O₈₇ with slight differences in some bond lengths and bond enthalpies.

Preferably, the crystal structure of the oxide of Formula 1, as determined by X-ray diffraction, corresponds to the crystal structure of Zn₂Nb₃₄O₈₇ or Cu₂Nb₃₄O₈₇; most preferably Zn₂Nb₃₄O₈₇. In this way, it can be confirmed that the ‘base’ material has been modified without significantly affecting the crystal structure, which is believed to have advantageous properties for use as an active anode material. The crystal structure of Zn₂Nb₃₄O₈₇ may be found at ICDD crystallography database entry JCPDS 28-1478.

The oxide of Formula 1 with cation/anion exchange may have unit cell parameters a, b, and c wherein a is 15.52-15.58 Å preferably 15.53-15.57 Å, b is 3.79-3.84 Å preferably 3.80-3.83 Å, and c=20.53-20.66 Å preferably 20.54-20.65 Å. The oxide of Formula 1 may have unit cell parameters α and γ each being about 90°, preferably wherein α=γ=90°; whereas β is 113.05-113.75° preferably 113.08-113.69° and unit cell volume is 1115-1135 Å³ preferably 1117-1133 Å³. Unit cell parameters may be determined by X-ray diffraction. The oxide of Formula 1 may have a crystallite size of 5-150 nm, preferably 30-60 nm, determined according to the Scherrer equation.

By ‘and mixtures thereof’, it is intended that M1, M3, and Q may each represent two or more elements from their respective lists. An example of such a material is Mg_{0.1}Ge_{0.1}Zn_{1.8}Nb₃₄O_{87.1}. Here, M1 is Mg_{a′}Ge_{a″} (where a′+a″=a), M2 is Zn, a=0.2, b=0, c=−0.1, d=0. Here, c has been calculated assuming that each cation adopts its typical oxidation state, i.e. Mg²⁺, Ge⁴⁺, Zn²⁺, and Nb⁵⁺.

The precise values of a, b, c, d within the ranges defined may be selected to provide a charge balanced, or substantially charge balanced, crystal structure. Additionally or alternatively, the precise values of a, b, c, d within the ranges defined may be selected to provide a thermodynamically stable, or thermodynamically metastable, crystal structure.

When exchange of the cations or anions in the structure (i.e. Zn, Cu, Nb, O) have taken place without preserving the initial valency, this can give rise to both oxygen deficiency and excess. For example, a material that substitutes Zn²⁺ by Ge⁴⁺ to some extent will demonstrate minor oxygen excess (i.e. ZnO vs GeO₂), whereas substitution of Nb⁵⁺ by Al³⁺ will show a minor oxygen deficiency (i.e. Nb₂O₅ vs Al₂O₃). Oxygen deficiency can also be induced through thermal treatment in inert or reducing conditions, which results in induced oxygen vacancy defects in the structure.

There may be partial oxidation or partial reduction to compensate for exchange which does not preserve the initial valency. For example, substitution of Zn²⁺ by Ge⁴⁺ may be compensated at least in part by reduction of some Nb⁵⁺ to Nb⁴⁺.

M2 is Zn or Cu. Preferably, M2 is Zn in which case the material is based on Zn₂Nb₃₄O₈₇.

M1 is a cation which substitutes for M2 in the crystal structure. M1 may be selected from Mg, Ti, Zr, Hf, V, Nb, Ta, Cr, Mo, W, Mn, Fe, Co, Ni, Cu, Zn, Cd, B, Al, Ga, Si, Ge, Sn, P, and mixtures thereof; preferably Mg, Ti, Zr, V, Nb, Cr, Mo, W, Mn, Fe, Co, Ni, Cu, Zn, B, Al, Si, Ge, P, and mixtures thereof; most preferably Mg, Zr, V, Cr, Mo, W, Fe, Cu, Zn, Al, Ge, P, and mixtures thereof. M1 may have a different valency than M2²⁺. This gives rise to oxygen deficiency or excess. Optionally, M1 has an equal or higher valency than M2²⁺, preferably higher.

M1 may also be selected from each of the specific elements used as such in the reference examples.

When more than one element is present as M1 or M3 it will be understood that the valency refers to M1 or M3 as a whole. For example, if 25 at % of M1 is Ti and 75 at % of M1 is W the valency M1 is 0.25×4 (the contribution from Ti)+0.75×6 (the contribution from W).

M1 preferably has a different ionic radius than M2²⁺, most preferably a smaller ionic radius. This gives rise to changing unit cell size and local distortions in crystal structure, providing the advantages discussed herein. Ionic radii referred to herein are the Shannon ionic radii (available at R. D. Shannon, Acta Cryst., A32, 1976, 751-767) at the coordination and valency that the ion would be expected to adopt in the crystal structure of the oxide comprising niobium. For example, the crystal structure of Zn₂Nb₃₄O₈₇ includes Nb⁵⁺O₆ octahedra and Zn²⁺O₆ octahedra. Accordingly, when M3 is Zr the ionic radius is taken as that of 6-coordinate Zr²⁺ since this is typical valency and coordination of Zr when replacing Nb in Zn₂Nb₃₄O₈₇.

The amount of M1 is defined by a, meeting the criterion 0≤a<1.0. a may be 0≤a≤0.6, preferably 0≤a≤0.2. Most preferably, a>0, for example a≥0.01. Higher values of a may be more readily achieved when M1 has the same valency as M2. When M1 comprises a cation with a 2+ valency (for example Mg) a may be 0≤a<1.0. When M1 does not comprise a cation with a 2+ valency a may be 0≤a≤0.15.

M3 is a cation which substitutes for Nb in the crystal structure. M3 may be selected from Mg, Ti, Zr, Hf, V, Ta, Cr, Mo, W, Mn, Fe, Co, Ni, Cu, Zn, Cd, B, Al, Ga, Si, Sn, P, and mixtures thereof; preferably Mg, Ti, Zr, V, Cr, Mo, W, Mn, Fe, Co, Ni, Cu, Zn, Cd, B, Al, Si, P, and mixtures thereof; most preferably Ti, Zr, V, Cr, Mo, W, Fe, Cu, Zn, Al, P, and mixtures thereof. M3 may have a different valency than Nb⁵⁺. This gives rise to oxygen deficiency or excess. Preferably, M3 has a lower valency than Nb⁵⁺. This gives rise to oxygen deficiency, i.e. the presence of oxygen vacancies providing the advantages discussed herein.

M3 may also be selected from each of the specific elements used as such in the reference examples.

M3 preferably has a different ionic radius than Nb⁵⁺, most preferably a larger ionic radius. This gives rise to changing unit cell size and local distortions in crystal structure, providing the advantages discussed herein.

Optionally, M1 does not comprise Nb and M3 does not comprise Zn and/or Cu.

The amount of M3 is defined by b, meeting the criterion 0≤b≤3.4. b may be 0≤b≤1.5, preferably 0≤b≤0.3. In each of these cases b may be >0, e.g. b≥0.01. Higher values of b may be more readily achieved when M3 has the same valency as Nb⁵⁺. When M3 comprises a cation with a 5+ valency (for example Ta) b may be 0≤b≤3.4. When M3 does not comprise a cation with a 5+ valency b may be 0≤b≤0.2.

Surprisingly, it has been found that the cation-substitution approach in accordance with Formula 1 can lead to an oxide comprising niobium that is more economical to synthesise than the unmodified ‘base’ material. Preferably, both a and b are >0. When both a and b are >0 the ‘base’ material has been substituted at both the M2 site and at the Nb site.

c reflects the oxygen content of the oxide comprising niobium. When c is greater than 0, it forms an oxygen-deficient material, i.e. the material has oxygen vacancies. Such a material would not have precise charge balance without changes to cation oxygen state, but is considered to be “substantially charge balanced” as indicated above. Alternatively, c may equal 0, in which it is not an oxygen-deficient material. c may be below 0, which is a material with oxygen-excess. c may be −0.25≤c≤4.35.

When c is 4.35, the number of oxygen vacancies is equivalent to 5% of the total oxygen in the crystal structure. c may be greater than 0.0435, greater than 0.087, greater than 0.174, or greater than 0.435. c may be between 0 and 2, between 0 and 0.75, between 0 and 0.5, or between 0 and 0.25. For example, c may satisfy 0.01≤c≤4.35. When the material is oxygen-deficient, for example with induced oxygen deficiency, the electrochemical properties of the material may be improved, for example, resistance measurements may show improved conductivity in comparison to equivalent non-oxygen-deficient materials. As will be understood, the percentage values expressed herein are in atomic percent.

The invention relates to oxide comprising niobium which may comprise oxygen vacancies (oxygen-deficient oxides comprising niobium), or which may have oxygen excess. Oxygen vacancies may be formed in an oxide comprising niobium by the sub-valent substitution of a base material as described above, and oxygen excess may be formed in an oxide comprising niobium by substitution for increased valency. Oxygen vacancies may also be formed by heating an oxide comprising niobium under reducing conditions, which may be termed forming induced oxygen deficiency. The amount of oxygen vacancies and excess may be expressed relative to the total amount of oxygen in the base material, i.e. the amount of oxygen in the un-substituted material (e.g. Zn₂Nb₃₄O₈₇).

A number of methods exist for determining whether oxygen deficiency, e.g. oxygen vacancies, is present in a material. For example, Thermogravimetric Analysis (TGA) may be performed to measure the mass change of a material when heated in air atmosphere. A material comprising oxygen vacancies can increase in mass when heated in air due to the material “re-oxidising” and the oxygen vacancies being filled by oxide anions. The magnitude of the mass increase may be used to quantify the concentration of oxygen vacancies in the material, on the assumption that the mass increase occurs entirely due to the oxygen vacancies being filled. It should be noted that a material comprising oxygen vacancies may show an initial mass increase as the oxygen vacancies are filled, followed by a mass decrease at higher temperatures if the material undergoes thermal decomposition. Moreover, there may be overlapping mass loss and mass gain processes, meaning that some materials comprising oxygen vacancies may not show a mass gain (and sometimes not a mass loss or gain) during TGA analysis.

Other methods of determining whether oxygen deficiency e.g. oxygen vacancies, is present include Raman spectroscopy, electron paramagnetic resonance (EPR), X-ray photoelectron spectroscopy (XPS, e.g. of oxygen 1s and/or and of cations in a mixed oxide), X-ray absorption near-edge structure (XANES, e.g. of cations in a mixed metal oxide), and TEM (e.g. scanning TEM (STEM) equipped with high-angle annular darkfield (HAADF) and annular bright-field (ABF) detectors). The presence of oxygen deficiency can be qualitatively determined by assessing the colour of a material relative to a non-oxygen-deficient sample of the same material, indicative of changes to its electronic band structure through interaction with light. For example, non-oxygen deficient stoichiometric Zn₂Nb₃₄O₈₇ has a white colour. Zn₂Nb₃₄O_{<87} with induced oxygen deficiency has a grey/black. The presence of vacancies can also be inferred from the properties, e.g. electrical conductivity, of a stoichiometric material compared to those of an oxygen-deficient material.

When d>0, additional anions Q are introduced into the oxide comprising niobium. Due to their differing electronic structure (i.e. F⁻ vs O²⁻), and differing ionic radii (6-coordinate O²⁻=1.40 Å, 6-coordinate F⁻=1.33 Å) they may improve electrochemical performance in the active material. This is due to altering unit cell characteristics with differing ionic radii allowing for improved Li ion capacity, or improved Coulombic efficiencies by improving reversibility. They may additionally improve electrical conductivity as for oxygen vacancy defects, or sub-valent cation substitutions, by altering the electronic structure of the crystal (i.e. doping effects). d may be 0≤d≤3.0, or 0≤d≤2.17. In each of these cases d may be >0. Q may be selected from F, Cl, N, S, and mixtures thereof; or F, N, and mixtures thereof; or Q is F.

Optionally d=0, in which case Formula 1 is M1ₐM2₂₋ₐM3_{b}Nb_{34-b}O_{87-c} where M1, M2, M3, a, b, and c are as defined herein. Advantageously, materials where d=0 are free from anion Q and may be easier to synthesise.

When a>0 and b=d=0 Formula 1 is M1ₐM2₂₋ₐNb₃₄O_{87-c} where M1, M2, a, and c are as defined herein, for example 0≤c≤4.35. This represents a material which has been modified at the M2 site and optionally modified by induced oxygen deficiency. Such materials represent a particularly effective way to improve the properties of the ‘base’ oxide M2₂Nb₃₄O₈₇ by simple synthetic means. Here, M1 may represent Ti, Mg, V, Cr, W, Zr, Mo, Cu, Ga, Ge, Ni, Al, Hf, Ta, Zn and mixtures thereof; preferably Ti, Mg, V, Cr, W, Zr, Mo, Ga, Ge, Al, Zn, and mixtures thereof.

When a=b=d=0 and c>0 Formula 1 has the composition M2₂Nb₃₄O_{87-c} where M2 and c are as defined herein. This represents a material which has been modified solely by inducing oxygen deficiency, providing improved properties as shown in the examples. For example, materials where a=b=d=0 and c>0 have been found to have surprisingly improved electronic conductivity.

It will be understood that the discussion of the variables of Formula 1 (M1, M2, M3, Q, a, b, c, and d) is intended to be read in combination. For example, preferably M1 is selected from Mg, Ti, Zr, V, Nb, Cr, Mo, W, Mn, Fe, Co, Ni, Cu, Zn, B, Al, Si, Ge, P, and mixtures thereof and M3 is selected from Mg, Ti, Zr, V, Cr, Mo, W, Mn, Fe, Co, Ni, Cu, Zn, Cd, B, Al, Si, P, and mixtures thereof and Q is selected from F, Cl, N, S, and mixtures thereof. Preferably 0≤a≤0.6, 0≤b≤1.5, 0≤c≤4.35, and 0≤d≤3.0.

For example, Formula 1 may be M1ₐM2₂₋ₐM3_{b}Nb_{34-b}O_{87-c-d}Q_{d}, wherein:
M1 and M2 are different;
M1 is selected from Mg, Ti, Zr, V, Nb, Cr, Mo, W, Mn, Fe, Co, Ni, Cu, Zn, B, Al, Si, Ge, P, and mixtures thereof;
M2 is Zn or Cu;
M3 is selected from Mg, Ti, Zr, V, Cr, Mo, W, Mn, Fe, Co, Ni, Cu, Zn, Cd, B, Al, Si, P, and mixtures thereof;
Q is selected from F, N, and mixtures thereof;
0≤a≤0.6; 0≤b≤1.5; −0.5≤c≤4.35; 0≤d≤4.35;
one or more of a, b, c, and d does not equal 0; and
when a, b, and d equal zero, c is greater than zero.

M1, M3, and Q may also be selected from each of the specific elements used as these dopants in the examples.

Optionally, the oxide of Formula 1 is free from titanium.

In a particularly preferred aspect, Formula 1 may be M1ₐZn₂₋ₐM3_{b}Nb_{34-b}O_{87-c}, wherein:
M1 is selected from Mg, Zr, V, Cr, Mo, W, Fe, Cu, Al, Ge, P, and mixtures thereof;
M3 is selected from Ti, Zr, V, Cr, Mo, W, Fe, Cu, Zn, Al, P, and mixtures thereof;
0<a<1.0; 0<b≤3.4; −0.5≤c≤4.35.

Formula 1 may be M1ₐM2₂₋ₐM3_{b}Nb_{34-b}O_{87-c}, wherein:
M1 is selected from Cr, Al, Ge, and mixtures thereof, preferably wherein M1 is Cr;
M2 is Zn or Cu, preferably wherein M2 is Zn;
M3 is selected from Ti, Zr, Fe, and mixtures thereof and optionally comprises Ti, preferably wherein M3 is selected from Ti, Zr, and mixtures thereof and optionally comprises Ti, most preferably wherein M3 is Ti;
0<a<1.0, preferably 0.01<a<1.0;
0<b≤1.5, preferably 0.01<b<1.0;
−0.5≤c≤4.35, preferably −0.5≤c≤2, most preferably c=0.

Formula 1 may be CrₐZn₂₋ₐM3_{b}Nb_{34-b}O_{87-c}, wherein:
M3 is selected from Ti, Zr, and mixtures thereof and optionally comprises Ti, preferably wherein M3 is Ti;
0.01<a<1.0, preferably 0.1<a<1.0;
0.01<b<1.0, preferably 0.1<b<1.0;
−0.5≤c≤2, preferably c=0.

The oxide of Formula 1 may further comprise Li and/or Na. For example, Li and/or Na may enter the crystal structure when the oxide comprising niobium is used in a metal-ion battery electrode.

### Formula 2

The oxide comprising niobium may have the formula M4ₐAl₁₋ₐM5_{b}Nb_{11-b}O_{29-c-d}Q_{d} (Formula 2), wherein:
M4 is selected from Mg, Ca, Sr, Y, La, Ce, Zr, Hf, V, Nb, Ta, Cr, Mo, W, Mn, Fe, Co, Ni, Cu, Zn, Cd, B, Ga, In, Si, Ge, Sn, Pb, P, Sb, Bi and mixtures thereof;
M5 is selected from Mg, Ca, Sr, Y, La, Ce, Zr, Hf, V, Ta, Cr, Mo, W, Mn, Fe, Co, Ni, Cu, Zn, Cd, B, Al, Ga, In, Si, Ge, Sn, Pb, P, Sb, Bi, and mixtures thereof;
Q is selected from F, Cl, Br, I, N, S, Se, and mixtures thereof;
0≤a<0.5; 0≤b≤1; −0.5≤c≤1.45; 0≤d≤1.45;
one or more of a, b, and d does not equal 0.

Formula 2 represents an example of an oxide comprising niobium having a crystal structure corresponding to the crystal structure of M^{III}Nb₁₁O₂₉.

It will be understood that Formula 2 does not correspond to stoichiometric AlNb₁₁O₂₉. The present inventors have found that by modifying AlNb₁₁O₂₉ by either incorporating further cations (M4 and/or M5), and/or by forming mixed anion materials (comprising O and Q), and optionally by creating an induced oxygen deficiency or excess, the resulting material has improved electrochemical properties, and in particular improved electrochemical properties when used as an anode material. When a>0, Formula 2 is modified by partial substitution of Al by M4. When b>0 Formula 2 is modified by partial substitution of Nb by M5. When c≠0, Formula 2 is modified by oxygen deficiency or excess. When d>0 Formula 2 is modified by partial substitution of O by Q. The inventors have found that materials according to Formula 2 have improved specific capacity, and improved capacity retention at high C-rates, compared to unmodified ‘base’ AlNb₁₁O₂₉, as shown by the present examples. These are important results in demonstrating the advantages of the material for use in high-power batteries designed for fast charge/discharge. Moreover, since 0≤a<0.5, Al is the major non-Nb cation in Formula 2. Since Al³⁺ is not redox active it is surprising that Formula 2 has the excellent properties for use as an active electrode material shown by the present examples. Typical prior approaches have focussed on redox-active cations as the major non-Nb cation, e.g. transition metals such as Cr and Fe.

AlNb₁₁O₂₉ may be considered to have a ReO₃-derived MO₃₋ₓ crystal structure such as a Wadsley-Roth crystal structure. The crystal structure of AlNb₁₁O₂₉ can be described as having a 3×4×∞ crystallographic block structure composed of [MO₆]octahedra, where M is Al, or Nb. The Al octahedra may be randomly distributed in the structure or may have a preference for particular sites such as at the edge, or corner of the blocks. This equates to one Al cation per block.

Preferably, the crystal structure of the oxide of Formula 2, as determined by X-ray diffraction, corresponds to the crystal structure of AlNb₁₁O₂₉. In this way, it can be confirmed that the ‘base’ material has been modified without significantly affecting the crystal structure, which is believed to have advantageous properties for use as an active electrode material. The crystal structure of AlNb₁₁O₂₉ may be found at ICDD crystallography database entry JCPDS 22-009.

The oxide of Formula 2 with cation/anion exchange may have unit cell parameters a, b, and c wherein a is 15.52-15.58 Å preferably 15.53-15.57 Å, b is 3.79-3.83 Å preferably 3.80-3.82 Å, and c=20.51-20.55 Å preferably 20.52-20.54 Å. The oxide of Formula 2 may have unit cell parameters α and γ each being about 90°, preferably wherein α=γ=90°; whereas β is 113.00-113.70° preferably 113.05-113.68° and unit cell volume is 1116-1120 Å³ preferably 1117-1119 Å³. Unit cell parameters may be determined by X-ray diffraction. The oxide of Formula 2 may have a crystallite size of 5-150 nm, preferably 40-70 nm, determined according to the Scherrer equation.

By ‘and mixtures thereof’, it is intended that M4, M5, and Q may each represent two or more elements from their respective lists. An example of such a material is Zn_{0.05}Ga_{0.05}Al_{0.9}Nb₁₁O_{28.975}. Here, M4 is Zn_{a′}Ga_{a″} (where a′+a″=a), a=0.1, b=0, c=0.025, d=0. Here, c has been calculated assuming that each cation adopts its typical oxidation state, i.e. Zn²⁺, Ga³⁺, Al³⁺.

The precise values of a, b, c, d within the ranges defined may be selected to provide a charge balanced, or substantially charge balanced, crystal structure. Additionally or alternatively, the precise values of a, b, c, d within the ranges defined may be selected to provide a thermodynamically stable, or thermodynamically metastable, crystal structure.

When exchange of the cations or anions in the structure (i.e. Al, Nb, O) have taken place without preserving the initial valency, this can give rise to both oxygen deficiency and excess. For example, a material that substitutes Al³⁺ by Ge⁴⁺ to some extent will demonstrate minor oxygen excess (i.e. Al₂O₃ vs GeO₂), whereas substitution of Nb⁵⁺ by Al³⁺ will show a minor oxygen deficiency (i.e. Nb₂O₅ vs Al₂O₃). Oxygen deficiency can also be induced through thermal treatment in inert or reducing conditions, which results in induced oxygen vacancy defects in the structure.

There may be partial oxidation or partial reduction to compensate for exchange which does not preserve the initial valency. For example, substitution of Al³⁺ by Ge⁴⁺ may be compensated at least in part by reduction of some Nb⁵⁺ to Nb⁴⁺.

M4 is a cation which substitutes for Al in the crystal structure. M4 may be selected from Mg, Zr, Hf, V, Nb, Ta, Cr, Mo, W, Mn, Fe, Co, Ni, Cu, Zn, Cd, B, Ga, Si, Ge, Sn, P, and mixtures thereof; preferably Mg, Zr, V, Cr, Mo, W, Mn, Fe, Co, Ni, Cu, Zn, B, Ga, Si, Ge, P, and mixtures thereof; most preferably Mg, Zr, Mo, W, Cu, Zn, Ga, Ge, P, and mixtures thereof. M4 may have a different valency than Al³⁺. This gives rise to oxygen deficiency or excess. Optionally, M4 has an equal or lower valency than Al³⁺, preferably lower.

M4 may also be selected from each of the specific elements used as such in the reference examples. For instance, preferably M4 is Ga.

When more than one element is present as M4 or M5 it will be understood that the valency refers to M4 or M5 as a whole. For example, if 25 at % of M4 is Zr and 75 at % of M4 is W the valency M4 is 0.25×4 (the contribution from Zr)+0.75×6 (the contribution from W).

M4 preferably has a different ionic radius than Al³⁺, most preferably a larger ionic radius. This gives rise to changing unit cell size and local distortions in crystal structure, providing the advantages discussed herein. Ionic radii referred to herein are the Shannon ionic radii (available at R. D. Shannon, Acta Cryst., A32, 1976, 751-767) at the coordination and valency that the ion would be expected to adopt in the crystal structure of Formula 2. For example, the crystal structure of AlNb₁₁O₂₉ includes Nb⁵⁺O₆ octahedra. Accordingly, when M5 is Zr the ionic radius is taken as that of 6-coordinate Zr⁴⁺ since this is typical valency and coordination of Zr when replacing Nb in AlNb₁₁O₂₉.

The amount of M4 is defined by a, meeting the criterion 0≤a<0.5. a may be 0≤a≤0.4, preferably 0≤a≤0.2. Most preferably, a>0, for example a≥0.01. Higher values of a may be more readily achieved when M4 has the same valency as Al³⁺. When M4 comprises a cation with a 3+ valency (for example Ga) a may be 0≤a<0.5. When M4 does not comprise a cation with a 3+ valency a may be 0≤a≤0.1.

M5 is a cation which substitutes for Nb in the crystal structure. M5 may be selected from Mg, Zr, Hf, V, Ta, Cr, Mo, W, Mn, Fe, Co, Ni, Cu, Zn, Cd, B, Al, Ga, Si, Sn, P, and mixtures thereof; preferably Mg, Zr, V, Cr, Mo, W, Mn, Fe, Co, Ni, Cu, Zn, Cd, B, Al, Si, P, and mixtures thereof; most preferably Zr, V, Cr, Mo, W, Fe, Cu, Zn, Al, P, and mixtures thereof. M5 may have a different valency than Nb⁵⁺. This gives rise to oxygen deficiency or excess. Preferably, M5 has a lower valency than Nb⁵⁺. This gives rise to oxygen deficiency, i.e. the presence of oxygen vacancies providing the advantages discussed herein.

M5 may also be selected from each of the specific elements used as such in the reference examples.

M5 preferably has a different ionic radius than Nb⁵⁺, most preferably a larger ionic radius. This gives rise to changing unit cell size and local distortions in crystal structure, providing the advantages discussed herein.

The amount of M5 is defined by b, meeting the criterion 0≤b≤1. b may be 0≤b≤0.5, preferably 0≤b≤0.1. In each of these cases b may be >0, e.g. b≥0.01. Higher values of b may be more readily achieved when M5 has the same valency as Nb⁵⁺. When M5 comprises a cation with a 5+ valency (for example Ta) b may be 0≤b≤1. When M5 does not comprise a cation with a 5+ valency b may be 0≤b≤0.05.

Optionally, both a and b are >0. When both a and b are >0 the ‘base’ material has been substituted at both the Al site and at the Nb site.

c reflects the oxygen content of Formula 2. When c is greater than 0, it forms an oxygen-deficient material, i.e. the material has oxygen vacancies. Such a material would not have precise charge balance without changes to cation oxygen state, but is considered to be “substantially charge balanced” as indicated above. Alternatively, c may equal 0, in which it is not an oxygen-deficient material. c may be below 0, which is a material with oxygen-excess. c may be −0.25≤c≤1.45.

When c is 1.45, the number of oxygen vacancies is equivalent to 5% of the total oxygen in the crystal structure. c may be greater than 0.0145, greater than 0.029, greater than 0.0435, or greater than 0.145. c may be between 0 and 1, between 0 and 0.75, between 0 and 0.5, or between 0 and 0.25. For example, c may satisfy 0.01≤c≤1.45. When the material is oxygen-deficient, for example with induced oxygen deficiency, the electrochemical properties of the material may be improved, for example, resistance measurements may show improved conductivity in comparison to equivalent non-oxygen-deficient materials. As will be understood, the percentage values expressed herein are in atomic percent.

When d>0, additional anions Q are introduced into Formula 2. Due to their differing electronic structure (i.e. F⁻ vs O²⁻), and differing ionic radii (6-coordinate O²⁻=1.40 Å, 6-coordinate F⁻=1.33 Å) they may improve electrochemical performance in the active material. This is due to altering unit cell characteristics with differing ionic radii allowing for improved Li ion capacity, or improved Coulombic efficiencies by improving reversibility. They may additionally improve electrical conductivity as for oxygen vacancy defects, or sub-valent cation substitutions, by altering the electronic structure of the crystal (i.e. doping effects). d may be 0≤d≤1.0, or 0≤d≤0.7. In each of these cases d may be >0, for example ≥0.01. Q may be selected from F, Cl, N, S, and mixtures thereof; or F, N, and mixtures thereof; or Q is F.

Optionally d=0, in which case Formula 2 is M4ₐAl₁₋ₐM5_{b}Nb_{11-b}O_{29-c} where M4, M5, a, b, and c are as defined herein. Advantageously, materials where d=0 are free from anion Q and may be easier to synthesise.

When a>0 and b=d=0 Formula 2 has the composition M4ₐAl₁₋ₐNb₁₁O₂₉c where M4, a, and c are as defined herein, for example 0≤c≤1.45. This represents a material which has been modified at the Al site and optionally modified by induced oxygen deficiency. Such materials represent a particularly effective way to improve the properties of the ‘base’ oxide AlNb₁₁O₂₉ by simple synthetic means. Here, M4 may represent Mg, V, Cr, W, Zr, Mo, Cu, Ga, Ge, Ni, Hf, Ta, Zn and mixtures thereof; preferably Mg, V, Cr, W, Zr, Mo, Ga, Ge, Zn, and mixtures thereof.

It will be understood that the discussion of the variables of Formula 2 (M4, M5, Q, a, b, c, and d) is intended to be read in combination. For example, preferably M4 is selected from Mg, Zr, V, Cr, Mo, W, Mn, Fe, Co, Ni, Cu, Zn, B, Ga, Si, Ge, P, and mixtures thereof and M5 is selected from Mg, Zr, V, Cr, Mo, W, Mn, Fe, Co, Ni, Cu, Zn, Cd, B, Al, Si, P, and mixtures thereof and Q is selected from F, Cl, N, S, and mixtures thereof. Preferably 0≤a≤0.4, 0≤b≤0.5, 0≤c≤1.45, and 0≤d≤1.0.

For example, Formula 2 may be M4ₐAl₁₋ₐM5_{b}Nb₁₁₋ₑO_{29-c-d}Q_{d}, wherein:
M4 is selected from Mg, Zr, V, Cr, Mo, W, Mn, Fe, Co, Ni, Cu, Zn, B, Ga, Si, Ge, P, and mixtures thereof;
M5 is selected from Mg, Zr, V, Cr, Mo, W, Mn, Fe, Co, Ni, Cu, Zn, Cd, B, Al, Si, P, and mixtures thereof;
Q is selected from F, Cl, N, S and mixtures thereof;
0<a≤0.4; 0≤b≤0.5; −0.25≤c≤1.45; 0≤d≤1.45.

For example, Formula 2 may be M4ₐAl₁₋ₐNb₁₁O_{29-c-d}Q_{d}, wherein:
M4 is selected from Mg, Zr, V, Cr, Mo, W, Mn, Fe, Co, Ni, Cu, Zn, B, Ga, Si, Ge, P, and mixtures thereof, preferably M4 is selected from Zr, Cr, Zn, Ga, and mixtures thereof;
Q is selected from F, N, and mixtures thereof, preferably wherein Q is F;
0<a<0.5; 0≤c≤1.45; 0≤d≤1.45.

For example, Formula 2 may be M4ₐAl₁₋ₐNb₁₁O_{29-c-d}Q_{d}, wherein:
M4 is selected from Mg, Zr, Mo, W, Cu, Zn, Ga, Ge, P, and mixtures thereof, preferably M4 is selected from Zr, Zn, Ga, and mixtures thereof;
Q is selected from F, N, and mixtures thereof, preferably wherein Q is F;
0<a≤0.2; 0≤c≤1.45; 0≤d≤1.45.

M4, M5, and Q may also be selected from each of the specific elements used as these dopants in the examples.

The oxide of Formula 2 may further comprise Li and/or Na. For example, Li and/or Na may enter the crystal structure when the oxide is used in a metal-ion battery electrode.

### Formula 3

The oxide comprising niobium may have the formula M6ₐPₓ₋ₐM7_{b}Nb_{9-b}O_{25-c-d}Q_{d} (Formula 3) wherein:
M6 is selected from Na, K, Mg, Ca, Sr, Y, Ti, Zr, Hf, V, Nb, Ta, Cr, Mo, W, Mn, Fe, Co, Ni, Cu, Zn, B, Al, Ga, Si, Ge, Sn, Bi, Sb, and mixtures thereof;
M7 is selected from Na, K, Mg, Ca, Sr, Y, Ti, Zr, Hf, V, Ta, Cr, Mo, W, Mn, Fe, Co, Ni, Cu, Zn, B, Al, Ga, Si, Ge, Sn, Bi, P, Sb, and mixtures thereof;
Q is selected from F, Cl, Br, I, N, S, Se, and mixtures thereof;
0≤a≤0.5; 0≤b≤2; −0.5≤c≤1.25; 0≤d≤5; 1≤x≤2;
one or more of a, b, c, and d does not equal 0;
with the proviso that if M6 consists of Nb and if M7 consists of P then c is >0.

Formula 3 represents an example of an oxide comprising niobium having a crystal structure corresponding to the crystal structure of M^{V}Nb₉O₂₅.

It will be understood that the Formula 3 does not correspond to stoichiometric PNb₉O₂₅. The present inventors have found that by modifying materials including PNb₉O₂₅ by either incorporating further cations (M6 and/or M7) to form mixed cation active electrode materials, and/or by creating an induced oxygen deficiency or excess, and/or by forming mixed anion active electrode materials (comprising O and Q) the resulting material has improved electrochemical properties, and in particular improved electrochemical properties when used as an anode material. For instance, the inventors have found that materials according to Formula 3 have a significantly improved capacity retention at high C-rates compared to PNb₉O₂₅, as shown by the present examples. This is an important result in demonstrating the advantages of the material according to Formula 3 for use in batteries designed for fast charge/discharge.

PNb₉O₂₅ may be considered to have a ReO₃-derived MO₃₋ₓ crystal structure such as a Wadsley-Roth crystal structure. The crystal structure of PNb₉O₂₅ can be described as having a 3×3×∞ crystallographic block structure, with corner-sharing tetrahedra. The crystal formulae of P_{2.5}Nb₁₈O₅₀ can be described as an isostructural phase to PNb₉O₂₅ with slight differences in some bond lengths due to additional P (P—O and Nb3—O2, Nb2—O2 for example). This has previously been reported as a Phosphate Bronze material but it and related theorised structures (i.e. P₂₋₄Nb₁₈O₅₀) are considered as a distorted Wadsley-Roth crystal structure herein.

Preferably, the crystal structure of Formula 3, as determined by X-ray diffraction, corresponds to the crystal structure of one or more of PNb₉O₂₅, VNb₉O₂₅, or P_{2.5}Nb₁₈O₅₀; or one or more of PNb₉O₂₅ or P_{2.5}Nb₁₈O₅₀; or most preferably PNb₉O₂₅. The crystal structure of PNb₉O₂₅ may be found at ICDD crystallography database entry JCPDS 81-1304. The crystal structure of VNb₉O₂₅ may be found at JCPDS 49-0289. The crystal structure of P_{2.5}Nb₁₈O₅₀ may be found at ICDD 01-082-0081. The oxide of Formula 3 may have unit cell parameters a, b, and c wherein a is 15.4-15.8 Å preferably 15.5-15.7 Å, b is 15.4-15.8 Å preferably 15.5-15.7 Å, and c=3.6-4.0 Å preferably 3.7-3.9 Å. Most preferably a=b. The oxide of Formula 3 may have unit cell parameters α, β, and γ each being about 90°, preferably wherein α=β=γ=90°. Unit cell parameters may be determined by X-ray diffraction. The oxide of Formula 3 may have a crystallite size of 10-100 nm, preferably 30-60 nm, determined according to the Scherrer equation. By ‘and mixtures thereof’, it is intended that M6, M7, or Q may each represent two or more elements from their respective lists. An example of such a material is Ti_{0.05}Mo_{0.05}P_{0.90}Nb₉O₂₅. Here, M6 represents Ti_{a′}Mo_{a″} (where a′+a″=a), a=0.1, b=0, c=0, and d=0. Another example of such a material is Al_{0.05}P_{0.95}Ti_{0.225}Mo_{0.225}Nb_{8.55}O_{24.95}. Here, M6 represents Alₐ, M7 represents Ti_{b′}Mo_{b″} (where b′+b″=b), a=0.05, b=0.45, c=0.05, and d=0.

The precise values of a, b, c, d within the ranges defined may be selected to provide a charge balanced, or substantially charge balanced, crystal structure. Additionally or alternatively, the precise values of a, b, c, d within the ranges defined may be selected to provide a thermodynamically stable, or thermodynamically metastable, crystal structure.

When exchange of the cations or anions in the structure (i.e. P, Nb, O) have taken place without preserving the initial valency, this can give rise to both oxygen deficiency and excess. For example, a material that substitutes P⁵⁺ for Mo⁶⁺ to some extent will demonstrate minor oxygen excess (i.e. P₂O₅ vs MoO₃), whereas substitution of P⁵⁺ for A³⁺ will show a minor oxygen deficiency (i.e. P₂O₅ vs Al₂O₃). Oxygen deficiency can also be induced through thermal treatment in inert or reducing conditions, which results in induced oxygen vacancy defects in the structure.

M6 is a cation which substitutes for P in the crystal structure. M6 may be selected from Ti, Zr, Hf, V, Nb, Ta, Cr, Mo, W, Mn, Fe, Co, Ni, Cu, Zn, B, Al, Ga, Si, Ge, Sn, Bi, Sb, and mixtures thereof; or Ti, Zr, Hf, Cr, Mo, W, B, Al, Ga, Bi, Sb, and mixtures thereof; or Ti, Mo, Al, B, and mixtures thereof. Preferably M6 is not Nb. Preferably, M6 is not Na. M6 may have a different valency than P⁵⁺. This gives rise to oxygen deficiency or excess. Preferably, M6 has a lower valency than p⁵⁺. This gives rise to oxygen deficiency, i.e. the presence of oxygen vacancies providing the advantages discussed herein. M6 preferably has a different ionic radius than P⁵⁺, most preferably a larger ionic radius. This gives rise to changing unit cell size and local distortions in crystal structure, providing the advantages discussed herein.

Ionic radii referred to herein are the Shannon ionic radii at the coordination and valency that the ion would be expected to adopt in the crystal structure of the active electrode material. For example, the crystal structure of PNb₉O₂₅ includes Nb⁵⁺O₆ octahedra and P⁵⁺O₄ tetrahedra.

The amount of M6 is defined by a, meeting the criterion 0≤a≤0.5. a may be 0≤a≤0.3, preferably 0≤a≤0.2. In each of these cases a may be >0, for example >0.01.

M7 is a cation which substitutes for Nb in the crystal structure. M7 may be selected from Ti, Zr, Hf, V, Ta, Cr, Mo, W, Mn, Fe, Co, Ni, Cu, Zn, B, Al, Ga, Si, Ge, Sn, Bi, P, Sb, and mixtures thereof; or Ti, Zr, Hf, Cr, Mo, W, V, Ta, and mixtures thereof; or Ti, Mo, and mixtures thereof. Preferably, M7 is not P. Preferably, M7 is not Na. M7 may have a different valency than Nb⁵⁺. This gives rise to oxygen deficiency or excess.

Preferably, M7 has a lower valency than Nb⁵⁺. This gives rise to oxygen deficiency, i.e. the presence of oxygen vacancies providing the advantages discussed herein. M7 preferably has a different ionic radius than Nb⁵⁺, most preferably a larger ionic radius. This gives rise to changing unit cell size and local distortions in crystal structure, providing the advantages discussed herein.

The amount of M7 is defined by b, meeting the criterion 0≤b≤2. b may be 0≤b≤1.5, preferably 0≤b≤1, or 0≤b≤0.9. In each of these cases b may be >0, for example >0.01.

Preferably, at least one of a and b is >0. Both of a and b can be >0.

c reflects the oxygen content of the active electrode material. When c is greater than 0, it forms an oxygen-deficient material, i.e. the material has oxygen vacancies. Such a material would not have precise charge balance without changes to cation oxygen state, but is considered to be “substantially charge balanced” as indicated above. Alternatively, c may equal 0, in which it is not an oxygen-deficient material. c may be below 0, which is a material with oxygen-excess. c may be −0.25≤c≤1.25. Preferably c is 0≤c≤1.25. Optionally, if a=b=0 then c≥0; preferably if a=b=0 then c>0.

When c is 1.25, the number of oxygen vacancies is equivalent to 5% of the total oxygen in the crystal structure. c may be greater than 0.0125 (0.05% oxygen vacancies), greater than 0.025 (0.1% oxygen vacancies), greater than 0.05 (0.2% oxygen vacancies), or greater than 0.125 (0.5% oxygen vacancies). c may be between 0 and 1 (4% oxygen vacancies), between 0 and 0.75 (3% oxygen vacancies), between 0 and 0.5 (2% oxygen vacancies), or between 0 and 0.25 (1% oxygen vacancies). For example, c may satisfy 0.01≤c≤1.25. When the material is oxygen-deficient, the electrochemical properties of the material may be improved, for example, resistance measurements may show improved conductivity in comparison to equivalent non-oxygen-deficient materials. As will be understood, the percentage values expressed herein are in atomic percent.

Formula 3 relates to phosphorus niobium oxides which may comprise oxygen vacancies (oxygen-deficient phosphorus niobium oxides), or may have oxygen excess. Oxygen vacancies may be formed in a phosphorus niobium oxide by the sub-valent substitution of a base material as described above, and oxygen excess may be formed in a phosphorus niobium oxide by substitution for increased valency. Oxygen vacancies may also be formed by heating a phosphorus niobium oxide under reducing conditions, optionally without cation substitution. Therefore, Formula 3 may be PₓNb₉O_{25-c-d}Q_{d} where x, c, d, and Q are as defined herein. The amount of oxygen vacancies and excess may be expressed relative to the total amount of oxygen in the base material, i.e. the amount of oxygen in the un-substituted material (e.g. PNb₉O₂₅) or the material before heating under reducing conditions.

When d>0, additional anions Q are introduced into the phosphorus niobium oxide. Due to their differing electronic structure (i.e. F⁻ vs O²⁻), and differing ionic radii (6-coordinate O²⁻=1.40 Å, 6-coordinate F⁻=1.33 Å) they may improve electrochemical performance in the active material. This is due to altering unit cell characteristics with differing ionic radii allowing for improved Li ion capacity, or improved Coulombic efficiencies by improving reversibility. They may additionally improve electrical conductivity as for oxygen vacancy defects, or sub-valent cation substitutions, by altering the electronic structure of the crystal (i.e. doping effects). d may be 0≤d≤2.5, or 0≤d≤1. In each of these cases d may be >0. Q may be selected from F, Cl, N, S, and mixtures thereof; or F, N, and mixtures thereof; or Q is N.

Optionally d=0, in which case the material has the composition M6ₐPₓ₋ₐM7_{b}Nb_{9-b}O_{25-c} where M6, M7, a, b, c, and x are as defined herein. Advantageously, materials where d=0 are free from anion Q and may be easier to synthesise.

x reflects the amount of phosphorus in the material, meeting the criterion 1≤x≤2. x may be 1≤x≤1.25. Preferably, x=1. When x=1 Formula 3 is based on the crystal structure of PNb₉O₂₅.

It will be understood that the discussion of the variables of the composition (M6, M7, Q, a, b, c, d, and x) is intended to be read in combination. For example, preferably M6 is selected from Ti, Zr, Hf, V, Nb, Ta, Cr, Mo, W, Mn, Fe, Co, Ni, Cu, Zn, B, Al, Ga, Si, Ge, Sn, Bi, Sb, and mixtures thereof and M7 is selected from Ti, Zr, Hf, V, Ta, Cr, Mo, W, Mn, Fe, Co, Ni, Cu, Zn, B, Al, Ga, Si, Ge, Sn, Bi, P, Sb, and mixtures thereof. M6 may be selected from Ti, Zr, Hf, Cr, Mo, W, B, Al, Ga, Bi, Sb, and mixtures thereof and M7 may be selected from Ti, Zr, Hf, Cr, Mo, W, V, Ta, and mixtures thereof. M6 may be selected from Ti, Mo, Al, B, and mixtures thereof and M7 may be selected from Ti, Mo, and mixtures thereof. M6 is preferably not Nb and M7 is preferably not P. M6 and M7 are preferably not Na. M6 and M7 may be different. a may be 0≤a≤0.3 and b may be 0≤b≤1.5. Preferably 0≤a≤0.2 and 0≤b≤1. In each of these cases a and/or b may be >0.

For example, Formula 3 may be M6ₐPₓ₋ₐM7_{b}Nb_{9-b}O_{25-c-d}Q_{d}, wherein:
M6 is selected from Ti, Zr, Hf, V, Ta, Cr, Mo, W, Mn, Fe, Co, Ni, Cu, Zn, B, Al, Ga, Si, Ge, Sn, Bi, Sb, and mixtures thereof;
M7 is selected from Ti, Zr, Hf, V, Ta, Cr, Mo, W, Mn, Fe, Co, Ni, Cu, Zn, B, Al, Ga, Si, Ge, Sn, Bi, Sb, and mixtures thereof;
Q is selected from F, Cl, N, S, and mixtures thereof;
0≤a≤0.3; 0≤b≤1.5; −0.25≤c≤1.25; 0:5≤d≤2.5; 1≤x≤1.25;
one or more of a, b, c, and d does not equal 0.

For example, Formula 3 may be M6ₐP₁₋ₐM7_{b}Nb_{9-b}O_{25-c-c}Q_{d}, wherein:
M6 is selected from Ti, Zr, Hf, V, Ta, Cr, Mo, W, Mn, Fe, Co, Ni, Cu, Zn, B, Al, Ga, Si, Ge, Sn, Bi, Sb, and mixtures thereof;
M7 is selected from Ti, Zr, Hf, V, Ta, Cr, Mo, W, Mn, Fe, Co, Ni, Cu, Zn, B, Al, Ga, Si, Ge, Sn, Bi, Sb, and mixtures thereof;
Q is selected from F, N, and mixtures thereof;
0≤a≤0.3; 0≤b≤1.5; 0≤c≤1.25; 0≤d≤2.5;
one or more of a, b, c, and d does not equal 0.

For example, Formula 3 may be M6ₐP₁₋ₐM7_{b}Nb_{9-b}O_{25-c-c}Q_{d}, wherein:
M6 is selected from Ti, Zr, Hf, Cr, Mo, W, B, Al, Ga, Ge, Bi, Sb, and mixtures thereof;
M7 is selected from Ti, Zr, Hf, Cr, Mo, W, V, Ta, Ga, Ge, and mixtures thereof;
Q is selected from F, N, and mixtures thereof;
0≤a≤0.2; 0≤b≤1; 0≤c≤1.25; 0≤d≤2.5;
wherein at least one of a and b is >0.

### Formula 4

The oxide comprising niobium may have the formula MBₐM9₁₋ₐM10_{b}Nb_{12-b}O_{33-c-d}Q_{d} (Formula 4) wherein:
M8 and M9 are different;
M8 is selected from Mg, Ca, Sr, Y, La, Ce, Ti, Zr, Hf, V, Nb, Ta, Cr, Mo, W, Mn, Fe, Co, Ni, Cu, Zn, Cd, B, Al, Ga, In, Si, Ge, Sn, Pb, P, Sb, Bi and mixtures thereof;
M9 is Mo or W;
M10 is selected from Mg, Ca, Sr, Y, La, Ce, Ti, Zr, Hf, V, Ta, Cr, Mo, W, Mn, Fe, Co, Ni, Cu, Zn, Cd, B, Al, Ga, In, Si, Ge, Sn, Pb, P, Sb, Bi, and mixtures thereof;
Q is selected from F, Cl, Br, I, N, S, Se, and mixtures thereof;
0≤a≤0.5; 0≤b≤2; −0.5≤c≤1.65; 0≤d≤1.65;
one or more of a, b, c and d does not equal zero; and
when a, b, and d equal zero, c is greater than zero.

Formula 4 represents an example of an oxide comprising niobium having a crystal structure corresponding to the crystal structure of M^{VI}Nb₁₂O₃₃.

It will be understood that Formula 4 does not correspond to stoichiometric WNb₁₂O₃₃ or MoNb₁₂O₃₃. The present inventors have found that by modifying WNb₁₂O₃₃ or MoNb₁₂O₃₃ by either incorporating further cations (M8 and/or M10), and/or by creating an induced oxygen deficiency or excess, and/or by forming mixed anion materials (comprising O and Q), the resulting material has improved electrochemical properties, and in particular improved electrochemical properties when used as an anode material. When a>0, the oxide is modified by partial substitution of M9 (Mo or W) by M8. When b>0, the oxide is modified by partial substitution of Nb by M10. When c≠0, the oxide is modified by oxygen deficiency or excess. When d>0 the oxide is modified by partial substitution of O by Q. The inventors have found that the modified oxides have significantly improved electronic conductivity, and improved coulombic efficiency, and improved de-lithiation voltage at high C-rates, compared to unmodified ‘base’ materials, as shown by the present examples. This is an important result in demonstrating the advantages of the material of the invention for use in batteries designed for fast charge/discharge.

MoNb₁₂O₃₃ and WNb₁₂O₃₃ may be considered to have a ReO₃-derived MO₃₋ₓ crystal structure such as a Wadsley-Roth crystal structure. The crystal structure of MoNb₁₂O₃₃ or WNb₁₂O₃₃ can be described as having a 3×4×∞ crystallographic block structure, with corner-sharing tetrahedra ([WO₄] or [MoO₄]). The crystal formulae of WNb₁₂O₃₃ can be described as an isostructural phase to MoNb₁₂O₃₃ with slight differences in some bond lengths.

Preferably, the crystal structure of the oxide of Formula 4, as determined by X-ray diffraction, corresponds to the crystal structure of WNb₁₂O₃₃ or MoNb₁₂O₃₃; most preferably MoNb₁₂O₃₃. In this way, it can be confirmed that the ‘base’ material has been modified without significantly affecting the crystal structure, which is believed to have advantageous properties for use as an active electrode material. The crystal structure of WNb₁₂O₃₃ may be found at ICDD crystallography database entry JCPDS 73-1322.

The oxide of Formula 4 with cation/anion exchange may have unit cell parameters α, b, and c wherein a is 22.23-22.43 Å preferably 22.27-22.38 Å, b is 3.81-3.84 Å preferably 3.82-3.84 Å, and c=17.7-17.9 Å preferably 17.73-17.88 Å. The oxide of Formula 4 may have unit cell parameters α and γ each being about 90°, preferably wherein α=γ=90°; whereas β is 123.1-123.70 preferably 123.2-123.650 and unit cell volume is 1260-1280 Å³ preferably 1264-1275 Å³. Unit cell parameters may be determined by X-ray diffraction. The oxide of Formula 4 may have a crystallite size of 5-150 nm, preferably 30-60 nm, determined according to the Scherrer equation.

By ‘and mixtures thereof’, it is intended that M8, M10, and Q may each represent two or more elements from their respective lists. An example of such a material is Ti_{0.05}W_{0.25}Mo_{0.70}Nb_{11.95}Al_{0.05}O_{32.9}. Here, M8 is Ti_{a′}W_{a″} (where a′+a″=a), M9 is Mo, M10 is Al, a=0.3, b=0.05, c=0.1, d=0. Here, c has been calculated assuming that each cation adopts its typical oxidation state, i.e. Al³⁺, Ti⁴⁺, W⁶⁺, Mo⁶⁺, and Nb⁵⁺.

The precise values of a, b, c, d within the ranges defined may be selected to provide a charge balanced, or substantially charge balanced, crystal structure. Additionally or alternatively, the precise values of a, b, c, d within the ranges defined may be selected to provide a thermodynamically stable, or thermodynamically metastable, crystal structure.

When exchange of the cations or anions in the structure (i.e. Mo, W, Nb, O) have taken place without preserving the initial valency, this can give rise to both oxygen deficiency and excess. For example, a material that substitutes Nb⁵⁺ for Mo⁶⁺ to some extent will demonstrate minor oxygen excess (i.e. Nb₂O₅ vs MoO₃), whereas substitution of Nb⁵⁺ for Al³⁺ will show a minor oxygen deficiency (i.e. Nb₂O₅ vs Al₂O₃). Oxygen deficiency can also be induced through thermal treatment in inert or reducing conditions, which results in induced oxygen vacancy defects in the structure.

There may be partial oxidation or partial reduction to compensate for exchange which does not preserve the initial valency. For example, substitution of Nb⁵⁺ for Al³⁺ may be compensated at least in part by reduction of some Nb⁵⁺ to Nb⁴⁺.

M9 is Mo or W. Preferably, M9 is Mo in which case the material is based on MoNb₁₂O₃₃.

M8 is a cation which substitutes for M9 in the crystal structure. M8 may be selected from Mg, Ti, Zr, Hf, V, Nb, Ta, Cr, Mo, W, Mn, Fe, Co, Ni, Cu, Zn, Cd, B, Al, Ga, Si, Sn, P, and mixtures thereof; preferably Mg, Ti, Zr, V, Nb, Cr, Mo, W, Mn, Fe, Co, Ni, Cu, Zn, Cd, B, Al, Si, P, and mixtures thereof; most preferably Ti, Zr, V, Cr, Mo, W, Fe, Cu, Zn, Al, P, and mixtures thereof. M8 may have a different valency than M9⁶⁺. This gives rise to oxygen deficiency or excess. Preferably, M8 has a lower valency than M9⁶⁺. This gives rise to oxygen deficiency, i.e. the presence of oxygen vacancies providing the advantages discussed herein.

M8 may also be selected from each of the specific elements used as such in the reference examples.

When more than one element is present as M8 or M10 it will be understood that the valency refers to M8 or M10 as a whole. For example, if 25 at % of M8 is Ti and 75 at % of M8 is W the valency of M8 is 0.25×4 (the contribution from Ti)+0.75×6 (the contribution from W).

M8 preferably has a different ionic radius than M9⁶⁺, most preferably a larger ionic radius. This gives rise to changing unit cell size and local distortions in crystal structure, providing the advantages discussed herein. Ionic radii referred to herein are the Shannon ionic radii (available at R. D. Shannon, Acta Cryst., A32, 1976, 751-767) at the coordination and valency that the ion would be expected to adopt in the crystal structure of Formula 4. For example, the crystal structure of MoNb₁₂O₃₃ includes Nb⁵⁺O₆ octahedra and Mo⁶⁺O₄ tetrahedra. Accordingly, when M10 is Zr the ionic radius is taken as that of 6-coordinate Zr⁴⁺ since this is typical valency and coordination of Zr when replacing Nb in MoNb₁₂O₃₃.

The amount of M8 is defined by a, meeting the criterion 0≤a<0.5. a may be 0≤a≤0.45, preferably 0≤a≤0.3. Most preferably a>0, for example a≥0.01. The inventors have found that partially substituting M9 for M8 provides a mixed niobium oxide with significantly improved properties compared to the unmodified ‘base; materials, as shown by the present examples. Higher values of a may be more readily achieved when M8 has the same valency as M9. When M8 comprises a cation with a 6+ valency (for example Mo or W) a may be 0≤a<0.5. When M8 does not comprise a cation with a 6+ valency a may be 0≤a≤0.2.

M10 is a cation which substitutes for Nb in the crystal structure. M10 may be selected from Mg, Ti, Zr, Hf, V, Ta, Cr, Mo, W, Mn, Fe, Co, Ni, Cu, Zn, Cd, B, Al, Ga, Si, Sn, P, and mixtures thereof; preferably Mg, Ti, Zr, V, Cr, Mo, W, Mn, Fe, Co, Ni, Cu, Zn, Cd, B, Al, Si, P, and mixtures thereof; most preferably Ti, Zr, V, Cr, Mo, W, Fe, Cu, Zn, Al, P, and mixtures thereof. M10 may have a different valency than Nb⁵⁺. This gives rise to oxygen deficiency or excess. Preferably, M10 has a lower valency than Nb⁵⁺. This gives rise to oxygen deficiency, i.e. the presence of oxygen vacancies providing the advantages discussed herein.

M10 may also be selected from each of the specific elements used as such in the reference examples.

M10 preferably has a different ionic radius than Nb⁵⁺, most preferably a larger ionic radius. This gives rise to changing unit cell size and local distortions in crystal structure, providing the advantages discussed herein.

The amount of M10 is defined by b, meeting the criterion 0≤b≤2. b may be 0≤b≤1.0, preferably 0≤b≤0.2. In each of these cases b may be >0, for example b≥0.01. Higher values of b may be more readily achieved when M10 has the same valency as Nb⁵⁺. When M10 comprises a cation with a 5+ valency (for example Ta) b may be 0≤b≤2. When M10 does not comprise a cation with a 5+ valency b may be 0≤b≤0.15.

c reflects the oxygen content of Formula 4. When c is greater than 0, it forms an oxygen-deficient material. Such a material may have oxygen vacancies. Such a material would not have precise charge balance without changes to cation oxygen state, but is considered to be “substantially charge balanced” as indicated above. Alternatively, c may equal 0, in which it is not an oxygen-deficient material. c may be below 0, which is a material with oxygen-excess. c may be −0.25≤c≤1.65. Preferably c is 0≤c≤1.65. For example, non-oxygen deficient stoichiometric MoNb₁₂O₃₃ has a white, off-white, or yellow colour. MoNb₁₂O_{<33} with induced oxygen deficiency has a purple colour.

When c is 1.65, the number of oxygen vacancies is equivalent to 5at % of the total oxygen in the crystal structure. c may be greater than 0.0165, greater than 0.033, greater than 0.066, or greater than 0.165. c may be between 0 and 1, between 0 and 0.75, between 0 and 0.5, or between 0 and 0.25. For example, c may satisfy 0.01≤c≤1.65. When the material is oxygen-deficient, the electrochemical properties of the material may be improved, for example, resistance measurements may show improved conductivity in comparison to equivalent non-oxygen-deficient materials.

When d>0, additional anions Q are introduced into Formula 4. Due to their differing electronic structure (i.e. F⁻ vs O²⁻), and differing ionic radii (6-coordinate O²⁻=1.40 Å, 6-coordinate F⁻=1.33 Å) they may improve electrochemical performance in the active material. This is due to altering unit cell characteristics with differing ionic radii allowing for improved Li ion capacity, or improved Coulombic efficiencies by improving reversibility. They may additionally improve electrical conductivity as for oxygen vacancy defects, or sub-valent cation substitutions, by altering the electronic structure of the crystal (i.e. doping effects). d may be 0≤d≤1.0, or 0≤d≤0.8. In each of these cases d may be >0, for example d≥0.01. Q may be selected from F, Cl, N, S, and mixtures thereof; or F, N, and mixtures thereof; or Q is N.

Optionally d=0, in which case Formula 4 is M8ₐM9₁₋ₐM10_{b}Nb_{12-b}O_{33-c} where M8, M9, M10, a, b, and c are as defined herein. Advantageously, materials where d=0 are free from anion Q and may be easier to synthesise.

It will be understood that the discussion of the variables of the composition (M8, M9, M10, Q, a, b, c, and d) is intended to be read in combination. For example, preferably M8 is selected from Mg, Ti, Zr, V, Nb, Cr, Mo, W, Mn, Fe, Co, Ni, Cu, Zn, Cd, B, Al, Si, P, and mixtures thereof and M10 is selected from Mg, Ti, Zr, V, Cr, Mo, W, Mn, Fe, Co, Ni, Cu, Zn, Cd, B, Al, Si, P, and mixtures thereof and Q is selected from F, N, and mixtures thereof. Most preferably M8 and M10 are selected from Ti, Zr, V, Cr, Mo, W, Fe, Cu, Zn, Al, P, and mixtures thereof. Preferably 0≤a≤0.45 and 0≤b≤1.0 and 0≤d≤1.0.

For example, Formula 4 may be M8ₐM9₁₋ₐM10_{b}Nb_{12-b}O_{33-c-d}Q_{d}, wherein:
M8 and M9 are different;
M8 is selected from Mg, Ti, Zr, V, Nb, Cr, Mo, W, Mn, Fe, Co, Ni, Cu, Zn, Cd, B, Al, Si, P, and mixtures thereof;
M9 is Mo or W;
M10 is selected from Mg, Ti, Zr, V, Cr, Mo, W, Mn, Fe, Co, Ni, Cu, Zn, Cd, B, Al, Si, P, and mixtures thereof;
Q is selected from F, N, and mixtures thereof;
0≤a≤0.45; 0≤b≤1.0; −0.5≤c≤1.65; 0≤d≤1.0;
one or more of a, b, c, and d does not equal 0; and
when a, b, and d equal zero, c is greater than zero.

For example, Formula 4 may be M8ₐM9₁₋ₐM10_{b}Nb_{12-b}O_{33-c-d}Q_{d}, wherein:
M8 and M9 are different;
M8 is selected from Ti, Zr, V, Cr, Mo, W, Fe, Cu, Zn, Al, P, and mixtures thereof;
M9 is Mo or W;
M10 is selected from Ti, Zr, V, Cr, Mo, W, Fe, Cu, Zn, Al, P, and mixtures thereof;
Q is selected from F, N, and mixtures thereof;
0<a≤0.45; 0≤b≤0.2; −0.25≤c≤1.65; 0≤d≤0.8.

M8, M10, and Q may also be selected from each of the specific elements used as these dopants in the examples and reference examples.

Formula 4 may further comprise Li and/or Na. For example, Li and/or Na may enter the crystal structure when the active electrode material is used in a metal-ion battery electrode.

Nb₂O₅

The oxide comprising niobium may be H—Nb₂O₅ or N—Nb₂O₅, preferably H—Nb₂O₅. The H—Nb₂O₅ and N—Nb₂O₅ may be doped with additional cations and/or anions. Further information on crystal structures of Nb₂O₅ may be found at Griffith et al., J. Am. Chem. Soc. 2016, 138, 28, 8888-8899. Nb₂O₅ may be obtained from commercial suppliers.

### Example 1

Electrochemical tests were carried out in full-coin cells (CR2032 size) for analysis. The cathode and anode active material to be tested was combined with N-Methyl Pyrrolidone (NMP), carbon black acting as a conductive additive, poly (vinyl difluoride) (PVDF) binder, and carbon nanotubes (CNTs) and mixed to form a slurry using a lab-scale centrifugal planetary mixer. The dry anode composition is 90 wt % active material, 5 wt % carbon black (Super P), 4 wt % PVdF, and 1 wt % CNT. The dry cathode composition is 91% active material, 4% carbon black (Super P), 4 wt % PVdF, and 1 wt % CNT. The slurry was coated on an aluminium foil current collector to the desired loading by doctor blade coating and dried. The electrodes were then calendared to a density of 2.4-3.0 g cm⁻³ at 80° C. to achieve targeted porosities of 31-35%.

The anode and cathode electrodes were punched out at the desired size, then individually weighed to achieve the desired N/P ratio. The anode and cathode electrode punches were combined with a separator (Celgard porous PP/PE), and electrolyte (1.3 M LiPF₆ in EC/DEC) inside a steel coin cell casing and sealed under pressure. Cycling was then carried out at low current rates (C/10) for 2 full cycles of lithiation and de-lithiation between 1.2-3.15 V. Afterwards, the cells were tested for their performance at increasing current densities.

During rate tests, the cells were cycled asymmetric, with a slow charge (C/5) followed by increasing discharge rates for dischargeability tests, and vice versa for chargeability tests. The DCIR was measured by discharging the full cell to 50% of its State-of-Charge (SOC) at a rate of 0.2C, and then applying a 5C pulse for 10 s. The 0.2C rate is then resumed to 0% SoC. The DCIR was calculated from the maximum voltage difference (dVₘₐₓ) observed and the applied current (Iₐₚₚ) as follows: R=Iₐₚₚ/dVₘₐₓ.

The active anode material used in Example 1 has the formula of Sample I11 below and is used at active material loadings of 1.1-1.3 mAhcm⁻², 2.6 gcm⁻³, and 5.5-6.5 mgcm⁻². The active cathode material used is NMC622 (LiNi_{0.6}Mn_{0.2}Co_{0.2}O₂) at active material loadings of 1.2-1.4 mAh cm⁻², 2.8 gcm⁻³, and 7.5-8.5 mg cm⁻².

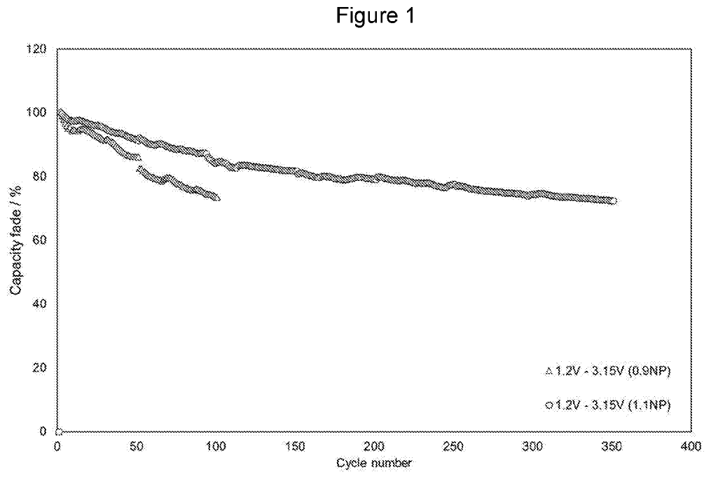

FIG. 1 shows capacity fade as a function of 1C/1C cycle number. During this test, all cells undergo a cycle of 1C CC charge (constant current no CV) followed by a 1C CC discharge. The graph shows a slower capacity fade for the N/P=1.1 cell design compared to the N/P=0.9 design, which shows this design is preferable for reducing the degradation of the system and extending cycle life. The cycle life tests were conducted at 25° C.

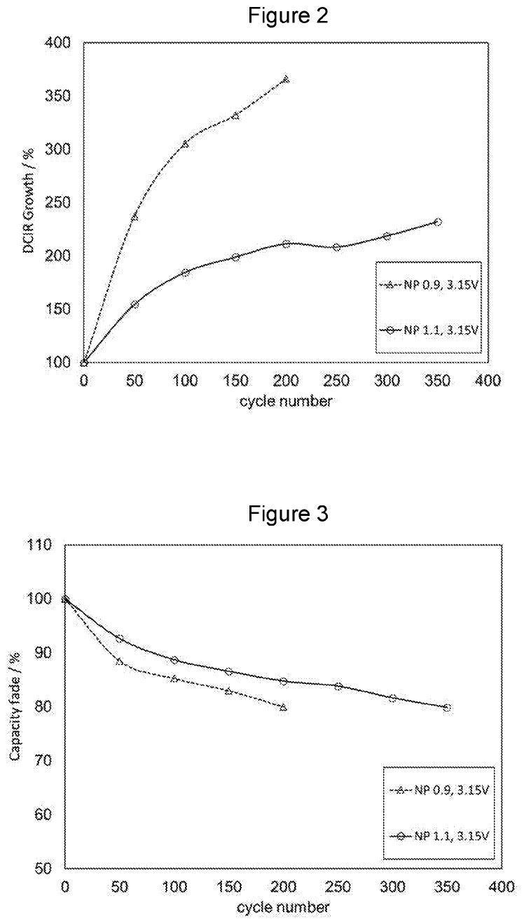

FIG. 2 shows DCIR growth as a function of cycle number. The DCIR was measured by discharging the full cell to 50% of its State-of-Charge (SOC) at a rate of 0.2C, and then applying a 5C pulse for 10 s. The 0.2C rate is then resumed to 0% SoC. The DCIR was calculated from the maximum voltage difference (dVₘₐₓ) observed during the 10 s pulse and the applied current (Iₐₚₚ) as follows: R=Iₐₚₚ/dVₘₐₓ. This measurement was taken every 50 1C/1C cycles. All measurements were done at 25° C. The graph displays a clear benefit of N/P ratio 1.1. After 200 cycles, the internal resistance of the N/P=0.9 cell shows a 360% DCIR growth compared to 210% of the N/P=1.1 cell. A lower DCIR growth over time allows the cell to deliver higher power for longer.

FIG. 3 shows reference capacity fade as a function of cycle number. The ‘capacity fade’ was measured by taking a low C-rate ‘reference’ cycle every 50 1C/1C cycles in a cycle life test. The reference cycle is a C/5 CC charge to 3.15V with a CV until C/40, followed by a C/5 CC discharge to 1.2V. The capacity obtained from this is then plotted on the graph with its corresponding cycle number. All measurements were done at 25° C. This graph shows a slower capacity fade for the N/P=1.1 cell design compared the N/P=0.9 cell design. A slower capacity fade indicates better stability in the anode and cathode materials.

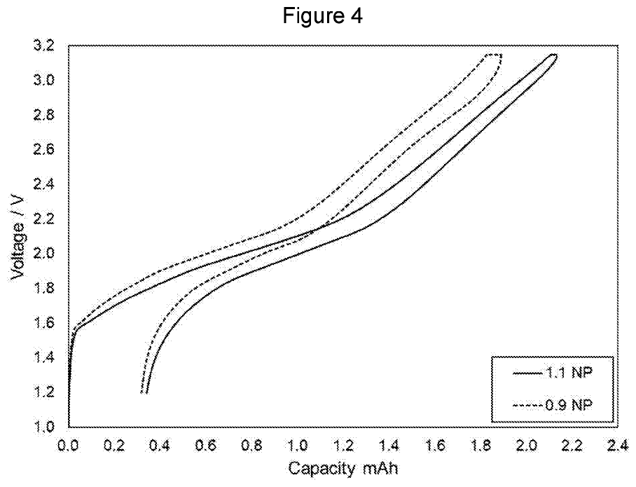

FIG. 4 shows 1^{st} cycle formation data. The formation is a C/5 CC CV (until C/40) charge followed by a C/5 CC discharge. N/P=1.1 shows higher capacity than N/P=0.9 whilst maintaining same first cycle loss. At higher SoC's the N/P=1.1 cell design also displays lower polarisation (the deltaV between charge and discharge), indicating a lower internal resistance. Formation was done at 25° C.

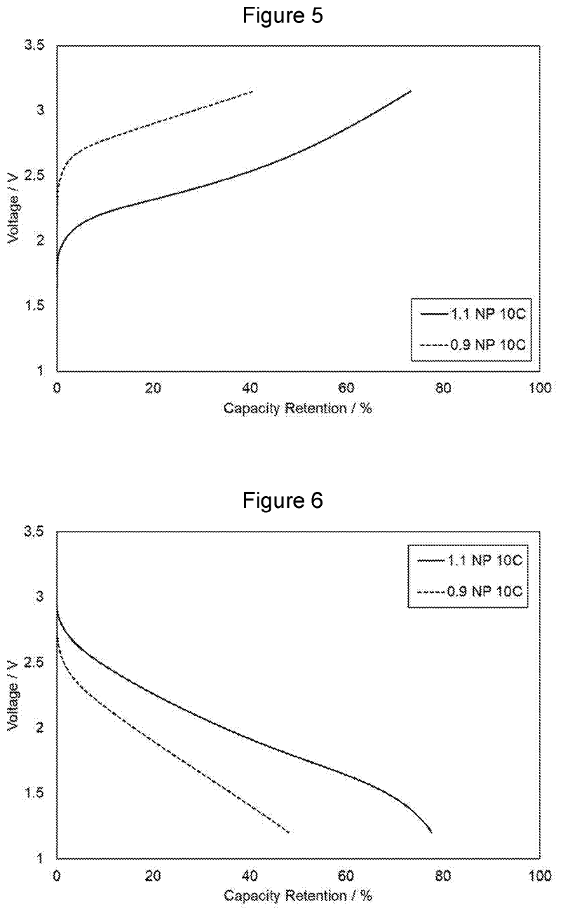

FIG. 5 shows a 10C charge rate test. This test consisted of a C/5 CC discharge followed by a 10C CC charge. This was done to evaluate the fast-charging capability of each system. The graph shows the N/P=1.1 cell design achieving 73% capacity retention compared to 40% of the N/P=0.9 cell design.

FIG. 6 shows a 10C discharge rate test. This test consisted of a C/5 CC CV (until C/40) charge followed by a 10C CC discharge. This was done to evaluate the discharge rate capability of each system. The graph shows the N/P=1.1 cell design achieving 77% capacity retention compared to 48% for the N/P=0.9 cell design.

### Example 2

Electrochemical tests were carried out in full-coin cells (CR2032 size) for analysis. The cathode and anode active material to be tested was combined with N-Methyl Pyrrolidone (NMP), carbon black acting as a conductive additive and poly (vinyl difluoride) (PVDF) binder and mixed to form a slurry using a lab-scale centrifugal planetary mixer. The dry anode composition is 92 wt % active material, 5 wt % carbon black (Super P) and 3 wt % PVdF. The dry cathode composition is 92 wt % active material, 5 wt % carbon black (Super P) and 3 wt % PVdF. The slurry was coated on an aluminium foil current collector to the desired loading by doctor blade coating and dried. The electrodes were then calendared to a density of 2.4-3.0 g cm⁻³ at 80° C. to achieve targeted porosities of 31-35%.

The anode and cathode electrodes were punched out at the desired size, then individually weighed to achieve the desired N/P ratio. The anode and cathode electrode punches were combined with a separator (Celgard porous PP/PE), and electrolyte (1.3 M LiPF₆ in EC/EMC) inside a steel coin cell casing and sealed under pressure. Cycling was then carried out at low current rates (C/5) for 2 full cycles of charge and discharge between 1.0-3.05 V. Afterwards, the cells were tested for their performance at increasing current densities. During rate tests, the cells were cycled asymmetric, with a slow charge (C/5) followed by increasing discharge rates for dischargeability tests, and vice versa for chargeability tests.

The active anode material used in Example 2 has approximately the formula of Sample E6 below and is used at active material loadings of 6.5-7.5 mg cm⁻². The active cathode material used is an NCA (LiNi_{0.x}Co_{0.y}Al_{1-0.x-0.y}O₂) at active material loadings of 6.5-9.0 mg cm⁻².

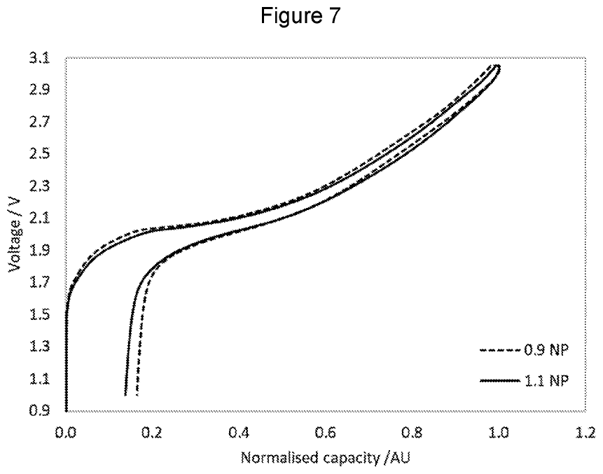

FIG. 7 shows 1^{st} cycle formation data. The formation is a C/5 CC CV (until C/40) charge followed by a C/5 CC discharge. N/P=0.9 shows a higher first cycle loss than N/P=1.1. At higher SoC's the N/P=1.1 cell design also displays lower polarisation (the deltaV between charge and discharge), indicating a lower internal resistance. Formation was done at 25° C.

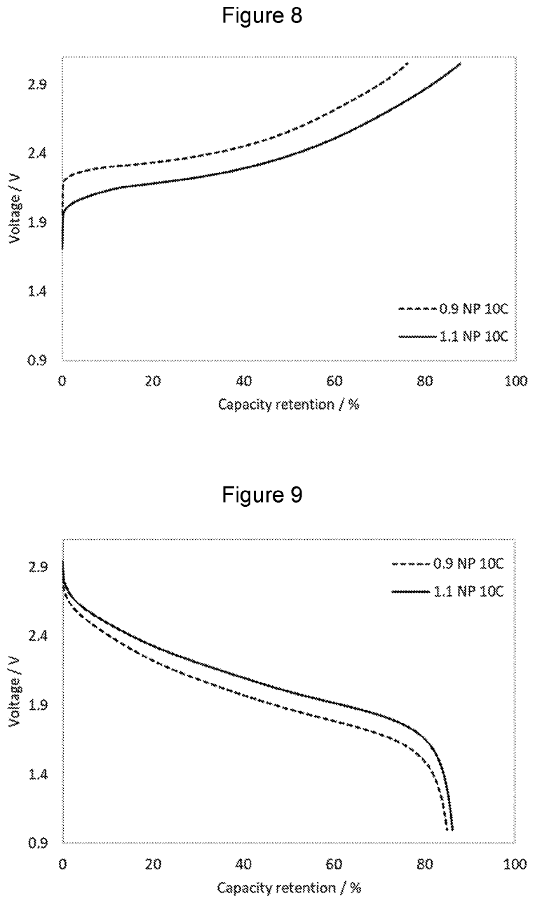

FIG. 8 shows a 10C charge rate test. This test consisted of a C/5 CC discharge followed by a 10C CC charge. This was done to evaluate the fast-charging capability of each system. The graph shows the N/P=1.1 cell design achieving 88% capacity retention compared to 76% of the N/P=0.9 cell design.

FIG. 9 shows a 10C discharge rate test. This test consisted of a C/5 CC CV (until C/40) charge followed by a 10C CC discharge. This was done to evaluate the discharge rate capability of each system. The graph shows the N/P=1.1 cell design achieving 86% capacity retention compared to 85% for the N/P=0.9 cell design.

### Example 3

Electrochemical tests were carried out in full-coin cells (CR2032 size) for analysis. The cathode and anode active material to be tested was combined with N-Methyl Pyrrolidone (NMP), carbon black acting as a conductive additive and poly (vinyl difluoride) (PVDF) binder and mixed to form a slurry using a lab-scale centrifugal planetary mixer. The dry anode composition is 92 wt % active material, 5 wt % carbon black (Super P) and 3 wt % PVdF. The dry cathode composition is 92 wt % active material, 5 wt % carbon black (Super P) and 3 wt % PVdF. The slurry was coated on an aluminium foil current collector to the desired loading by doctor blade coating and dried. The electrodes were then calendared to a density of 2.4-3.0 g cm⁻³ at 80° C. to achieve targeted porosities of 31-35%.

The anode and cathode electrodes were punched out at the desired size, then individually weighed to achieve the desired N/P ratio. The anode and cathode electrode punches were combined with a separator (Celgard porous PP/PE), and electrolyte (1.3 M LiPF₆ in EC/DEC) inside a steel coin cell casing and sealed under pressure. Cycling was then carried out at low current rates (C/5) for 2 full cycles of charge and discharge between 1.0-3.05 V. Afterwards, the cells were tested for their performance at increasing current densities. During rate tests, the cells were cycled asymmetric, with a slow charge (C/5) followed by increasing discharge rates for dischargeability tests, and vice versa for chargeability tests.

The active anode material used in Example 3 has the formula of Sample G16 below and is used at active material loadings of 6.5-7.5 mg cm⁻². The active cathode material used is an NCA (LiNi_{0.x}Co_{0.y}Al_{1-0.x-0.y}O₂) at active material loadings of 6.5-9.0 mg cm⁻².

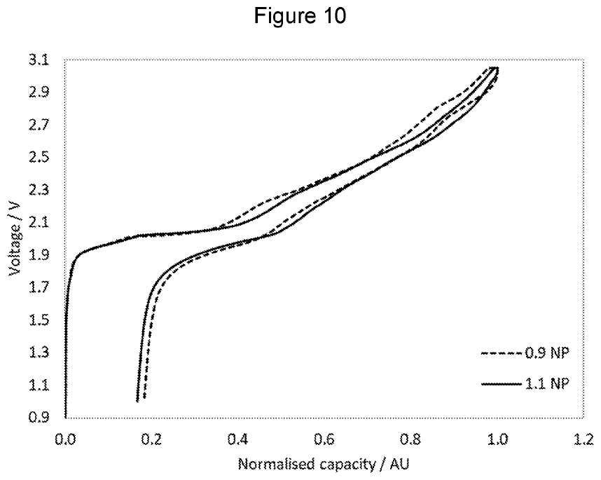

FIG. 10 shows 1^{st} cycle formation data. The formation is a C/5 CC CV (until C/40) charge followed by a C/5 CC discharge. N/P=0.9 shows a higher first cycle loss than N/P=1.1. At higher SoC's the N/P=1.1 cell design also displays lower polarisation (the deltaV between charge and discharge), indicating a lower internal resistance. Formation was done at 25° C.

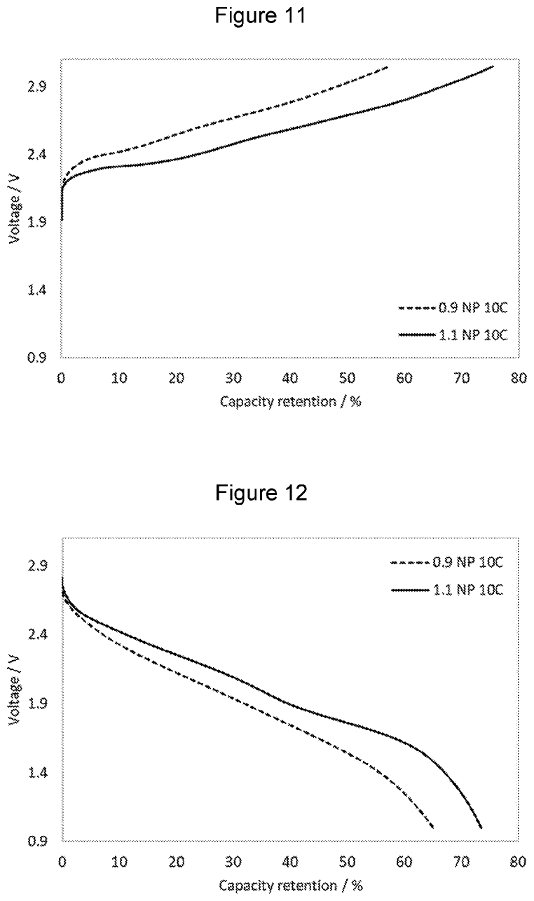

FIG. 11 shows a 10C charge rate test. This test consisted of a C/5 CC discharge followed by a 10C CC charge. This was done to evaluate the fast-charging capability of each system. The graph shows the N/P=1.1 cell design achieving 76% capacity retention compared to 57% of the N/P=0.9 cell design.

FIG. 12 shows a 10C discharge rate test. This test consisted of a C/5 CC CV (until C/40) charge followed by a 10C CC discharge. This was done to evaluate the discharge rate capability of each system. The graph shows the N/P=1.1 cell design achieving 74% capacity retention compared to 65% for the N/P=0.9 cell design.

### Example 4

Electrochemical tests were carried out in full-coin cells (CR2032 size) for analysis. The cathode and anode active material to be tested was combined with N-Methyl Pyrrolidone (NMP), carbon black acting as a conductive additive and poly (vinyl difluoride) (PVDF) binder and mixed to form a slurry using a lab-scale centrifugal planetary mixer. The dry anode composition is 92 wt % active material, 5 wt % carbon black (Super P) and 3 wt % PVdF. The dry cathode composition is 92 wt % active material, 5 wt % carbon black (Super P) and 3 wt % PVdF. The slurry was coated on an aluminium foil current collector to the desired loading by doctor blade coating and dried. The electrodes were then calendared to a density of 2.7-3.0 g cm⁻³ at 80° C. to achieve targeted porosities of 27-33%.

The anode and cathode electrodes were punched out at the desired size, then individually weighed to achieve the desired N/P ratio. The anode and cathode electrode punches were combined with a separator (Celgard porous PP/PE), and electrolyte (1 M LiPF₆ in EC/EMC) inside a steel coin cell casing and sealed under pressure. Cycling was then carried out at low current rates (C/10) for 2 full cycles of charge and discharge between 1.0-3.05 V. Afterwards, the cells were tested for their performance at increasing current densities. During rate tests, the cells were cycled asymmetric, with a slow charge (C/5) followed by increasing discharge rates for dischargeability tests, and vice versa for chargeability tests.

The active anode material used in Example 4 has the formula of Sample E8 below and is used at active material loadings of 6.5-7.5 mg cm⁻². The active cathode material used is an NCA (LiNi_{0.x}Co_{0.y}Al_{1-0.x-0.y}O₂) at active material loadings of 6.5-8.4 mg cm⁻².

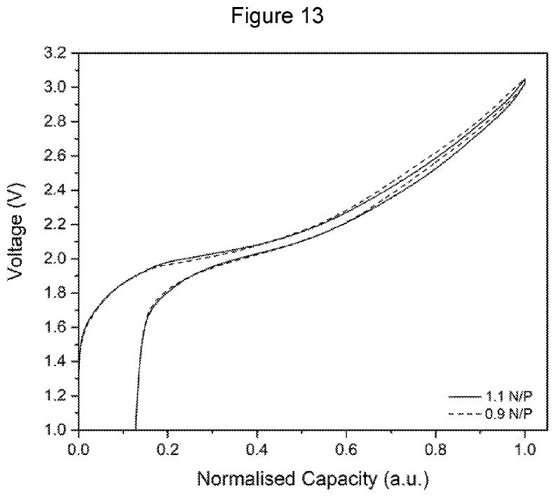

FIG. 13 shows 1^{st} cycle formation data as a function of voltage vs. normalised capacity. The formation is a C/10 CC charge followed by a C/10 CC discharge. At higher SoC (>50%) the N/P=1.1 cell design displays lower polarisation (the deltaV between charge and discharge), indicating a lower internal resistance. Formation was done at 25° C.

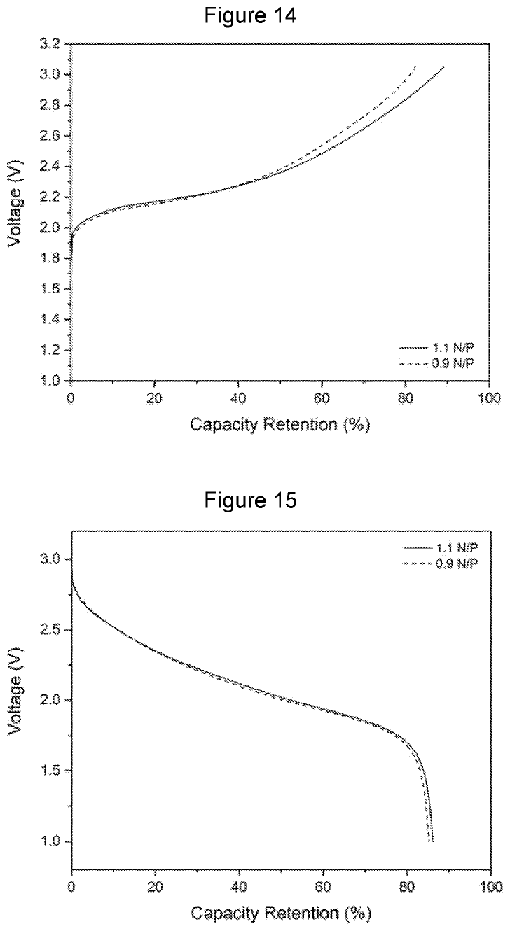

FIG. 14 shows the 10C charge rate test. This test consisted of a C/5 CC discharge followed by a 10C CC charge. This was done to evaluate the fast-charging capability of each system. The graph shows the N/P=1.1 cell design achieving 89% capacity retention compared to 82% of the N/P=0.9 cell design.

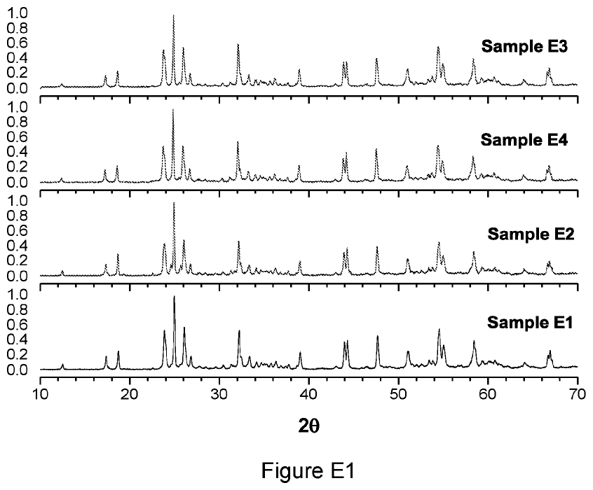

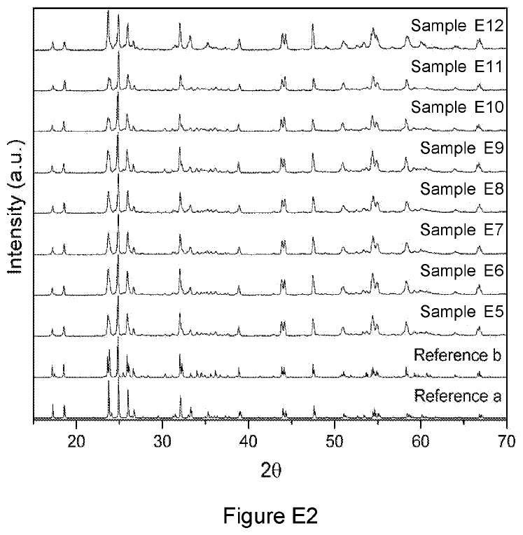

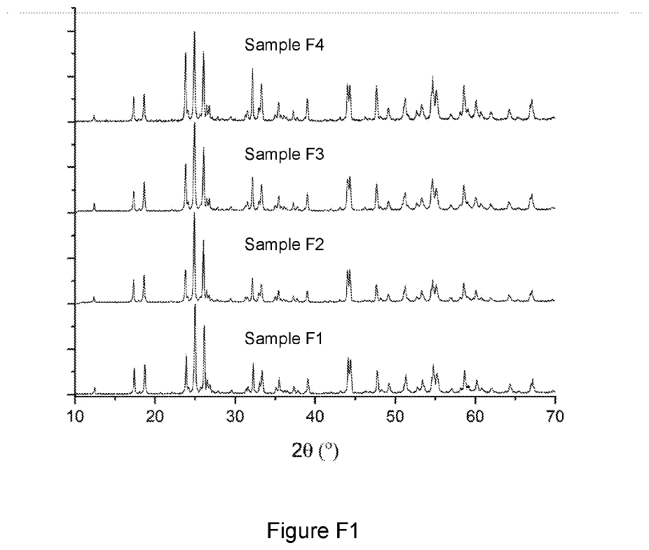

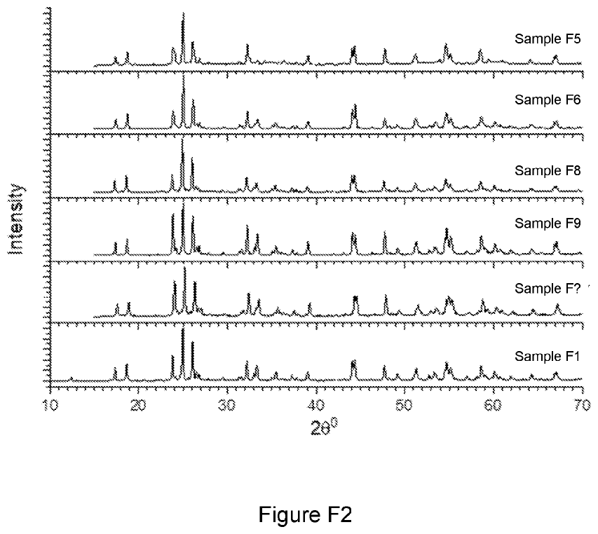

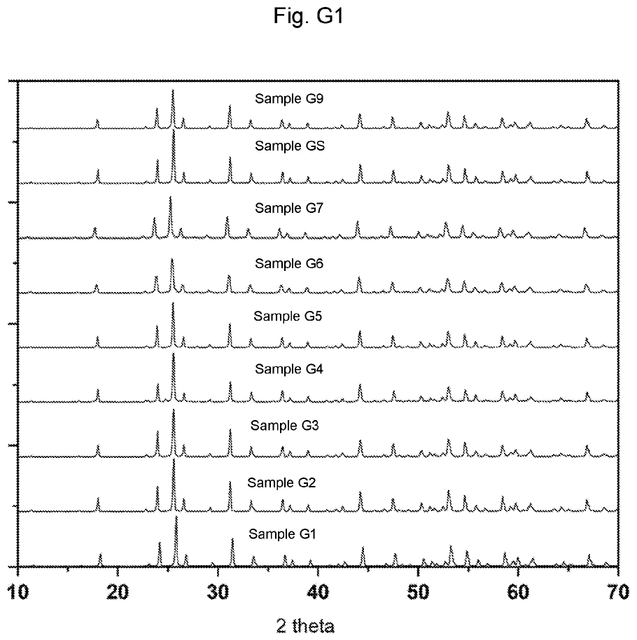

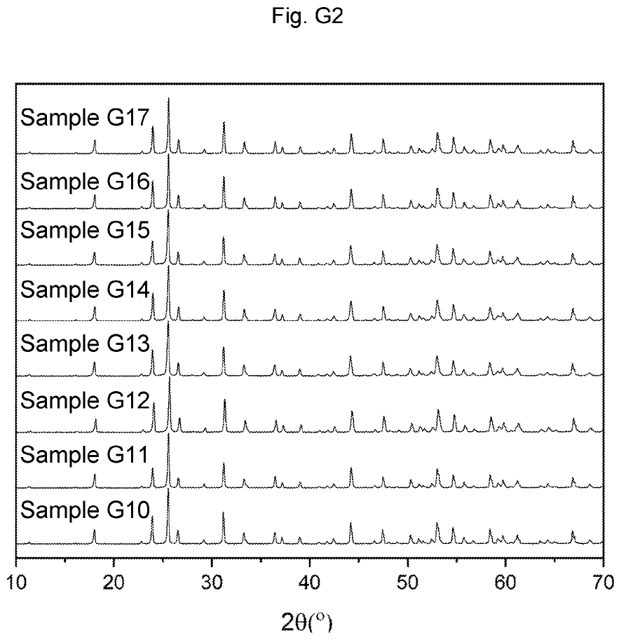

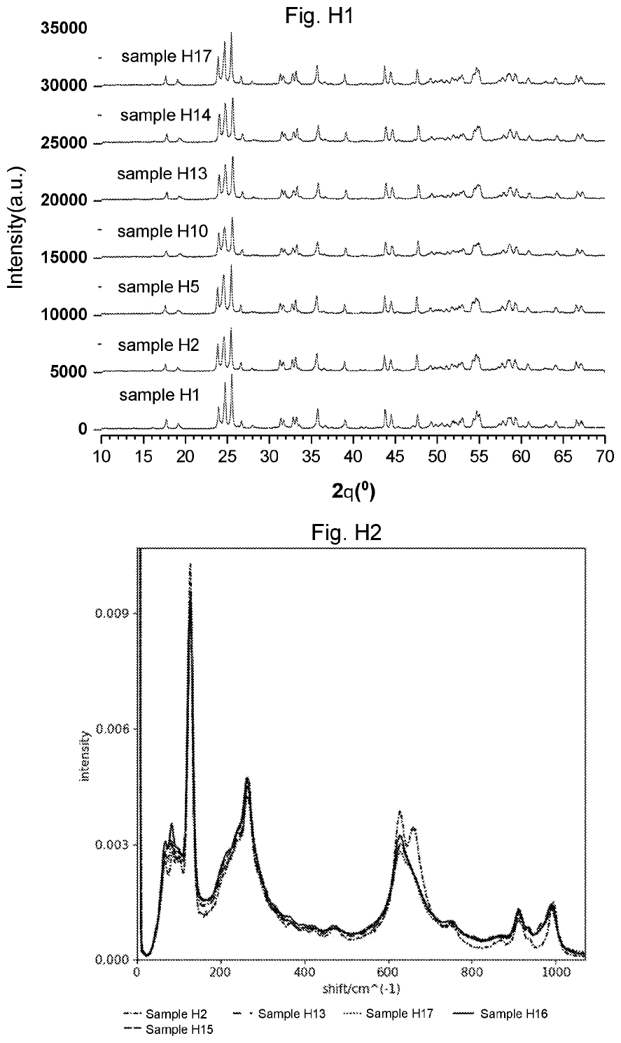

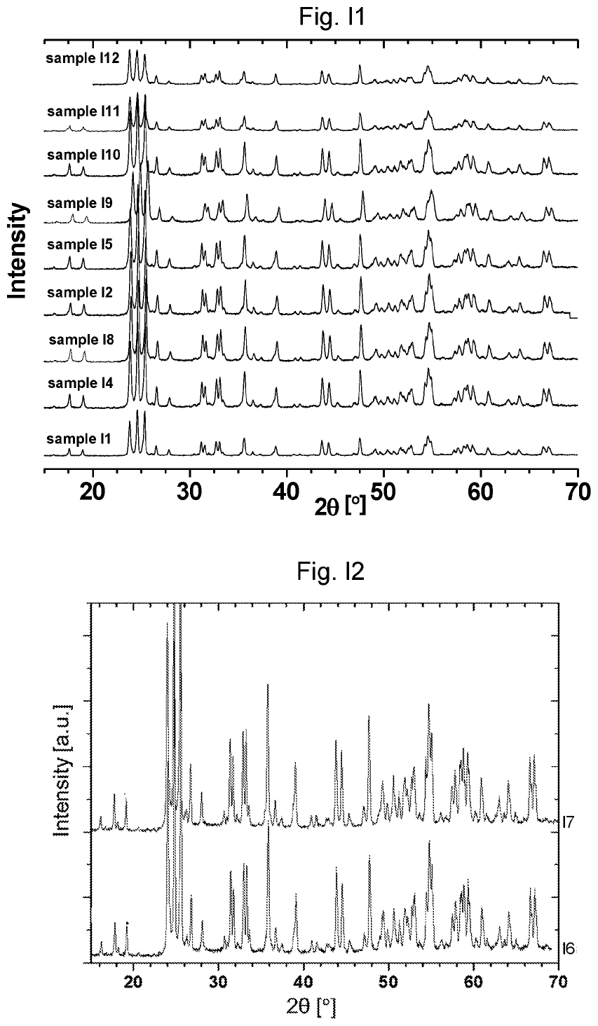

FIG. 15 shows a 10C discharge rate test. This test consisted of a C/5 CC CV (until C/40) charge followed by a 10C CC discharge. This was done to evaluate the discharge rate capability of each system. The graph shows the N/P=1.1 cell design achieving 86% capacity retention compared to 85% for the N/P=0.9 cell design.

### Reference Examples

The following reference examples demonstrate how to synthesise oxides comprising niobium as active anode materials for use in accordance with the invention. The reference examples demonstrate the electrochemical performance of these materials when tested as half-cells. It is expected that the beneficial properties observed would be also be present when these materials are utilised in full cells at the appropriate N/P ratio in accordance with the invention.

### Reference Examples Related to Formula 1

Mixed niobium oxides were synthesised by a solid-state route. In a first step precursor materials (Nb₂O₅, GeO₂, ZnO, TiO₂, Cr₂O₃, Al₂O₃, Fe₂O₃, ZrO₂, and CuO) were milled to a D₅₀(v/v) particle size below 20 μm. The materials were mixed in stoichiometric proportions (50 g total) and combined in a homogeneous powder mixture by an impact mill at 20,000 rpm. The resulting powders were heat treated in an alumina crucible in a muffle furnace in air at T₁=600-1350° C. for 0.5-24 h, providing the desired Wadsley-Roth phase. Selected samples (E9-E11) were removed from the furnace after heat treatment, ground by impact mill at 20,000 rpm, and then had repeated heat treatment under similar conditions. Specifically, the precursor mixture was heated at a ramp rate of 5°/min to temperatures at or below 800° C., followed by a ramp rate of 1°/min to the maximum temperature for a holding period. An additional heat treatment step was also applied in some cases under a N₂ atmosphere at T₂=600-1350° C. for 0.5-12 h. For inclusion of anions, there was an additional milling/mixing step with the precursor (PVDF in a 1:10 mass ratio for F; if N is required then C₃H₆N₆ in a 1:3 mass ratio versus the parent material may be used) prior to heat treatment in a N₂ or air atmosphere in one or two steps at T₂ₐ/T_{2b}=300-1200° C. for 0.5-12 h.

A final de-agglomeration step was utilised by impact milling or jet milling to adjust to the desired particle size distribution where necessary. Specifically, the material was de-agglomerated by impact milling at 20,000 RPM for 10 seconds. Particle Size Distributions were obtained with a Horiba laser diffraction particle analyser for dry powder. Air pressure was kept at 0.3 MPa. The results are set out in Table E1.

TABLE E1
A summary of the materials synthesised. Particle size distribution
has been evaluated by dry powder laser diffraction.

| | | T₁ | T₂ₐ | T_{2b} | D10 | D50 | D90 |
|---|---|---|---|---|---|---|---|
| Sample | Material | (° C.; h) | (° C.; h) | (° C.; h) | (μm) | (μm) | (μm) |
| E1* | Zn₂Nb₃₄O₈₇ | 1200; 12 | — | — | 4.6 | 8.1 | 15.1 |
| E2** | Zn₂Nb₃₄O₈₇₋ₓ | 1200; 12 | 1200^{†}; 5 | — | 4.4 | 7.4 | 12.3 |
| E3 | Ge_{0.1}Zn_{1.9}Nb₃₄O_{87.1}*** | 1200; 12 | — | — | 5.1 | 9.2 | 16.5 |
| E4 | Zn₂Nb₃₄O_{87-y}F_{y} | 1200; 12 | 1200; 5^{†} | 375; 24 | 4.0 | 6.8 | 11.3 |
| E5 | Cr_{0.4}Zn_{1.6}Ti_{0.4}Nb_{33.6}O₈₇ | 1100; 12 | — | — | 3.4 | 5.4 | 8.3 |
| E6 | Cr_{0.6}Zn_{1.4}Ti_{0.6}Nb_{33.4}O₈₇ | 1100; 12 | — | — | 3.5 | 5.4 | 8.5 |
| E7 | Cr_{0.8}Zn_{1.2}Ti_{0.8}Nb_{33.2}O₈₇ | 1100; 12 | — | — | 3.4 | 5.5 | 8.5 |
| E8 | Cr_{0.99}Zn_{1.01}Ti_{0.99}Nb_{33.01}O₈₇ | 1100; 12 | — | — | 3.4 | 5.5 | 8.4 |
| E9 | Cr_{0.4}Zn_{1.6}Zr_{0.4}Nb_{33.6}O₈₇ | 1100; 12 x3 | — | — | 3.6 | 5.6 | 8.5 |
| E10 | Zn₂Fe_{0.2}Nb_{33.8}O_{86.8}*** | 1100; 12 x2 | — | — | 3.8 | 5.8 | 8.8 |
| E11 | Al_{0.1}Zn_{1.9}Nb₃₄O_{87.05}*** | 1100; 12 x2 | — | — | 4.0 | 6.1 | 9.2 |
| E12 | Cr_{0.99}Cu_{1.01}Ti_{0.99}Nb_{33.01}O₈₇ | 1100; 12 | — | — | 2.9 | 6.0 | 11.5 |

*Comparative sample—unmodified ‘base’ Zn₂Nb₃₄O₈₇
**Induced oxygen deficiency may be calculated from e.g. TGA
***Oxygen stoichiometry calculated assuming Ge⁴⁺, Zn²⁺, Fe³⁺, Al³⁺, and Nb⁵⁺
^{†}This heat treatment step was carried out in a N₂ atmosphere. All others were carried out in an air atmosphere.

### Materials Characterisation

The phase purity of samples was analysed using a Rigaku Miniflex powder X-ray diffractometer in 20 range (10-70°) at 1°/min scan rate.

FIG. E1 shows the measured XRD diffraction patterns for Samples E1-E4, and FIG. E2 for Samples E5-E12. Diffraction patterns have peaks at the same locations (with some shift due to crystal modification, up to around 0.2°), and match crystallography database entry JCPDS 28-1478. Certain samples were found to be a phase mixture of monoclinic (JCPDS 28-1478, Reference a) and orthorhombic (PDF card: 04-021-7859, Reference b) crystal structures of the same Wadsley-Roth block structure (Zn₂Nb₃₄O₇), and so have been refined to this mixture. There is no amorphous background noise and the peaks are sharp and intense. This means that all samples are crystalline, with crystallite size 45-55 nm according to the Scherrer equation and crystal structure matching Zn₂Nb₃₄O₈₇. This confirms the presence of a Wadsley-Roth crystal structure.

TABLE E2
A summary table of unit cell parameters for each sample calculated by Rietveld
refinement of their powder XRD spectra with software GSASII, and average crystallite
size calculated by the Scherrer equation across the spectra.

| | | | | | | | | Crystallite |
|---|---|---|---|---|---|---|---|---|
| Sample | a [Å] | b [Å] | c [Å] | β [°] | Vol [Å³] | χ² | % Phase | size [nm] |
| Reference a | 15.57 | 3.814 | 20.54 | 113.68 | 1117.02 | — | — | — |
| Reference b | 28.709 | 3.826 | 20.624 | 90 | 2265.15 | — | — | — |
| E1* | 15.533 | 3.807 | 20.560 | 113.09 | 1118.61 | 9 | 100 a | 48 |
| E2 | 15.537 | 3.806 | 20.563 | 113.16 | 1118.09 | 10 | 100 a | 49 |
| E3 | 15.560 | 3.823 | 20.649 | 113.16 | 1132.80 | 10 | 100 a | 48 |
| E4 | 15.542 | 3.808 | 20.562 | 113.15 | 1119.05 | 11 | 100 a | 51 |
| E5a | 15.594 | 3.829 | 20.643 | 113.02 | 1134.41 | 10 | 34 a | 48 |
| E5b | 28.710 | 3.827 | 20.650 | 90 | 2269.10 | | 66 b | |
| E6a | 15.594 | 3.828 | 20.635 | 113.04 | 1133.55 | 9 | 43 a | 50 |
| E6b | 28.703 | 3.827 | 20.645 | 90 | 2267.69 | | 57 b | |
| E7a | 15.587 | 3.828 | 20.621 | 113.05 | 1132.23 | 9 | 40 a | 50 |
| E7b | 28.693 | 3.827 | 20.635 | 90 | 2265.88 | | 60 b | |
| E8a | 15.584 | 3.828 | 20.612 | 113.07 | 1131.35 | 9 | 41 a | 52 |
| E8b | 28.687 | 3.827 | 20.628 | 90 | 2264.52 | | 59 b | |
| E9a | 15.606 | 3.830 | 20.650 | 113.07 | 1135.47 | 10 | 25 a | 48 |
| E9b | 28.725 | 3.828 | 20.658 | 90 | 2271.51 | | 75 b | |
| E10a | 15.608 | 3.830 | 20.655 | 113.10 | 1135.74 | 10 | 12 a | 48 |
| E10b | 28.726 | 3.828 | 20.664 | 90 | 2272.61 | | 88 b | |
| E11a | 15.608 | 3.827 | 20.648 | 113.11 | 1134.28 | 11 | 12 a | 48 |
| E11b | 28.722 | 3.829 | 20.667 | 90 | 2272.87 | | 88 b | |
| E12 | 15.566 | 3.831 | 20.610 | 113.12 | 1130.41 | 12 | 100 a | 49 |

χ² represents the goodness of fit and the accuracy of the Rietveld refinement.

### Electrochemical Characterisation

Electrochemical tests were carried out in half-coin cells (CR2032 size) for analysis. In half-coin tests, the active material is tested in an electrode versus a Li metal electrode to assess its fundamental performance. In the below reference examples, the active material composition to be tested was combined with N-Methyl Pyrrolidone (NMP), carbon black (Super P) acting as a conductive additive, and poly(vinyldifluoride) (PVDF) binder and mixed to form a slurry using a lab-scale centrifugal planetary mixer. The non-NMP composition of the slurries was 92 wt % active material, 3 wt % conductive additive, 5 wt % binder. The slurry was coated on an Al foil current collector to the desired loading of 69-75 g m⁻² by doctor blade coating and dried by heating. The electrodes were then calendared to a density of 2.6-2.9 g cm⁻³ at 80° C. to achieve targeted porosities of 35-40%. Electrodes were punched out at the desired size and combined with a separator (Celgard porous PP/PE), Li metal, and electrolyte (1.3 M LiPF₆ in EC/DEC) inside a steel coin cell casing and sealed under pressure. Cycling was then carried out at 23° C. at low current rates (C/10) for 2 full cycles of lithiation and de-lithiation between 1.1-3.0 V. Afterwards, the cells were tested for their performance at increasing current densities. During these tests, the cells were cycled asymmetric at 23° C., with a slow lithiation (C/5) followed by increasing de-lithiation rates (e.g. 1C, 5C, 10C) to provide the capacity retention, and nominal voltage at 5C. Nominal voltage vs Li/Li+ has been calculated from the integral of the V/Q curve divided by the total capacity at 5C during de-lithiation. No constant voltage steps were used. Data has been averaged from 5 cells prepared from the same electrode composition, with the error shown from the standard deviation. Accordingly, the data represent a robust study showing the improvements achieved by the materials according to the invention compared to prior materials. These data are shown in Tables E4 and E5.

Cell resistance has been calculated from the Direct Current Internal Resistance (DCIR) of the half coin cell. In a typical measurement, the cell is lithiated to 100% State of Charge (SOC) and then delithiated to 50% SOC at a rate of C/10, then after a rest of 0.5 h a 5C delithiation pulse is applied for 10 s, followed by another rest of 0.5 h. The DCIR is then calculated from V=IR, using the voltage immediately before the peak from the pulse, and the measured maximum voltage during the pulse.

The electrical resistivity of the electrode composition was separately assessed by a 4-point-probe method with an Ossila instrument (T2001 A3-UK) at 23° C. Slurries were formulated (the active material composition to be tested was combined with N-Methyl Pyrrolidone (NMP), carbon black acting as a conductive additive, and poly(vinyldifluoride) (PVDF) binder and mixed to form a slurry using a lab-scale centrifugal planetary mixer; the non-NMP composition of the slurries was 80 w.% active material, 10 w.% conductive additive, 10 w.% binder). The slurry was then coated on a dielectric mylar film at a loading of 1 mg/cm². Electrode-sized discs where then punched out and resistance of the coated-film was measured using a 4-point probe. The results for sheet resistance (Ω/square) are outlined in Table E3, with error based on the standard deviation of 3 measurements.

Homogeneous, smooth coatings on both Cu and Al current collector foils, the coatings being free of visible defects or aggregates may also be prepared as above for these samples with a centrifugal planetary mixer to a composition of up to 94 wt % active material, 4 wt % conductive additive, 2 wt % binder. These can be prepared with both PVDF (i.e. NMP-based) and CMC:SBR-based (i.e. water-based) binder systems. The coatings can be calendared at 80° C. for PVDF and 50° C. for CMC:SBR to porosities of 35-40% at loadings from 1.0 to 5.0 mAh cm⁻². This is important to demonstrate the viability of these materials in both high energy and high-power applications, with high active material content.

TABLE E3
Summary of 4-point probe resistivity measurement results

| Sample | Sheet Resistivity [Ω/square] |
|---|---|
| E1* | 1242 ± 156 |
| E2 | 1027 ± 13 |
| E3 | 1041 ± 103 |

TABLE E4
A summary of electrochemical testing results from Li-ion half coin
cells. In general it is beneficial to have a higher capacity,
a higher Coulombic efficiency, and a lower nominal voltage.

| | Delithiation | | |
|---|---|---|---|
| | specific | | |
| | capacity 2^{nd} | Coulombic efficiency | Nominal de-lithiation |
| | C/10 cycle | 1^{st} cycle at | voltage at 5 C vs |
| Sample | [mAh/g] | C/10 [%] | Li/Li⁺ [V] |
| E1* | 196 ± 1 | 97.84 ± 0.02 | 1.836 ± 0.008 |
| E2 | 197 ± 1 | 98.18 ± 0.54 | 1.816 ± 0.010 |
| E3 | 201 ± 1 | 98.08 ± 0.09 | 1.776 ± 0.013 |
| E4 | 200 ± 4 | 97.76 ± 0.15 | 1.859 ± 0.028 |
| E5 | 206 ± 1 | 99.09 ± 0.64 | 1.820 ± 0.007 |
| E6 | 208 ± 3 | 98.69 ± 0.11 | 1.821 ± 0.002 |
| E7 | 213 ± 2 | 98.82 ± 0.31 | 1.799 ± 0.001 |
| E8 | 212 ± 2 | 98.87 ± 0.27 | 1.795 ± 0.003 |
| E9 | 202 ± 1 | 98.46 ± 0.15 | 1.787 ± 0.001 |
| E10 | 201 ± 3 | 98.27 ± 0.32 | 1.818 ± 0.004 |
| E11 | 205 ± 1 | 98.51 ± 0.51 | 1.813 ± 0.004 |
| E12 | 208 ± 1 | 93.20 ± 0.07 | 1.827 ± 0.002 |

*Comparative sample

TABLE E5
A summary of further electrochemical testing
results from Li-ion half coin cells.

| | Delithiation | Delithiation | Delithiation |
|---|---|---|---|
| | specific capacity | specific capacity | specific capacity |
| Sample | 1 C [mAh/g] | 5 C [mAh/g] | 10 C [mAh/g] |
| E1* | 190 ± 2 | 186 ± 2 | 180 ± 4 |
| E2 | 192 ± 2 | 191 ± 2 | 184 ± 3 |
| E3 | 195 ± 1 | 192 ± 1 | 184 ± 2 |
| E4 | 194 ± 4 | 191 ± 4 | 180 ± 7 |
| E5 | 202 ± 2 | 200 ± 2 | 192 ± 1 |
| E6 | 202 ± 2 | 198 ± 2 | 191 ± 2 |
| E7 | 205 ± 4 | 203 ± 3 | 194 ± 2 |
| E8 | 206 ± 1 | 202 ± 1 | 197 ± 1 |
| ES | 197 ± 2 | 194 ± 2 | 190 ± 2 |
| E10 | 193 ± 2 | 191 ± 2 | 188 ± 2 |
| E11 | 198 ± 3 | 196 ± 3 | 192 ± 3 |
| E12 | 203 ± 1 | 202 ± 1 | 195 ± 1 |

*Comparative sample

TABLE E6
A summary of further electrochemical testing
results from Li-ion half coin cells

| | De-lithiation | De-lithiation | De-lithiation | |
|---|---|---|---|---|
| | capacity | capacity | capacity | Cell |
| | retention | retention | retention | resistance |
| Sample | 1 C/0.5 C [%] | 5 C/0.5 C [%] | 10 C/0.5 C [%] | [mOhms] |
| E1* | 99.6 ± 0.3 | 97.5 ± 0.6 | 94.1 ± 2.1 | 21.7 ± 0.8 |
| E2 | 99.6 ± 0.1 | 98.7 ± 0.2 | 95.3 ± 1.3 | 18.8 ± 0.7 |
| E3 | 99.9 ± 0.1 | 98.2 ± 0.3 | 94.1 ± 1.0 | 18.4 ± 1.1 |
| E4 | 99.6 ± 0.1 | 98.3 ± 0.9 | 92.5 ± 2.5 | 23.2 ± 5.7 |
| E5 | 99.9 ± 0.1 | 98.7 ± 0.1 | 94.9 ± 0.5 | 18.0 ± 1.0 |
| E6 | 99.5 ± 0.1 | 97.7 ± 0.3 | 94.4 ± 0.7 | 19.6 ± 1.1 |
| E7 | 99.7 ± 0.1 | 98.6 ± 0.3 | 94.2 ± 1.0 | 17.0 ± 0.6 |
| E8 | 99.6 ± 0.1 | 98.5 ± 0.1 | 96.0 ± 0.6 | 18.8 ± 1.1 |
| E9 | 99.6 ± 0.2 | 98.0 ± 0.4 | 95.9 ± 0.3 | 19.6 ± 0.4 |
| E10 | 99.7 ± 0.1 | 98.7 ± 0.4 | 96.7 ± 0.5 | 21.5 ± 1.4 |
| E11 | 99.6 ± 0.1 | 98.4 ± 0.4 | 96.5 ± 0.5 | 20.1 ± 1.6 |
| E12 | 99.9 ± 0.1 | 99.5 ± 0.1 | 96.2 ± 0.5 | 20.6 ± 0.8 |

*Comparative sample

### Discussion

The mixed niobium oxide Sample E1* has been modified through a cation substitution approach in Sample E3, focussed at the Zn²⁺ cations substituted by Ge⁴⁺. In Samples E5-E8, Zn²⁺ cations have been substituted by Cr³⁺ cations and Nb⁵⁺ cations have been substituted by T₁⁴⁺ cations, spanning a wide range of the variables a and b. Sample E10 substitutes Nb⁵⁺ by Fe³⁺. Sample E11 substitutes Zn²⁺ by Al³⁺. Sample E12 is based on Cu₂Nb₃₄O₈₇ where Cu²⁺ cations have been substituted by Cr³⁺ cations and Nb⁵⁺ cations have been substituted by T₁⁴⁺ cations. Increased valency may be compensated for by partial oxygen excess (i.e. c<0) and/or partial reduction of Nb⁵⁺. Decreased vacancy may be compensated for by the formation of oxygen vacancies (i.e. c>0). These modifications are expected to provide an advantage versus the base crystal structure of Sample E1* through the combination of (a) altered ionic radii, (b) altered valency, and (c) altered voltage. Altered ionic radii can give rise to beneficial changes in electrochemical performance due to changing unit cell size and local distortions in crystal structure altering available lithiation sites or lithiation pathways—potentially improving Coulombic efficiency, capacity, performance at high rate, and lifetime. Altered valency provides significantly improved electrical conductivity of the material due to providing available intermediate energy levels for charge carriers. These effects are shown by the lower resistivity observed in Table E3 of the modified samples vs. Sample E1*, and by the improvements in specific capacity, coulombic efficiency, de-lithiation voltage at 5C, and capacity retention at 1 C, 5C, and 10C observed in Tables E4-E6. These are key results demonstrating the utility of the modified mixed niobium oxides according to the invention for use in high-power Li-ion cells designed for fast charge/discharge.

Table E2 demonstrates the alterations in unit cell parameters observed upon cation exchange, observed due to alterations of ionic radii and electronic structure of these materials.

It is expected that similar benefits will be observed with the described cation exchange approach for this material for use in Li-ion cells.

The mixed niobium oxide Sample E1*has modified through the introduction of induced oxygen deficiency by a heat treatment in an inert or reducing atmosphere to provide Sample E2. By treating the ‘base’ oxide at high temperature in an inert or reducing atmosphere it may be partially reduced, and maintain this upon return to room temperature and exposure to an air atmosphere. This is accompanied with an obvious colour change, for example Sample E2 is grey/black in colour vs white for Sample E1*. This colour change demonstrates a significant change in the electronic structure of the material, allowing it to interact with different energies (i.e. wavelength) of visible light due to the reduced band gap. This is reflected in sample E2, demonstrating an improved delithiation voltage at a rate of 5C, which corresponds to a reduced level of polarisation in the cell.

The induced oxygen deficiency results in a defect in the crystal structure, e.g. where an oxygen anion has been removed, and the overall redox state of the cations is reduced in turn. This provides additional energetic states improving material electrical conductivity significantly, and alters the band gap energy as demonstrated by colour changes. This is shown by the lower resistivity observed in Table E3 for Sample E2 vs. Sample E1*. If induced oxygen deficiency is present beyond 5 atomic % (i.e. c>4.35), then the crystal structure may be less stable.

The mixed niobium oxide Sample E1*has modified through anion substitution (O²⁻ by F⁻) to provide Sample E4. Improvements in specific capacity were observed (Tables E4 and E5).

It is expected that similar benefits will be observed in any of the described mixed niobium oxides utilising any combination of M1, M2, M3, Q, a, b, c, and d within the described limits for use in Li ion cells.

### Reference Examples Related to Formula 2

Mixed niobium oxides were synthesised by a solid-state route. In a first step precursor materials (Nb₂O₅, Ga₂O₃, ZnO, ZrO₂, Cr₂O₃, CeO₂, and Al₂O₃) were milled to a D₅₀(v/v) particle size below 20 μm. The materials were mixed in stoichiometric proportions (50 g total) and combined in a homogeneous powder mixture by an impact mill at 20,000 rpm. The resulting powders were heat treated in an alumina crucible in a muffle furnace in air at T₁=600-1350° C. for 0.5-24 h, providing the desired Wadsley-Roth phase. Specifically, the precursor mixture was heated at a ramp rate of 5°/min to temperatures at or below 800° C., followed by a ramp rate of 1°/min to the maximum temperature for a holding period. An additional heat treatment step was also applied in some cases under a N₂ atmosphere at T₂=600-1350° C. for 0.5-12 h. For inclusion of anions, there was an additional milling/mixing step with the precursor (PVDF in a 1:10 mass ratio for F; if N is required then C₃H₆N₆ in a 1:3 mass ratio versus the parent material may be used) prior to heat treatment in a N₂ or air atmosphere in one or two steps at T₂ₐ/T_{2b}=300-1300° C. for 0.5-24 h.

A final de-agglomeration step was utilised by impact milling or jet milling to adjust to the desired particle size distribution where necessary. Specifically, the material was de-agglomerated by impact milling at 20,000 RPM for 10 seconds. Particle Size Distributions were obtained with a Horiba laser diffraction particle analyser for dry powder. Air pressure was kept at 0.3 MPa. The results are set out in Table F1.

TABLE F1
A summary of the materials synthesised. Particle size distribution
has been evaluated by dry powder laser diffraction.

| | | T₁ | T₂ₐ | T_{2b} | D10 | D50 | D90 |
|---|---|---|---|---|---|---|---|
| Sample | Material | (° C.; h) | (° C.; h) | (° C.; h) | (μm) | (μm) | (μm) |
| F1* | AlNb₁₁O₂₉ | 1300; 12 | — | — | 3.9 | 6.6 | 11.0 |
| F2 | Ga_{0.05}Al_{0.95}Nb₁₁O₂₉ | 1300; 12 | — | — | 3.7 | 7.0 | 15.5 |
| F3** | Ga_{0.05}Al_{0.95}Nb₁₁O₂₉₋ₓ | 1300; 12 | 1100; 5^{†} | — | 4.9 | 8.0 | 12.7 |
| F4 | Ga_{0.05}Al_{0.95}Nb₁₁O₂₉₋ₓFₓ | 1300; 12 | 1100; 5^{†} | 375; 24 | 4.0 | 6.6 | 10.8 |
| F5 | Zn_{0.2475}Zr_{0.2475}Al_{0.495}Nb₁₁O₂₉ | 1300; 12 | — | — | 4.6 | 8.3 | 12.8 |
| F6 | Zn_{0.3}Al_{0.7}Mo_{0.55}Nb_{10.45}O_{29.125}*** | 1300; 12 | — | — | 4.5 | 8.0 | 12.1 |
| F7 | Cr_{0.25}Al_{0.75}Nb₁₁O₂₉ | 1100; 24 | — | — | 2.6 | 5.3 | 8.5 |
| F8 | Zn_{0.1}Ce_{0.1}Al_{0.8}Nb₁₁O₂₉ | 1300; 24 | — | — | 4.6 | 9.2 | 14.7 |
| F9 | Zn_{0.1}Al_{0.9}Nb₁₁O_{28.95}*** | 1300; 12 | — | — | 3.5 | 6.8 | 10.1 |

*Comparative sample—unmodified ‘base’ AlNb₁₁O₂₉
**Induced oxygen deficiency may be calculated from e.g. TGA
***Oxygen stoichiometry calculated assuming Zn²⁺, Al³⁺, Mo⁶⁺, and Nb⁵⁺
^{†}This heat treatment step was carried out in a N₂ atmosphere. All others were carried out in an air atmosphere.

### Materials Characterisation

The phase purity of samples was analysed using a Rigaku Miniflex powder X-ray diffractometer in 20 range (10-70°) at 1°/min scan rate.

FIG. F1 shows the measured XRD diffraction patterns for Samples F1-F4 and FIG. F2 shows patterns for Samples F5-F9. Diffraction patterns have peaks at the same locations (with some shift due to crystal modification, up to around 0.2°), and match crystallography database entry JCPDS 22-009. There is no amorphous background noise and the peaks are sharp and intense. This means that all samples are crystalline, with crystallite size 40-60 nm according to the Scherrer equation and crystal structure matching AlNb₁₁O₂₉. This confirms the presence of a Wadsley-Roth crystal structure.

TABLE F2
A summary table of unit cell parameters for each sample
calculated by Rietveld refinement of their powder XRD spectra
with software GSASII, and average crystallite size calculated
by the Scherrer equation across the spectra.

| | a | b | c | β | Vol | | Crystallite |
|---|---|---|---|---|---|---|---|
| Sample | [Å] | [Å] | [Å] | [°] | [Å³] | χ² | size [nm] |
| Reference | 15.57 | 3.814 | 20.54 | 113.68 | 1117.02 | — | — |
| F1* | 15.551 | 3.811 | 20.532 | 113.28 | 1117.98 | 4.4 | 57 |
| F2 | 15.549 | 3.810 | 20.528 | 113.27 | 1117.48 | 9.2 | 60 |
| F3 | 15.555 | 3.810 | 20.538 | 113.29 | 1118.13 | 8.8 | 55 |
| F4 | 15.550 | 3.810 | 20.532 | 113.29 | 1117.72 | 3.8 | 56 |
| F5 | 15.607 | 3.821 | 20.622 | 113.18 | 1130.77 | 7.6 | 43 |
| F6 | 15.555 | 3.816 | 20.570 | 113.18 | 1122.46 | 9.8 | 46 |
| F7 | 15.548 | 3.812 | 20.515 | 113.25 | 1117.28 | 8.7 | 45 |
| F8 | 15.577 | 3.819 | 20.575 | 113.25 | 1124.68 | 8.1 | 51 |
| F9 | 15.592 | 3.822 | 20.595 | 113.24 | 1127.85 | 7.5 | 58 |

χ² represents the goodness of fit and is a representation of the accuracy of the Rietveld refinement, a value ≤10 supports the accuracy of the data.

### Electrochemical Characterisation

Electrochemical tests were carried out in half-coin cells (CR2032 size) for analysis. In half-coin tests, the active material is tested in an electrode versus a Li metal electrode to assess its fundamental performance. In the below reference examples, the active material composition to be tested was combined with N-Methyl Pyrrolidone (NMP), carbon black (Super P) acting as a conductive additive, and poly(vinyldifluoride) (PVDF) binder and mixed to form a slurry using a lab-scale centrifugal planetary mixer. The non-NMP composition of the slurries was 92 wt % active material, 3 wt % conductive additive, 5 wt % binder. The slurry was coated on an Al foil current collector to the desired loading of 69-75 g m⁻² by doctor blade coating and dried by heating. The electrodes were then calendared to a density of 2.6-2.9 g cm⁻³ at 80° C. to achieve targeted porosities of 35-40%. Electrodes were punched out at the desired size and combined with a separator (Celgard porous PP/PE), Li metal, and electrolyte (1.3 M LiPF₆ in EC/DEC) inside a steel coin cell casing and sealed under pressure. Cycling was then carried out at 23° C. at low current rates (C/10) for 2 full cycles of lithiation and de-lithiation between 1.1-3.0 V. Afterwards, the cells were tested for their performance at increasing current densities. During these tests, the cells were cycled asymmetric at 23° C., with a slow lithiation (C/5) followed by increasing de-lithiation rates (e.g. 1C, 5C, 10C) to provide the capacity retention, and nominal voltage at 5C. Nominal voltage vs Li/Li+ has been calculated from the integral of the V/Q curve divided by the total capacity at C/10, and 5C during de-lithiation. No constant voltage steps were used.

Cell resistance has been calculated from the Direct Current Internal Resistance (DCIR) of the half coin cell. In a typical measurement, the cell is lithiated to 100% SOC and then delithiated to 50% SOC at a rate of C/10, then after a rest of 0.5 h a 5C delithiation pulse is applied for 10 s, followed by another rest of 0.5 h. The DCIR is then calculated from V=IR, using the voltage just before the peak and the measured maximum voltage during the pulse.

Data has been averaged from 5 cells prepared from the same electrode composition, with the error shown from the standard deviation. Accordingly, the data represent a robust study showing the improvements achieved by the materials according to the invention compared to prior materials.

Homogeneous, smooth coatings on both Cu and Al current collector foils, the coatings being free of visible defects or aggregates may also be prepared as above for these samples with a centrifugal planetary mixer to a composition of up to 94 wt % active material, 4 wt % conductive additive, 2 wt % binder. These can be prepared with both PVDF (i.e. NMP-based) and CMC:SBR-based (i.e. water-based) binder systems. The coatings can be calendared at 80° C. for PVDF and 50° C. for CMC:SBR to porosities of 35-40% at loadings from 1.0 to 5.0 mAh cm⁻². This is important to demonstrate the viability of these materials in both high energy and high-power applications, with high active material content.

TABLE F3
A summary of electrochemical testing results from Li-ion half coin
cells. In general it is beneficial to have a higher capacity,
a higher Coulombic efficiency, and a lower nominal voltage.

| | Delithiation | | Nominal | Nominal |
|---|---|---|---|---|
| | specific | Coulombic | de-lithiation | de-lithiation |
| | capacity | efficiency | voltage at | voltage at |
| | 2^{nd} C/10 | 1^{st} cycle | C/10 vs | 5 C vs |
| Sample | cycle [mAh/g] | at C/10 [%] | Li/Li⁺ [V] | Li/Li⁺ [V] |
| F1* | 201 ± 4 | 97.84 ± 0.02 | 1.607 ± 0.006 | 1.857 ± 0.015 |
| F2 | 201 ± 4 | 97.83 ± 0.38 | 1.600 ± 0.001 | 1.833 ± 0.009 |
| F3 | 198 ± 3 | 97.17 ± 0.24 | 1.599 ± 0.003 | 1.798 ± 0.011 |
| F4 | 201 ± 2 | 98.87 ± 0.89 | 1.596 ± 0.011 | 1.811 ± 0.055 |
| F5 | 199 ± 1 | 97.98 ± 0.18 | 1.591 ± 0.001 | 1.817 ± 0.002 |
| F6 | 191 ± 3 | 97.12 ± 0.42 | 1.614 ± 0.001 | 1.888 ± 0.005 |
| F7 | 206 ± 3 | 98.46 ± 0.21 | 1.583 ± 0.003 | 1.819 ± 0.019 |
| F8 | 195 ± 1 | 97.27 ± 0.22 | 1.608 ± 0.001 | 1.910 ± 0.007 |
| F9 | 200 ± 1 | 97.46 ± 0.09 | 1.596 ± 0.004 | 1.852 ± 0.010 |

*Comparative sample

TABLE F4
A summary of further electrochemical testing
results from Li-ion half coin cells.

| | De-lithiation | De-lithiation | De-lithiation |
|---|---|---|---|
| | capacity retention | capacity retention | capacity retention |
| Sample | 1 C/0.5 C [%] | 5 C/0.5 C [%] | 10 C/0.5 C [%] |
| F1* | 99.2 ± 0.1 | 96.2 ± 0.4 | 91.8 ± 1.3 |
| F2 | 99.2 ± 0.1 | 96.5 ± 0.5 | 93.5 ± 1.4 |
| F3 | 99.3 ± 0.6 | 97.7 ± 1.6 | 95.3 ± 2.1 |
| F4 | 99.9 ± 0.2 | 99.0 ± 0.5 | 96.6 ± 1.1 |
| F5 | 99.6 ± 0.0 | 97.3 ± 0.0 | 94.4 ± 0.5 |
| F6 | 100.3 ± 0.1 | 98.5 ± 0.5 | 95.2 ± 0.2 |
| F7 | 99.6 ± 0.2 | 97.8 ± 0.5 | 94.7 ± 1.2 |
| F8 | 99.8 ± 0.1 | 96.6 ± 0.2 | 88.3 ± 1.5 |
| F9 | 99.6 ± 0.2 | 97.7 ± 0.4 | 93.2 ± 2.3 |

*Comparative sample

### DISCUSSION

The mixed niobium oxide Sample F1* has been modified through a cation substitution approach in Sample F2, focussed at the Al³⁺ cations substituted by Ga³⁺. Samples F5-F9 substitute Al³⁺ by further cations (Zn²⁺, Zr⁴⁺, Cr³⁺, and Ce⁴⁺). This is expected to provide an advantage versus the base crystal structure of Sample F1* through the combination of altered ionic radii and altered voltage. Table F2 demonstrates the alterations in unit cell parameters observed upon cation exchange, observed due to alterations of ionic radii and electronic structure of these materials. Altered ionic radii can give rise to beneficial changes in electrochemical performance due to changing unit cell size and local distortions in crystal structure altering available lithiation sites or lithiation pathways—potentially improving capacity, performance at high rate, and lifetime. For example, the ionic radius of the 6-coordinate Ga³⁺ cation is 0.62 Å vs the ionic radius of 6-coordinate Al³⁺ cation of 0.54 Å. These effects are shown in Table F3 by the improved lower de-lithiation voltages at C/10 and 5C for the modified samples compared to Sample F1*. Moreover, Table F4 shows improved capacity retention at rates of 5C and above, with greater improvement at the higher rate of 10C, a key result in demonstrating the utility of the modified mixed niobium oxides according to the invention for use in high-power Li-ion cells designed for fast charge/discharge. It is expected that similar benefits will be observed with the described cation exchange approach for this material for use in Li-ion cells.

The mixed niobium oxide has been modified through the introduction of F⁻ anions to provide Sample F4. In a similar fashion to cation exchange, this exchange may take place in an O²⁻ anion site, in which case the increased valency may increase the electronic conductivity of the material. It may also take place in an interstitial site within the crystal structure. In both cases, this may also give rise to different unit cell size and associated crystallographic distortions due to the differing ionic radii and valency of the anions, providing similar potential benefits to cation exchange. It is expected that similar benefits will be observed through the use of anions of different electronegativity and valency with any of the described MNO structures for use in Li ion cells.

The mixed niobium oxide has been modified by induced oxygen deficiency to provide Sample F3 by a heat treatment in an inert or reducing atmosphere. By treating these materials at high temperature in an inert or reducing atmosphere, they may be partially reduced and maintain this upon return to room temperature and exposure to an air atmosphere. This is reflected in Table F4, with Sample F3 having further improved capacity retention compared to Sample F1* in particular at 5C and above, and further improved cell resistance.

The induced oxygen deficiency is a defect in the crystal structure e.g. where an oxygen anion has been removed, and the overall redox state of the cations is reduced in turn. This provides additional energetic states improving material electrical conductivity significantly, and alters the band gap energy. If induced oxygen deficiency is present beyond 5 atomic % (i.e. c>1.45), then the crystal structure may be less stable.

It is expected that similar benefits will be observed in any of the described MNO structures utilising any combination of M4, M5, Q, a, b, c, and d within the described limits for use in Li ion cells.

### Reference Examples Related to Formula 3

A base phosphorus niobium oxide material was synthesised by a solid-state route. In a first step precursor materials (Nb₂O₅, NH₄H₂PO₄, TiO₂, MoO₃, H₃BO₃, Al₂O₃, ZrO₂, GeO₂, Ga₂O₃, Cr₂O₃) were mixed in stoichiometric proportions (350 g total) and ball-milled at 550 rpm with a ball to powder ratio of 10:1 for 3 h. The resulting powders were heat treated in an alumina crucible in a muffle furnace in air at T₁ₐ=250-600° C. for 1-12 h followed by T_{1b}=800-1350° C. for 4-24 h, providing the desired Wadsley-Roth phase. An additional heat treatment step was also applied in some cases under a N₂ atmosphere at T₂₌₈₀₀-1350° C. for 1-12 h to result in induced oxygen deficiencies (oxygen vacancies) in the base crystal structure. For inclusion of anions, there was an additional milling/mixing step with the precursor (NH₄HCO₃ for N in a 1:3 mass ratio, PVDF for F in a 1:10 mass ratio) prior to heat treatment in a N₂ atmosphere for N and an air atmosphere for F at T₂₌₄₀₀-1200° C. for 1-24 h.

A final de-agglomeration step was utilised by impact milling or jet milling to adjust to the desired particle size distribution where necessary. Specifically, the material was de-agglomerated by impact milling at 20,000 RPM for 10 seconds.

TABLE G1
A summary of the materials synthesised. Particle size distribution
has been evaluated by dry powder laser diffraction.

| | | T₁ₐ | T_{1b} | T₂ | D10 | D50 | D90 |
|---|---|---|---|---|---|---|---|
| Sample | Material | (° C.; h) | (° C.; h) | (° C.; h) | (μm) | (μm) | (μm) |
| G1* | PNb₉O₂₅ | 380; 6 | 1200; 12 | — | 2.7 | 5.7 | 11.0 |
| G2 | PNb₉O_{24.990}** | 380; 6 | 1200; 24 | 1200; 5 | 4.0 | 6.9 | 11.5 |
| G3 | Ti_{0.05}Mo_{0.05}P_{0.90}Nb₉O₂₅ | 380; 6 | 1200; 12 | — | 2.6 | 5.4 | 10.0 |
| G4 | PTi_{0.45}Mo_{0.45}Nb_{8.10}O₂₅ | 380; 6 | 1200; 12 | — | 3.9 | 6.8 | 12.1 |
| G5 | PTi_{0.225}Mo_{0.225}Nb_{8.45}O₂₅ | 380; 6 | 1200; 16 | — | 3.7 | 6.6 | 11.7 |
| G6 | Al_{0.05}P_{0.95}Ti_{0.225}Mo_{0.225}Nb_{8.55}O_{24.95}** | 380; 6 | 1200; 16 | — | 4.5 | 7.9 | 13.5 |
| G7 | Al_{0.05}P_{0.95}Ti_{0.225}Mo_{0.225}Nb_{8.55}O_{24.937}** | 380; 6 | 1200; 12 | 1200; 5 | 4.2 | 7.0 | 11.7 |
| G8 | PTi_{0.225}Mo_{0.225}Nb_{8.55}O_{25-d}N_{d} | 380; 6 | 1200; 16 | 900; 1 | 5.0 | 9.0 | 17.6 |
| G9 | B_{0.05}P_{0.95}Nb₉O_{24.95}** | 380; 6 | 1200; 12 | — | 2.8 | 6.0 | 11.3 |
| G10 | PNb₉O_{25-d}F_{d} | 380; 6 | 1200; 12 | 435; 24 | 2.7 | 5.7 | 11 |
| G11 | Mo_{0.05}P_{0.95}Nb₉O_{25.025}** | 380; 6 | 1200; 12 | — | 2.5 | 4.8 | 8.5 |
| G12 | PZr_{0.05}Nb_{8.95}O_{24.975}** | 380; 6 | 1200; 12 | — | 2.4 | 5.5 | 12.1 |
| G13 | PGe_{0.05}Nb_{8.95}O_{24.975}** | 380; 6 | 1200; 12 | — | 2.6 | 5.7 | 13.9 |
| G14 | Ge_{0.05}P_{0.95}Nb₉O_{24.975}** | 380; 6 | 1200; 12 | — | 1.9 | 5.0 | 18.8 |
| G15 | PGa_{0.05}Nb_{8.95}O_{24.95}** | 380; 6 | 1200; 12 | — | 1.9 | 4.8 | 12.3 |
| G16 | PCr_{0.05}Nb_{8.95}O_{24.95}** | 380; 6 | 1200; 12 | — | 2.9 | 6.0 | 11.2 |
| G17 | Cr_{0.05}P_{0.95}Nb₉O_{24.95}** | 380; 6 | 1200; 12 | — | 2.9 | 5.8 | 10.9 |

*Comparative sample—unmodified
**Induced oxygen deficiency calculated from TGA mass loss, and inherent oxygen deficiency or excess calculated from cation or anion exchange assuming a charge-balanced structure and site-specific substitution.

### Materials Characterisation

The phase purity of samples was analysed using a Rigaku Miniflex powder X-ray diffractometer in 20 range (20-70°) at 1°/min scan rate.

FIG. G1 shows the measured XRD diffraction patterns for Samples G1-G9. FIG. G2 shows the measured XRD diffraction patterns for Samples G10-G17. Diffraction patterns have peaks at the same locations (with some shift due to doping, up to around 0.2°), and match ICDD crystallography database entry JCPDS 81-1304, which corresponds to PNb₉O₂₅. There is no amorphous background noise and the peaks are sharp and intense. This means that all samples are phase-pure and crystalline, with crystallite size 30-60 nm according to the Scherrer equation and crystal structure matching PNb₉O₂₅. This confirms the presence of a Wadsley-Roth crystal structure.

TABLE G2
A summary table of unit cell parameters for each sample
calculated by Rietveld refinement of their powder XRD spectra
with software GSASII, and average crystallite size calculated
by the Scherrer equation across the spectra.

| | a = b | | | | | Crystallite |
|---|---|---|---|---|---|---|
| Sample | [Å] | c [Å] | α = β [°] | γ [°] | χ²** | size [nm] |
| Reference⁸ | 15.639 | 3.831 | 90 | 90 | — | — |
| G1* | 15.6237 | 3.8377 | 90 | 90 | 7.4 | 48 ± 5 |
| G2 | 15.6272 | 3.8373 | 90 | 90 | 4.0 | 51 ± 7 |
| G3 | 15.6312 | 3.8347 | 90 | 90 | 2.6 | 47 ± 9 |
| G4 | 15.6410 | 3.8312 | 90 | 90 | 4.2 | 47 ± 8 |
| G5 | 15.6319 | 3.8346 | 90 | 90 | 7.9 | 51 ± 8 |
| G6 | 15.6279 | 3.8328 | 90 | 90 | 3.5 | 35 ± 4 |
| G7 | 15.6225 | 3.8328 | 90 | 90 | 8.3 | 40 ± 6 |
| G8 | 15.6032 | 3.8355 | 90 | 90 | 2.4 | 49 ± 9 |
| G9 | 15.6292 | 3.8362 | 90 | 90 | 6.9 | 48 ± 8 |
| G10 | 15.6254 | 3.8381 | 90 | 90 | 4.8 | 53 ± 6 |
| G11 | 15.6154 | 3.8352 | 90 | 90 | 10.0 | 53 ± 7 |
| G12 | 15.6236 | 3.8338 | 90 | 90 | 10.0 | 51 ± 6 |
| G13 | 15.6228 | 3.8306 | 90 | 90 | 8.0 | 50 ± 6 |
| G14 | 15.6587 | 3.8400 | 90 | 90 | 5.8 | 48 ± 6 |
| G15 | 15.6299 | 3.8350 | 90 | 90 | 9.7 | 51 ± 8 |
| G16 | 15.6217 | 3.8362 | 90 | 90 | 5.0 | 53 ± 6 |
| G17 | 15.6359 | 3.8388 | 90 | 90 | 5.6 | 53 ± 8 |

**χ² represents the goodness of fit and is a representation of how accurate the Rietveld refinement is, a value <10 supports the accuracy of the data.

Thermogravimetric Analysis (TGA) was performed on some samples using a Perkin Elmer Pyris 1 system in an air atmosphere. Samples were heated from 30° C. to 900° C. at 5° C./min and held at 900° C. for 30 mins, with an air flow of 20 mL/min. TGA was performed on samples G2, and G7 to quantify mass changes on oxidation. The mass gain measured was assumed to correspond to the degree of induced oxygen deficiency present.

TABLE G3
A summary of TGA analysis carried out on some samples in air.

| Sample | Mass gain by TGA analysis [w/w %] |
|---|---|
| G2 | 0.041 |
| G7 | 0.054 |

Particle Size Distributions were obtained with a Horiba laser diffraction particle analyser for dry powder. Air pressure was kept at 0.3 MPa. The results are set out in Table G1.

### Electrochemical Characterisation

Electrochemical tests were carried out in half-coin cells (CR2032 size) for analysis. In half-coin tests, the active material is tested in an electrode versus a Li metal electrode to assess its fundamental performance. In the below reference examples, the active material composition to be tested was combined with N-Methyl Pyrrolidone (NMP), carbon black acting as a conductive additive, and poly(vinyldifluoride) (PVDF) binder and mixed to form a slurry using a lab-scale centrifugal planetary mixer. The non-NMP composition of the slurries was 90 wt % active material, 6 wt % conductive additive, 4 wt % binder. The slurry was coated on an Al foil current collector to the desired loading of 70 g m⁻² by doctor blade coating and dried. The electrodes were then calendared to a density of 2.6-3.2 g cm⁻³ at 80° C. to achieve targeted porosities of 35-40%. Electrodes were punched out at the desired size and combined with a separator (Celgard porous PP/PE), Li metal, and electrolyte (1.3 M LiPF₆ in EC/DEC) inside a steel coin cell casing and sealed under pressure. Cycling was then carried out at 23° C. at low current rates (C/10) for 2 full cycles of lithiation and de-lithiation between 1.0-2.5 V for samples G1-G9, and 1.0-3.0 V for samples G10-G17. Afterwards, the cells were tested for their performance at increasing current densities. During rate tests, the cells were cycled asymmetric at 23° C., with a slow charge (lithiation, C/5) followed by increasing discharge rates (de-lithiation, e.g. 1C, then 2C, then 5C, then 10C) for dis-chargeability tests (e.g. measuring capacity retention). Nominal voltage vs Li/Li+ has been calculated from the integral of the V/Q curve divided by the total capacity at 5C during de-lithiation. Samples G10-G17 have been evaluated in at least triplicate, with errors presented as their standard deviation.

The electrical resistivity of the electrode composition was assessed by a 4-point-probe method with an Ossila instrument. An electrode composition was prepared to a mass loading of 70 g cm⁻² and calendared to a porosity of 35-40% on a sheet of insulating mylar for all samples. The sheet resistance was then measured on a 15 mm diameter disc in units of 2 per square at constant temperature of 23° C.

Homogeneous, smooth coatings on both Cu and Al current collector foils, the coatings being free of visible defects or aggregates were also prepared as above for selected samples with a centrifugal planetary mixer to a composition of up to 94 wt % active material, 4 wt % conductive additive, 2 wt % binder. These have been prepared with both PVDF and CMC:SBR-based binder systems. The coatings were calendared at 80° C. for PVDF and 50° C. for CMC:SBR to porosities of 35-40% at loadings from 1.0 to 3.5 mAh cm⁻². This is an important demonstration of these materials being viable in a commercially focussed electrodes for both high energy and high-power applications.

TABLE G4
A summary of electrical resistance measurements carried
out as described. Resistivity was measured by 4-point-
probe techniques, on equivalent coatings on mylar.

| Sample | Sheet resistance [Ω per square] |
|---|---|
| G1* | 763 ± 53 |
| G2 | 454 ± 25 |
| G3 | 745 ± 26 |
| G4 | 576 ± 27 |
| G5 | 668 ± 18 |
| G6 | 517 ± 15 |
| G7 | 559 ± 8 |
| G8 | 751 ± 31 |
| G9 | 644 ± 39 |

*Comparative sample

TABLE G5
A summary of electrochemical testing results from Li-ion half coin
cells. In general (although not exclusively) it is beneficial to
have a higher capacity, a higher ICE, and a lower nominal voltage.

| | Delithiation | | |
|---|---|---|---|
| | specific | Coulombic | Nominal |
| | capacity | efficiency 1^{st} | de-lithiation |
| | 2^{nd} C/10 cycle | cycle / 2^{nd} | voltage at 5 C |
| Sample | [mAh/g] | cycle at C/10 [%] | vs Li/Li⁺ [V] |
| G1* | 212 | 97.41/98.40 | 1.76** |
| G2 | 234 | 98.13/98.82 | 1.72** |
| G3 | 224 | 96.75/98.93 | 1.72** |
| G4 | 206 | 91.06/97.82 | 1.75** |
| G5 | 218 | 95.58/98.88 | 1.73** |
| G6 | 217 | 93.84/98.92 | 1.77** |
| G7 | 221 | 95.97/99.09 | 1.72** |
| G8 | 208 | 94.69/98.81 | 1.71** |
| G9 | 227 | 97.77/99.21 | 1.75** |
| G10 | 205 ± 2 | 95.97 ± 0.21/97.92 ± 0.38 | 1.78 ± 0.01** |
| G11 | 217 ± 1 | 97.30 ± 0.16/98.80 ± 0.21 | 1.77 ± 0.01** |
| G12 | 213 ± 3 | 95.30 ± 0.71/96.85 ± 0.70 | 1.77 ± 0.03** |
| G13 | 208 ± 0 | 94.65 ± 0.18/97.70 ± 0.16 | 1.79 ± 0.01** |
| G14 | 212 ± 2 | 93.73 ± 0.29/97.21 ± 0.28 | 1.84 ± 0.01** |
| G15 | 211 ± 2 | 94.21 ± 0.56/96.82 ± 0.80 | 1.82 ± 0.00** |
| G16 | 215 ± 1 | 97.17 ± 0.80/98.75 ± 0.24 | 1.82 ± 0.00** |
| G17 | 215 ± 2 | 97.79 ± 0.18/98.91 ± 0.22 | 1.77 ± 0.01** |

*Comparative sample
**Samples G1-G9 evaluated in the voltage range 1.0-2.5 V, samples G10-G17 evaluated in the voltage range 1.0-3.0 V; this affects the absolute values for nominal voltage but not the trend.

TABLE G6
A summary of electrochemical testing results from Li-ion half coin
cells. It is beneficial to have a higher capacity retention.

| | 1 C/0.5 C | 2 C/0.5 C | 5 C/0.5 C | 10 C/0.5 C |
|---|---|---|---|---|
| | delithiation | delithiation | delithiation | delithiation |
| | capacity | capacity | capacity | capacity |
| | retention | retention | retention | retention |
| Sample | [%] | [%] | [%] | [%] |
| G1* | 94.7 | 89.3 | 82.9 | 68.4 |
| G2 | — | — | 95.3 | 87.6 |
| G3 | 98.1 | 96.1 | 94.2 | 89.8 |
| G4 | 98.4 | 97.4 | 94.8 | 89.6 |
| G5 | — | — | 96.8 | 92.4 |
| G6 | — | — | 95.2 | 82.4 |
| G7 | — | — | 96.2 | 89.6 |
| G8 | 100 | 99.7 | 98.5 | 96.6 |
| G9 | 98.6 | 96.7 | 94.3 | 83.9 |
| G10 | 97.6 ± 0.8 | 95.2 ± 1.5 | 91.6 ± 2.4 | 84.9 ± 2.7 |
| G11 | 98.6 ± 0.5 | 97.2 ± 0.6 | 95.0 ± 0.7 | 90.0 ± 1.2 |
| G12 | 96.7 ± 0.5 | 93.6 ± 1.1 | 89.4 ± 2.0 | 83.5 ± 2.7 |
| G13 | 96.8 ± 0.1 | 93.7 ± 0.2 | 89.5 ± 0.4 | 84.1 ± 0.4 |
| G14 | 96.3 ± 0.2 | 92.5 ± 0.4 | 86.9 ± 0.7 | 79.6 ± 0.9 |
| G15 | 96.4 ± 0.1 | 93.0 ± 0.2 | 88.3 ± 0.3 | 80.9 ± 1.0 |
| G16 | 97.8 ± 0.1 | 95.4 ± 0.3 | 91.7 ± 0.4 | 86.5 ± 0.6 |
| G17 | 98.0 ± 1.0 | 96.3 ± 1.0 | 93.4 ± 1.3 | 89.4 ± 1.3 |

*Comparative sample

### Reference Example 3A—Samples G1* and G3

Comparative Sample G1*has been modified through cation substitution with the P⁵⁺ cation, maintaining overall valency as in Sample G3 (i.e. isovalent M6 substitution where a>0). As valency is maintained, the effects on the PNb₉O₂₅ active material will be due to changing unit cell size and local distortions in crystal structure as a result of the different ionic radii of the cations used. For example, the ionic radius of the 4-coordinate P⁵⁺ cation is 0.17 Å vs the ionic radius of 4-coordinate Ti⁴⁺ cation of 0.42 Å. This can give rise to improved electrochemical performance through altering the Li ion site availability by varying cavity size (in this case likely the Type VI cavity in particular), and resultant electrochemical properties such as improved specific capacity, or improved Coulombic efficiency through reduction of energy barriers to reversible lithiation. This can also result in improved electrical conductivity through variations in crystal properties, and reduced impedance/polarisation electrochemically by improving Li-ion diffusion.

The exchange of the P⁵⁺ cations for alternative electrochemically active cations such as Ti⁴⁺ or Mo⁶⁺ can also aid in the tuning of the redox properties of the material, such as by lowering the nominal voltage vs Li/Li⁺ to increase full cell energy density, or by improving capacity and Coulombic efficiency through more efficient and reversible redox processes.

Table G2 demonstrates the change that has taken place in unit cell parameters between Sample G1*and G3. In particular there has been a change in the a and b parameters increasing by 0.0075 Å and the c parameter showing a slight reduction of 0.0030 Å. This demonstrates that isovalent substitution with materials of larger ionic radii can cause an expansion in the lattice in the a and b directions. This is carried across to minor improvements in electrical resistance shown in Table G4, reducing from Sample G1* to Sample G3 by 18 Ω per square. Electrochemical performance shows great improvements in Table G5 and Table G6, with improved specific capacity, improved 2^{nd} cycle Coloumbic efficiency, and reduction in polarisation at high voltage (represented by the nominal voltage at 5C). Additionally, there are improvements in the specific capacity retention at increasing rates to 10C, and likely beyond this to rates of 20C or more, or 50C or more, or 1000 or more.

It is expected that similar benefits will be observed with the described M6 dopants for use in Li-ion cells.

### Reference Example 3B—Samples G1*, G4, and G5

Comparative Sample G1* has been modified through cation substitution with the Nb⁵⁺ cation, maintaining overall valency as in Samples G4 and G5 (i.e. isovalent M7 substitution where b>0). Similar advantages can be observed as in Reference Example 3A, as a result of altered unit cell size, electrical, and electrochemical properties. Specifically, Samples G4 and G5 show improved electrical resistance in Table G4 versus Sample G1*, and improvements in the specific capacity retention at increasing rates to 10C in Table G6, and likely beyond this to rates of 20C or more, or 50C or more, or 1000 or more.

It is expected that similar benefits will be observed with the described M7 dopants for use in Li-ion cells.

### Reference Example 3C—Samples G1*, G6, G9, and G11-G17

Comparative Sample G1* has been modified through cation substitution without maintaining overall valency in Samples G6, G9, and G11-G17. For example, in Samples G6 and G9 a cation of lower valency has been utilised, with others in the case of Sample G6. The advantages from altering ionic radii by substitution as described in Reference Examples 3A and 3B are maintained. For Samples G6 and G9, the lower valency results in crystal structure changes, and electronic structure changes. If the substitution takes place in the same cation site, e.g. P⁵⁺ directly substitutes for Al³⁺, then the O-content of the material will be decreased proportionally to maintain a charge-balanced structure (i.e. oxygen deficient vs the base PNb₉O₂₅ structure). This creates defects and additional charge carriers in the structure (i.e. electron holes), improving electrical conductivity. This can also induce crystal distortions due to altered coordination with O anions and surrounding P/Nb cations, further improving electrical and electrochemical performance in a similar fashion to altering ionic radii as described.

This is observed in Table G2, where the unit cell parameters demonstrate a decrease in a and b parameters, and a decrease in the c parameter as well, overall demonstrating a minor crystal structure contraction. Electrical resistance measurements show improvements in Table G4, with large reductions in the observed sheet resistance vs Sample G1. Electrochemical measurements additionally show advantages for both Samples G6 and G9 in specific capacity, 2^{nd} cycle Coulombic efficiency, polarisation, and capacity retention at high rates in Table G5 and Table G6.

Samples G11-G17 demonstrate further substitutions of P⁵⁺ by M6 or Nb⁵⁺ by M7 without maintaining overall valency. Each of Samples G11-G17 provided significantly improved capacity retention at high rates compared to Comparative Sample G1* (Table G6).

It is expected that similar benefits will be observed with cation or anion exchange of lower or increased valency vs P⁵⁺ or Nb⁵⁺ for use in Li-ion cells.

### Reference Example 3D—Samples G1*, G2, G6, and G7

Comparative Sample G1*and Sample G6 have been modified through the introduction of induced oxygen vacancy defects (cf. oxygen deficiency) by a heat treatment in an inert or reducing atmosphere to provide Samples G2 and G7. By treating these materials at high temperature in an inert or reducing atmosphere, they may be partially reduced and maintain this upon return to room temperature and exposure to air atmosphere. This is accompanied with an obvious colour change, for example Sample G2 is light blue in colour vs white for Sample G1*. This colour change demonstrates a significant change in the electronic structure of the material, allowing it to interact with different energies (i.e. wavelength) of visible light due to reduced band gap.

The induced oxygen vacancy is specifically a defect in the crystal structure where an oxygen anion has been removed. This provides excess electrons improving material electrical conductivity significantly, and alters the band gap energy as demonstrated by colour changes. If induced oxygen vacancies are present beyond 5 at % (i.e. c>1.25), then the crystal structure collapses due to a loss in stability. These induced oxygen vacancies can be present in addition to oxygen deficiency caused by the use of subvalent cation exchange, as shown in Sample G7. Evidence of oxygen deficiency is provided here by TGA analysis in air, showing a mass increase upon increasing temperature; this has been assumed to correspond to the degree of oxygen deficiency present as it becomes oxidised to provide once more analogous structures to Sample G1*and G6. A host of other techniques can also be employed as described above to quantify oxygen deficiency.

Table G2 demonstrates the change in unit cell parameters that take place upon inducing oxygen vacancies in Samples G2 and G7. Electrical resistance measurements show improvements in Table G4 for Sample G2 over Sample G1*. A similar sheet resistance was observed between Sample G6 and G7, due to Sample G6 already being oxygen deficient due to its subvalent substitution of P⁵⁺ with Al³⁺. Electrochemical measurements additionally show significant advantages for Sample G7 vs G6 in specific capacity, 1^{st} and 2^{nd} cycle Coulombic efficiencies, polarisation, and capacity retention at high rates in Table G5 and Table G6.

It is expected that similar benefits will be observed with any of the described PNO structures having induced oxygen deficiency for use in Li-ion cells.

### Reference Example 3E—Samples G1*, G5, G8, and G10

Sample G5 has been modified through the introduction of N³⁻ anions (cf. nitridation) to provide Sample G8. This was carried out by a solid-state synthesis route but could equally be carried out with a gaseous route utilising NH₃ gas at high temperature, or through use of a dissolved N-containing material in a solvent that is subsequently evaporated followed by high temperature heat treatment. Sample G8 is brown compared to Sample G5, which is off-white/light yellow, demonstrating changes to the active material electronic structure in a similar fashion to Reference Example 3D.

In a similar fashion to Reference Examples 3A-3C, this exchange may take place in an O²⁻ anion site, in which case the increased valency may increase the electronic conductivity of the material. It may also take place in an interstitial site within the crystal structure. In both cases, this may also give rise to different unit cell size and associated crystallographic distortions due to the differing ionic radii and valency of the anions, providing similar potential benefits to Reference Examples 3A-3D.

Table G2 demonstrates the change in unit cell parameters that take place upon introduction of N³⁻ anions for Sample G8 over Sample G5, with large reductions in the a and b parameters, and a small increase in the c parameter, providing evidence for N³⁻ incorporation within the crystal structure. Electrochemical measurements show improvements in capacity retention at high rates for Sample G8 vs G5 (Table G6). Compared to the reference Sample G1*, Sample G8 has significantly improved capacity retention at high rates.

Comparative Sample G1* has been modified to introduce F⁻ anions to provide Sample G10. Electrochemical measurements show significant improvements in capacity retention at high rates for Sample G10 vs G1* (Table G6).

It is expected that similar benefits will be observed through the use of anions of different electronegativity and valency with any of the described PNO structures for use in Li ion cells.

### DISCUSSION

Comparative Sample G1* may also be modified with more than one type of cation/anion substitution, or induced oxygen deficiency (i.e. a>0 and b>0; or a>0, d>0; or a>0, b>0, c>0, and so on). Sample G6 demonstrates the effect of having a>0 and b>0; Sample G7 demonstrates the effect of having a>0, b>0 and c>0. A material with additionally d>0 is expected to provide additional benefits in performance to the active material. Improvements as described for Reference Examples 3A-3E are expected for these materials that demonstrate multiple types of modifications.

Table G2 demonstrates changes in unit cell parameters reflecting the alterations to the materials that have taken place. Samples G6 and G7 both show large improvements in the electrical resistance vs Sample G1* as shown in Table G4. Electrochemical measurements additionally show significant advantages for both Samples G6 and G7 vs 1* in specific capacity, 2^{nd} cycle Coulombic efficiencies, polarisation (for Sample G7), and capacity retention at high rates in Table G5 and Table G6.

By introducing increased degrees of disorder in the crystal structure (cf. entropy) this can aid in reversible lithiation processes by providing less significant energy barriers to reversible lithiation, and to prevent Li ion ordering within a partially lithiated crystal. This can also be defined as creating a spread in the energetic states for Li ion intercalation, which prevents unfavourable lithium ordering and entropic energy barriers.

It is expected that similar benefits will be observed in any of the described PNO structures utilising any combination of M6, M7, Q, a, b, c, and d within the described limits for use in Li ion cells.

### Reference Examples Related to Formula 4

The following Reference Examples demonstrate the improvement in the properties of unmodified ‘base’ MoNb₁₂O₃₃ and WNb₁₂O₃₃ which is achieved by substitution of M10 for Nb and/or O for Q, with optional further substitution of M8 for M9 and/or induced oxygen deficiency. It would be expected that the same improvements would be seen when the modified mixed niobium oxides are combined with niobium oxides in accordance with the invention.

The mixed niobium oxides were synthesised by a solid-state route. In a first step precursor materials (Nb₂O₅, NH₄H₂PO₄, MoO₃, Al₂O₃, WO₃, ZrO₂, ZnO) were mixed in stoichiometric proportions (50 g total) and ball-milled at 350 rpm with a ball to powder ratio of 10:1 for 1 h. The resulting powders were heat treated in an alumina crucible in a muffle furnace in air at T₁ₐ=250-900° C. for 1-12 h followed by T_{1b}=700-1350° C. for 2-16 h, providing the desired Wadsley-Roth phase. An additional heat treatment step was also applied in some cases under a N₂ atmosphere at T₂=800-1350° C. for 1-12 h. For inclusion of anions, there was an additional milling/mixing step with the precursor (C₃H₆N₆ in a 1:3 mass ratio versus the parent material for N, PVDF in a 1:10 mass ratio for F) prior to heat treatment in a N₂ or air atmosphere at T₂=300-1200° C. for 1-24 h.

A final de-agglomeration step was utilised by impact milling or jet milling to adjust to the desired particle size distribution where necessary. Specifically, the material was de-agglomerated by impact milling at 20,000 RPM for 10 seconds.

TABLE H1
A summary of the materials synthesised. Particle size distribution
has been evaluated by dry powder laser diffraction.

| | | T₁ₐ | T_{1b} | T₂ | D10 | D50 | D90 |
|---|---|---|---|---|---|---|---|
| Sample | Material | (° C.; h) | (° C.; h) | (° C.; h) | (μm) | (μm) | (μm) |
| H1* | MoNb₁₂O₃₃ | — | 900; 12 | — | 1.3 | 4.8 | 11.0 |
| H2** | Mo_{0.75}W_{0.25}Nb₁₂O₃₃ | — | 900; 12 | — | 1.5 | 4.7 | 9.7 |
| H3 | Mo_{0.75}W_{0.25}Nb_{11.95}Zr_{0.05}O_{32.975} | — | 900; 12 | — | — | — | — |
| H4 | Mo_{0.75}W_{0.25}Nb_{11.9}Zr_{0.1}O_{32.95} | — | 900; 12 | — | 2.4 | 5.3 | 9.9 |
| H5 | Mo_{0.75}W_{0.25}Nb_{11.95}Al_{0.05}O_{32.95} | — | 900; 12 | — | 1.3 | 4.7 | 10.3 |
| H6 | Mo_{0.75}W_{0.25}Nb_{11.95}Zn_{0.05}O_{32.925} | — | 900; 12 | — | — | — | — |
| H7 | Mo_{0.75}W_{0.25}Nb_{11.95}Mo_{0.05}O_{33.025} | — | 900; 12 | — | — | — | — |
| H8 | Mo_{0.75}W_{0.25}Nb_{11.95}W_{0.05}O_{33.025} | — | 900; 12 | — | — | — | — |
| H9 | Mo_{0.75}W_{0.25}Nb_{11.95}P_{0.05}O₃₃ | 380; 3 | 900; 12 | — | — | — | — |
| H10 | Mo_{0.75}W_{0.25}Nb₁₂O_{33-y}N_{y} | — | 900; 12 | 700; 10^{†} | 2.1 | 5.9 | 12.2 |
| H12 | Mo_{0.75}W_{0.25}Nb_{11.9}Zr_{0.1}O_{32.95-y}F_{y} | 900; 12 | 950; 5^{†} | 375; 24 | 0.8 | 5.5 | 16.7 |
| H13 | Mo_{0.75}W_{0.25}Nb_{11.95}Al_{0.05}O_{32.95-y}F_{y} | 900; 12 | 950; 5^{†} | 375; 24 | — | — | — |
| H14*** | Mo_{0.75}W_{0.25}Nb_{11.95}Al_{0.05}O_{32.95-y} | 900; 12 | 950; 5^{†} | — | 0.9 | 4.7 | 13.8 |
| H15*** | Mo_{0.75}W_{0.25}Nb_{11.95}Mo_{0.05}O_{33.025-y} | 900; 12 | 950; 5^{†} | — | 0.8 | 3.6 | 9.8 |
| H16*** | Mo_{0.75}W_{0.25}Nb_{11.9}Zr_{0.1}O_{32.95-y-z}N_{z} | 900; 12 | 700; 10^{†} | 950; 5^{†} | — | — | — |
| H17*** | Mo_{0.75}W_{0.25}Nb₁₂O_{33-y-z}N_{z} | 900; 12 | 700; 10^{†} | 950; 5^{†} | — | — | — |

*Comparative sample—unmodified ‘base’ MoNb₁₂O₃₃
**Comparative sample—MoNb₁₂O₃₃ with cation exchange at M9 site
***Induced oxygen deficiency may be calculated from e.g. TGA
^{†}This heat treatment step was carried out in a N₂ atmosphere. All others were carried out in an air atmosphere.

### Materials Characterisation

The phase purity of samples was analysed using a Rigaku Miniflex powder X-ray diffractometer in 2θ range (10-70°) at 1°/min scan rate.

FIG. H1 shows the measured XRD diffraction patterns for Samples H1, H2, H5, H10, H13, H14, H17. Diffraction patterns have peaks at the same locations (with some shift due to crystal modification, up to around 0.2°), and match ICDD crystallography database entry JCPDS, which corresponds to JCPDS 73-1322. There is no amorphous background noise and the peaks are sharp and intense. This means that all samples are crystalline, with crystallite size 35-42 nm according to the Scherrer equation and crystal structure matching MoNb₁₂O₃₃ or the isostructural WNb₁₂O₃₃. This confirms the presence of a Wadsley-Roth crystal structure.

TABLE H2
A summary table of unit cell parameters for each sample
calculated by Rietveld refinement of their powder XRD spectra
with software GSASII, and average crystallite size calculated
by the Scherrer equation across the spectra.

| | | | | | | | Crystallite |
|---|---|---|---|---|---|---|---|
| Sample | a [Å] | b [Å] | c [Å] | β [°] | Vol(Å³) | χ² | size [nm] |
| Reference | 22.370 | 3.825 | 17.870 | 123.60 | 1273.58 | — | — |
| H1* | 22.285 | 3.826 | 17.744 | 123.3 | 1264.81 | 9 | 37.9 |
| H2** | 22.327 | 3.833 | 17.794 | 123.28 | 1273.27 | 10 | 38.3 |
| H4 | 22.314 | 3.833 | 17.781 | 123.28 | 1271.72 | 8 | 41.4 |
| H5 | 22.312 | 3.836 | 17.786 | 123.29 | 1271.26 | 9 | 40.2 |
| H10 | 22.322 | 3.834 | 17.806 | 123.22 | 1275.07 | 10 | 35.5 |
| H13 | 22.315 | 3.829 | 17.799 | 123.31 | 1271.20 | 9 | 36.2 |
| H14 | 22.316 | 3.832 | 17.797 | 123.23 | 1273.16 | 10 | 36.0 |

χ² represents the goodness of fit and is a representation of how accurate the Rietveld refinement is, a value ≤10 supports the accuracy of the data.

Particle Size Distributions were obtained with a Horiba laser diffraction particle analyser for dry powder. Air pressure was kept at 0.3 MPa. The results are set out in Table H1.

Confocal Raman spectroscopy was carried out on selected samples. A laser excitation of 532 nm, attenuation of 10% and magnification of 50 was used on a Horiba Xplora Plus Raman microscope, with samples pressed into pellets at 10 MPa pressure, and placed on a glass slide. Spectra were recorded with on average an acquisition time of 15 s per scan, 3 repeats and 3 different sample locations in the spectral range of 0-2500 cm⁻¹. Peaks characteristic to structures containing NbₓO_{y} species can be found in the region 500-700 cm⁻¹, those relating to longer Nb—O bonds in corner-shared octahedral units at 760-770 cm⁻¹, distorted octahedral species relating to O═Nb—O at 890-900 cm⁻¹, and shorter Nb—O bonds as in edge shared octahedra at 1000 cm⁻¹. Notably, Sample H2** contains a peak at ˜650 cm⁻¹ which is absent in Samples H13, H15, H16, and H17. This is believed to provide proof of change to Nb—O bonds in the material which is evidence of the modification to the crystal structure caused by the induced oxygen vacancies and/or substitution of O by N or F.

### Electrochemical Characterisation

Electrochemical tests were carried out in half-coin cells (CR2032 size) for analysis. In half-coin tests, the active material is tested in an electrode versus a Li metal electrode to assess its fundamental performance. In the below reference examples, the active material composition to be tested was combined with N-Methyl Pyrrolidone (NMP), carbon black (Super P) acting as a conductive additive, and poly(vinyldifluoride) (PVDF) binder and mixed to form a slurry using a lab-scale centrifugal planetary mixer. The non-NMP composition of the slurries was 92 wt % active material, 3 wt % conductive additive, 5 wt % binder. The slurry was coated on an Al foil current collector to the desired loading of 69-75 g m⁻² by doctor blade coating and dried by heating. The electrodes were then calendared to a density of 2.6-3.2 g cm⁻³ at 80° C. to achieve targeted porosities of 35-40%. Electrodes were punched out at the desired size and combined with a separator (Celgard porous PP/PE), Li metal, and electrolyte (1.3 M LiPF₆ in EC/DEC) inside a steel coin cell casing and sealed under pressure. Cycling was then carried out at 23° C. at low current rates (C/10) for 2 full cycles of lithiation and de-lithiation between 1.1-3.0 V. Afterwards, the cells were tested for their performance at increasing current densities. During these tests, the cells were cycled asymmetric at 23° C., with a slow lithiation (C/5) followed by increasing de-lithiation rates (e.g. 5C) to provide the nominal voltage at 5C. Nominal voltage vs Li/Li+ has been calculated from the integral of the V/Q curve divided by the total capacity at 5C during de-lithiation. No constant voltage steps were used. Data has been averaged from 5 cells prepared from the same electrode composition, with the error shown from the standard deviation. Accordingly, the data represent a robust study showing the improvements achieved by the modified mixed niobium oxides compared to prior materials.

The electrical resistivity of the electrode composition was separately assessed by a 4-point-probe method with an Ossila instrument. An electrode composition was prepared to a mass loading of 69-75 g cm⁻² and calendared to a porosity of 35-40% on a sheet of insulating mylar for all samples. The sheet resistance was then measured on a 14 mm diameter disc in units of 2 per square at constant temperature of 23° C.

Homogeneous, smooth coatings on both Cu and Al current collector foils, the coatings being free of visible defects or aggregates may also be prepared as above for these samples with a centrifugal planetary mixer to a composition of up to 94 wt % active material, 4 wt % conductive additive, 2 wt % binder. These can be prepared with both PVDF (i.e. NMP-based) and CMC:SBR-based (i.e. water-based) binder systems. The coatings can be calendared at 80° C. for PVDF and 50° C. for CMC:SBR to porosities of 35-40% at loadings from 1.0 to 5.0 mAh cm⁻². This is important to demonstrate the viability of these materials in both high energy and high-power applications, with high active material content.

TABLE H3
A summary of electrical resistance measurements carried
out as described. Resistivity was measured by 4-point-
probe techniques, on equivalent coatings on mylar.

| Sample | Sheet resistance [kΩ per square] |
|---|---|
| H1* | 2.96 ± 0.31 |
| H2** | 1.26 ± 0.04 |
| H5 | 1.43 ± 0.09 |
| H10 | 1.29 ± 0.11 |
| H12 | 1.20 ± 0.14 |
| H14 | 1.41 ± 0.04 |

TABLE H4
A summary of electrochemical testing results from Li-ion half coin
cells. In general it is beneficial to have a higher capacity,
a higher Coulombic efficiency, and a lower nominal voltage.

| | Delithiation | | | |
|---|---|---|---|---|
| | specific | Coulombic | Coulombic | Nominal |
| | capacity 2^{nd} | efficiency | efficiency | de-lithiation |
| | C/10 cycle | 1^{st} cycle | 2^{nd} cycle | voltage at 5 C vs |
| Sample | [mAh/g] | at C/10 [%] | at C/10 [%] | Li/Li⁺ [V] |
| H1* | 200.5 ± 2.8 | 87.7 ± 0.7 | 98.8 ± 0.1 | 1.910 |
| H2** | 199.4 ± 3.2 | 88.8 ± 0.2 | 99.4 ± 0.1 | 1.878 |
| H5 | 201.2 ± 2.6 | 88.4 ± 0.1 | 99.7 ± 0.0 | 1.901 |
| H10 | 203.6 ± 7.0 | 88.3 ± 0.6 | 98.8 ± 0.2 | 1.938 |
| H12 | 205.1 ± 7.5 | 90.4 ± 0.2 | 99.3 ± 0.2 | 1.894 |
| H14 | 206.9 ± 10.1 | 90.6 ± 1.0 | 99.3 ± 0.2 | 1.901 |

### Reference Example 4A—Cation Exchange

The mixed niobium oxide has been modified through a cation substitution approach in samples H3-H9, focussed at the Nb⁵⁺ cations within the 3×4 block of NbO₆ octahedra. In the case of samples H3-H6, the exchange has been carried out with a cation of reduced valency. Samples H7-H8 show increased valency, and sample H9 shows isovalent exchange. This is expected to provide an advantage versus the base crystal structure of sample H1 through the combination of (a) altered ionic radii, (b) altered valency, and (c) altered voltage. Altered ionic radii can give rise to beneficial changes in electrochemical performance due to changing unit cell size and local distortions in crystal structure altering available lithiation sites or lithiation pathways—potentially improving Coulombic efficiency, capacity, performance at high rate, and lifetime. For example, the ionic radius of the 6-coordinate Nb⁵⁺ cation is 0.64 Å vs the ionic radius of 6-coordinate Al³⁺ cation of 0.54 Å in sample H5. Cation exchange provides significantly improved electrical conductivity of the material compared to the unmodified sample H1*, believed to be due to providing available intermediate energy levels for charge carriers, as shown in Table H3. This is believed to further result in better performance at high charge and discharge rates, and reduced nominal voltage at high rates due to lower polarisation in the cell. If the substitution takes place in the same cation site, then the O-content of the material will be decreased proportionally to maintain a charge-balanced structure (i.e. oxygen deficient vs the base MoNb₁₂O₃₃ structure). Voltage can further be modified through the introduction of cations with different electrochemical redox potentials, allowing the design of materials to provide lower nominal voltage.

Table H₂ demonstrates the alterations in unit cell parameters observed upon cation exchange, observed due to alterations of ionic radii and electronic structure of these materials.

It is expected that similar benefits will be observed with the described cation exchange approach for this material for use in Li-ion cells.

### Reference Example 4B—Anion Exchange

The mixed niobium oxide has been modified through the introduction of N³⁻ anions (cf. nitridation) to provide Sample H10. This was carried out by a solid-state synthesis route but could equally be carried out with a gaseous route utilising NH₃ gas at high temperature, or through use of a dissolved N-containing material in a solvent that is subsequently evaporated followed by high temperature heat treatment. Sample H10 is grey/blue compared to Sample H2**, which is off-white, demonstrating changes to the active material electronic structure in a similar fashion to Reference Example 4A.

In a similar fashion to Reference Example 4A with cation exchange, this exchange may take place in an O²⁻ anion site, in which case the increased valency may increase the electronic conductivity of the material. It may also take place in an interstitial site within the crystal structure. In both cases, this may also give rise to different unit cell size and associated crystallographic distortions due to the differing ionic radii and valency of the anions, providing similar potential benefits to Reference Example 4A.

In a similar fashion, the mixed niobium oxide can be altered through the introduction of F⁻ anions to provide samples H12 and H13, providing an advantage in the Coulombic efficiency versus the reference samples H1 and H2.

Table H₂ demonstrates the change in unit cell parameters that take place upon introduction of N³⁻ anions or F⁻ anions, providing further evidence for anion incorporation within the crystal structure.

FIG. H2 further shows evidence of N or F incorporation by the change in the characteristic peaks corresponding to Nb—O bonds at 500-700 cm⁻¹ in the Raman spectra.

It is expected that similar benefits will be observed through the use of anions of different electronegativity and valency with any of the described MNO structures for use in Li ion cells.

### Reference Example 4C—Induced Oxygen Vacancy Defects

Sample H5, H7, and H10 have been modified through the introduction of induced oxygen vacancy defects (cf. oxygen deficiency) by a heat treatment in an inert or reducing atmosphere to provide Samples H14, H15, and H17. By treating these materials at high temperature in an inert or reducing atmosphere, they may be partially reduced and maintain this upon return to room temperature and exposure to an air atmosphere. This is accompanied with an obvious colour change, for example Sample H15 is purple/blue in colour vs white for Sample H7. This colour change demonstrates a significant change in the electronic structure of the material, allowing it to interact with different energies (i.e. wavelength) of visible light due to the reduced band gap. This is reflected in sample H14, demonstrating a reduced nominal voltage at a rate of 5C, which corresponds to a reduced level of polarisation in the cell.

The induced oxygen vacancy is specifically a defect in the crystal structure where an oxygen anion has been removed, and the overall redox state of the cations is reduced in turn. This provides additional energetic states improving material electrical conductivity significantly, and alters the band gap energy as demonstrated by colour changes. If induced oxygen vacancies are present beyond 5 atomic % (i.e. c>1.65), then the crystal structure may be less stable. These induced oxygen vacancies can be present in addition to oxygen deficiency caused by the use of subvalent cation exchange, as shown in Sample H14.

Evidence of oxygen deficiency is provided here by Raman spectra in Figure H₂, as in Reference Example 4B. A host of other techniques can also be employed as described above to quantify oxygen deficiency.

It is expected that similar benefits will be observed with the described approach to induce oxygen vacancy defects for this material for use in Li-ion cells.

### DISCUSSION

Comparative Sample H1*or H₂** may also be modified with more than one type of cation/anion substitution, or induced oxygen deficiency (i.e. a>0 and b>0; or a>0, d>0; or a>0, b>0, c>0, and so on). Samples H3-H9 demonstrates the effect of having a>0 and b>0; Sample H16 demonstrates the effect of having a>0, b>0, c>0 and d>0. Improvements as described for Reference Examples 4A-4C are expected for these materials that demonstrate multiple types of modifications.

Table H₂ demonstrates changes in unit cell parameters for modified materials reflecting the alterations to the materials that have taken place at the crystal level. All samples show large improvements in the electrical resistance vs Sample H1* as shown in Table H3. Electrochemical measurements additionally show significant advantages for modified samples vs Sample H1*in 1^{st} and 2^{nd} cycle Coulombic efficiencies, and in their nominal voltage at a 5C de-lithiation rate as in Table H4. Moreover, modifying Sample H₂** by including substation at the Nb site and/or at the O site provided improved specific capacity, and important result demonstrating the utility of the modified materials for use as active electrode materials.

Modifying the ‘base’ material by introducing increased degrees of disorder in the crystal structure (cf. entropy) can aid in reversible lithiation processes by providing less significant energy barriers to reversible lithiation, and preventing Li ion ordering within a partially lithiated crystal. This can also be defined as creating a spread in the energetic states for Li ion intercalation, which prevents unfavourable lithium ordering and entropic energy barriers. This can be inferred from examining dQ/dV or Cyclic Voltammetry plots.

It is expected that similar benefits will be observed in any of the described MNO structures utilising any combination of M8, M9, M10, Q, a, b, c, and d within the described limits for use in Li ion cells.

### Further Reference Examples Related to Formula 4

The following Reference Examples demonstrate the improvement in the properties of unmodified ‘base’ MoNb₁₂O₃₃ and WNb₁₂O₃₃ which is achieved by substitution of M9 for M8 and/or by inducing oxygen deficiency. It would be expected that the same improvements would be seen when the modified mixed niobium oxides are combined with niobium oxides in accordance with the invention.

A number of different materials were prepared and characterised, as summarised in Table I1, below. Broadly, these samples can be split into a number of groups. Samples I1, I2, I3, I4, I5, I8, I9, I10, I11, and I12 belong to the same family of Wadsley-Roth phases based on MoNb₁₂O₃₃ (M⁶⁺Nb₁₂O₃₃, 3×4 block of octahedra with a tetrahedron at each block corner). The blocks link to each other by edge sharing between NbO₆ octahedra, as well as corner sharing between M⁶⁺O₄ tetrahedra and NbO₆ octahedra. Sample I1 is the base crystal structure, which is modified to a mixed metal cation structure by exchanging one or multiple cations in samples I2 to I4, and/or in a mixed crystal configuration (blending with isostructural WNb₁₂O₃₃) in samples I8, I9, I10, I11, and I12. Oxygen deficiencies are created in the base crystal in sample R5 and in the mixed metal cation structure I11. Sample I3 is a spray-dried and carbon-coated version of the crystal made in sample I2, and sample I12 is a spray-dried and carbon-coated version of the crystal made in sample I10. Samples I6, I7 and I13 belong to the same family of Wadsley-Roth phases based on WNb₁₂O₃₃ (M⁶⁺Nb₁₂O₃₃, a 3×4 NbO₆ octahedra block with a tetrahedron at each block corner).

TABLE I1
A summary of different compositions synthesised.
Samples indicated with * are comparative samples.

| Sample | | Material |
|---|---|---|
| No. | Composition | Synthesis |
| I1* | MoNb₁₂O₃₃ | Solid state |
| I2 | Ti_{0.05}Mo_{0.95}Nb₁₂O_{32.95} | Solid state |
| I3 | Ti_{0.05}Mo_{0.95}Nb₁₂O_{32.95} + C | Solid state, spray dry, |
| | | carbon pyrolysis |
| I4 | Zr_{0.05}Mo_{0.95}Nb₁₂O_{32.95} | Solid state |
| I5 | MoNb₁₂O_{<33} | Solid state |
| I6* | WNb₁₂O₃₃ | Solid state |
| I7 | Ti_{0.05}W_{0.95}Nb₁₂O_{32.95} | Solid state |
| I8 | W_{0.25}Mo_{0.75}Nb₁₂O₃₃ | Solid state |
| I9 | Ti_{0.05}W_{0.25}Mo_{0.70}Nb₁₂O_{32.95} | Solid state |
| I10 | Ti_{0.05}Zr_{0.05}W_{0.25}Mo_{0.65}Nb₁₂O_{32.9} | Solid state |
| I11 | Ti_{0.05}Zr_{0.05}W_{0.25}Mo_{0.65}Nb₁₂O_{<32.9} | Solid state |
| I12 | Ti_{0.05}Zr_{0.05}W_{0.25}Mo_{0.65}Nb₁₂O_{32.9} + C | Solid state, spray dry, |
| | | carbon pyrolysis |
| I13 | WNb₁₂O_{33-α} | Solid state |

### Material Synthesis

Samples listed in Table 11 were synthesised using a solid-state route. In a first step, metal oxide precursor commercial powders (Nb₂O₅, NbO₂, MoO₃, ZrO₂, TiO₂, WO₃, V₂O₅, ZrO₂, K₂O, CoO, ZnO and/or MgO) were mixed in stochiometric proportions and planetary ball-milled at 550 rpm for 3 h in a zirconia jar and milling media with a ball to powder ratio of 10:1. The resulting powders were then heated in a static muffle furnace in air in order to form the desired crystal phase. Samples I1 to I5 and I8 to I12 were heat-treated at 900° C. for 12 h; samples I6 to I7 were heat-treated at 1200° C. for 12 h. Sample I3 and I12 were further mixed with a carbohydrate precursor (such as sucrose, maltodextrin or other water-soluble carbohydrates), dispersed in an aqueous slurry at concentrations of 5, 10, 15, or 20 w/w % with ionic surfactant, and spray-dried in a lab-scale spray-drier (inlet temperature 220° C., outlet temperature 95° C., 500 mL/h sample introduction rate). The resulting powder was pyrolyzed at 600° C. for 5 h in nitrogen. Sample I5 and I11 were further annealed in nitrogen at 900° C. for 4 hours.

Sample I13 was prepared by ball milling as above, and impact milling at 20,000 rpm as needed to a particle size distribution with D90<20 μm, heat-treated as in a muffle furnace in air at 1200° C. for 12 h and then further annealed in nitrogen at 1000° C. for 4 h.

### XRD Characterisation of Samples

The phase purity of some samples was analysed using Rigaku Miniflex powder X-ray diffractometer in 26 range (10-70°) at 1°/min scan rate.

FIG. I1 shows the measured XRD diffraction patterns for samples I1, I4, I8, I2, I5, I9, I10, I11, I12 which are relevant to Comparative Study A. All diffraction patterns have peaks at the same locations (within instrument error, that is 0.1°), and match JCPDS crystallography database entry JCPDS 73-1322. There is no amorphous background noise and the peaks are sharp and intense. This means that all samples are phase-pure and crystalline, with crystallite size ˜200 nm according to the Scherrer equation and crystal structure matching MoNb₁₂O₃₃.

FIG. I2 shows the measured XRD diffraction patterns for samples I6 and I7. All diffraction patterns have peaks at the same locations (within instrument error, that is 0.1°), and match JCPDS crystallography database entry JCPDS 73-1322. There is no amorphous background noise and the peaks are sharp and intense. This means that all samples are phase-pure and crystalline, with crystallite size ˜200 nm according to the Scherrer equation and crystal structure matching WNb₁₂O₃₃.

### Qualitative Assessment of Oxygen Deficiency

As discussed above, sample I5 and I11 were heat-treated at 900° C. for 12 h to form the active electrode material, and was then further annealed in nitrogen (a reducing atmosphere) at 900° C., in a post-processing heat treatment step. A colour change from white to dark purple was observed after the post-processing heat treatment in nitrogen, indicating change in oxidation states and band structure of the material, as a result of oxygen deficiency of the sample.

Sample I13 was further annealed in nitrogen at 1000° C. for 4 h. Sample I6 transitions from off-white to light blue in I13.

### Electrochemical Testing of Samples

Electrochemical tests were carried out in half-coin cells (CR2032 size) for initial analysis. In half-coin tests, the material is tested in an electrode versus a Li metal electrode to assess its fundamental performance. In the below reference examples, the active material composition to be tested was combined with N-Methyl Pyrrolidone (NMP), carbon black acting as a conductive additive, and poly(vinyldifluoride) (PVDF) binder and mixed to form a slurry using a lab-scale centrifugal planetary mixer (although it is also possible to form aqueous slurries by using water rather than NMP). The non-NMP composition of the slurries was 80 w.% active material, 10 w.% conductive additive, 10 w.% binder. The slurry was then coated on an Al foil current collector to the desired loading of 1 mg/cm² by doctor blade coating and dried in a vacuum oven for 12 hours. Electrodes were punched out at the desired size and combined with a separator (Celgard porous PP/PE), Li metal, and electrolyte (1 M LiPF₆ in EC/DEC) inside a steel coin cell casing and sealed under pressure. Formation cycling was then carried out at low current rates (C/20) for 2 full charge and discharge cycles. After formation, further cycling can be carried out at a fixed or varied current density as required. These tests have been termed “half-cell galvanostatic cycling” for future reference. Homogeneous, smooth coatings on current collector foil, the coatings being free of visible defects were also prepared as above with a centrifugal planetary mixer to a composition of 94 w.% active material, 4 w.% conductive additive, 2 w.% binder. The coatings were calendared at 80° C. to a density of up to 3.0 g/cm³ at loadings of 1.3-1.7 mAh/cm² in order to demonstrate possible volumetric capacities >700 mAh/cm³ in the voltage range 0.7-3.0 V at C/20, and >640 mAh/cm³ in the voltage range 1.1-3.0 V at C/5. This is an important demonstration of these materials being viable in a commercially focussed electrode power cell formulation, where retaining performance after calendaring to a high electrode density allows for high volumetric capacities. Loadings of up to and including 1.0, 1.5, 2.0, 2.5, or 3.0 mAh/cm² may be useful for Li-ion cells focussed on power performance; loadings greater than 3.0, 4.0, or 5.0 mAh/cm² are useful for energy-focussed performance in Li ion cells. Calendaring of these materials was demonstrated down to electrode porosity values of 35%, and typically in the range 35-40%; defined as measured electrode density divided by the average of the true densities of each electrode component adjusted to their w/w %. Some of the data obtained for the Further Reference Examples related to Formula 4 may not have been obtained under identical conditions to the data obtained for the Reference Examples. Therefore, the absolute values obtained for the Reference Examples and the Further Reference Examples may not be directly comparable.

Electrical conductivity of electrodes made with the samples listed in Table 11 was measured using a 4-point probe thin film resistance measurement apparatus. Slurries were formulated according to the procedure described above and coated on a dielectric mylar film at a loading of 1 mg/cm². Electrode-sized discs where then punched out and resistance of the coated-film was measured using a 4-point probe. Bulk resistivity can be calculated from measured resistance using the following equation:

$$( 3 )$$

$$Bulk resistivity ( ρ ) = 2 π s ( V / I ) ; R = V / I ; s = 0.1 cm = 2 π \times 0.1 \times R ( Ω )$$

The results of this test are shown in Table I2, below:

TABLE I2
Summary of 4-point probe resistivity measurement
results for samples I1, I2, I4, I5 and I8 to I12.

| Sample | Resistance [kΩ] | Bulk resistivity [kΩ · cm] |
|---|---|---|
| I1* | 8.5 | 5.3 |
| I2 | 1.7 | 1.1 |
| I4 | 3.2 | 2.0 |
| I5 | 0.52 | 0.33 |
| I8 | 2.7 | 1.7 |
| I9 | 1.2 | 0.75 |
| I10 | 1.3 | 0.82 |
| I11 | 0.89 | 0.56 |
| I12 | 0.33 | 0.21 |

The results of this test are shown in Table I3, below:

TABLE I3
Summary of DCIR/ASI measurement results
for samples I1, I2, I4, I8, I10-I12.

| Sample | ASI/Ω · cm² |
|---|---|
| I1* | 141 |
| I2 | 125 |
| I4 | 120 |
| I8 | 99 |
| I10 | 74 |
| I11 | 75 |
| I12 | 121 |

The reversible specific capacity C/20, initial coulombic efficiency, nominal lithiation voltage vs Li/Li+ at C/20, 5C/0.5C capacity retention, and 10C/0.5C capacity retention for a number of samples were also tested, the results being set out in Table I4, below. Nominal lithiation voltage vs Li/Li+ has been calculated from the integral of the V/Q curve divided by the total capacity on the 2^{nd} cycle C/20 lithiation. Capacity retention at 10C and 5C has been calculated by taking the specific capacity at 10C or 5C, and dividing it by the specific capacity at 0.5C. It should be noted that the capacity retention was tested with symmetric cycling tests, with equivalent C-rate on lithiation and de-lithiation. Upon testing with an asymmetric cycling program, 10C/0.5C capacity retention greater than 89% is routinely observed.

TABLE I4
Summary of electrochemical testing results from Li-ion half coin
cells using a number of samples. In general (although not exclusively)
it is beneficial to have a higher capacity, a higher ICE, a lower
nominal voltage, and higher capacity retentions.

| | Reversible | | | | |
|---|---|---|---|---|---|
| | specific | Initial | Nominal | 5 C/0.5 C | 10 C/0.5 C |
| | capacity | coulombic | lithiation | capacity | capacity |
| | C/20 | efficiency | voltage vs | retention | retention |
| Sample | [mAh/g] | [%] | Li/Li⁺ [V] | [%] | [%] |
| I1* | 214 | 87.8 | 1.61 | 62 | 35 |
| I2 | 240 | 90.9 | 1.61 | 64 | 45 |
| I3 | 203 | 84.9 | 1.58 | 79 | 68 |
| I4 | 286 | 90.7 | 1.59 | 68 | 54 |
| I5 | 253 | 86.0 | 1.60 | 63 | 43 |
| I6* | 192 | 82.0 | 1.60 | 54 | 36 |
| I7 | 188 | 86.8 | 1.61 | 64 | 54 |
| I8 | 278 | 91.0 | 1.59 | | |
| I9 | 228 | 89.2 | 1.59 | | |
| I10 | 281 | 90.8 | 1.58 | 72 | 58 |
| I11 | 228 | 90.1 | 1.59 | 84 | 68 |
| I12 | 267 | 86.9 | 1.57 | 71 | 62 |

The modification of MoNb₁₂O₃₃ and WNb₁₂O₃₃ as shown above demonstrates the applicability of cation substitution improve active material performance in Li-ion cells. By substituting the non-Nb cation to form a mixed cation structure as described, the entropy (cf disorder) can increase in the crystal structure, reducing potential energy barriers to Li ion diffusion through minor defect introduction (e.g. I10). Modification by creating mixed cation structures that retain the same overall oxidation state demonstrate the potential improvements by altering ionic radii, for example replacement of an Mo⁶⁺ cation with W⁶⁺ in sample I8, which can cause minor changes in crystal parameters and Li-ion cavities (e.g. tuning the reversibility of Type VI cavities in Wadsley-Roth structures) that can improve specific capacity, Li-ion diffusion, and increase Coulombic efficiencies of cycling by reducing Li ion trapping. Modification by creating mixed cation structures that result in increased oxidation state is expected to demonstrate similar potential advantages with altered ionic radii relating to capacity and efficiency, compounded by introduction of additional electron holes in the structure to aid in electrical conductivity. Modification by creating mixed cation structures that result in decreased oxidation state (e.g. Ti⁴⁺ to replace Mo⁶⁺ in sample I2) demonstrate similar potential advantages with altered ionic radii relating to capacity and efficiency, compounded by introduction of oxygen vacancies and additional electrons in the structure to aid in electrical conductivity. Modification by inducing oxygen deficiency from high temperature treatment in inert or reducing conditions demonstrate the loss of a small proportion of oxygen from the structure, providing a reduced structure of much improved electrical conductivity (e.g. sample I5) and improved electrochemical properties such as capacity retention at high C-rates (e.g. sample I5). Combination of mixed cation structures and induced oxygen deficiency allows multiple beneficial effects (e.g. increased specific capacity, reduced electrical resistance) to be compounded (e.g. sample I11).

The complex metal oxide sample I10 demonstrates improved specific capacity as compared to its unmodified crystals sample I1. This is due to the cations that are included in the complex structures increasing the number of sites in the crystal that Li ions can accommodate due to their differing ionic radii and oxidation states, thus increasing capacity. An increase in ICE was observed between samples I1 and I10 which further demonstrates that Li ions intercalated in the modified crystal structure can be more efficiently delithiated as the Li ion sites are modified to enable their de-intercalation.

Across all materials tested, each modified material demonstrates an improvement versus the unmodified ‘base’ crystal structure. This is inferred from measurements of resistivity/impedance by two different methods, and also electrochemical tests carried out in Li-ion half coin cells, particularly the capacity retention at increased current densities (cf. rates, Table I4). Without wishing to be bound by theory, the inventors suggest that this is a result of increased ionic and electronic conductivity of the materials as defects are introduced, or by alterations to the crystal lattice by varying ionic radii; also evidenced by DCIR/ASI (Table I3) measurements to show decreased resistance or impedance upon material modification. Li-ion diffusion rates likely also increase in modified materials as compared with the unmodified ‘base’ materials. Specific capacities themselves may also increase in some cases as shown in Table I4, as doping/exchange with metal ions of different sizes can expand or contract the crystal lattice and allow for more intercalation or more reversibility of intercalation of Li-ions than possible in the unmodified structure.

The data in Table I2 show a large reduction in the resistivity between sample I1 (comparative) and samples I2, I4, I5, I8, I9, I10, I11, I12, demonstrating the effect of the modification on improving electrical conductivity of the crystal structures through both cation exchange, oxygen deficiencies, and carbon coating.

The data in Table I3 shows a large reduction in the DCIR/ASI from sample I1 (comparative) to samples I2, I4, I8, I10, I11 and I12, reflecting the trends shown in Table I2.

In Table I4, across most samples there is a trend for improved specific capacities, initial Coulombic efficiencies (ICE), nominal lithiation voltage vs Li/Li⁺, and capacity retention at 5C and 10C vs 0.5C for modified materials versus the comparative ‘base’ materials (e.g. samples I1, I8). For example samples I2, I3, I4, I5, I8, I9, I10, I11, I12 all demonstrate improvements in one or more of these parameters vs sample I1. This is also the case for sample I7 versus I6 where ICE and capacity retention are improved.

1. An electrochemical cell comprising an anode, a cathode, and an electrolyte disposed between the anode and cathode;
wherein the anode comprises an oxide comprising niobium as an active anode material, wherein the crystal structure of the oxide comprising niobium corresponds to the crystal structure of M^{II}₂Nb₃₄O₈₇, M^{III}Nb₁₁O₂₉, M^{III}Nb₄₉O₁₂₄, M^{IV}Nb₂₄O₆₂, M^{V}Nb₉O₂₅, M^{VI}Nb₁₂O₃₃, H—Nb₂O₅, or N—Nb₂O₅;
wherein the cell has an N/P ratio >1, wherein N/P is defined as:
$$\frac{\begin{matrix}areal loading ( {mgcm}^{- 2} ) ( anode ) \times active fraction ( wt \% ) ( anode ) \times \\ first lithiation capacity ( {mAhg}^{- 1} ) ( anode )\end{matrix}}{\begin{matrix}areal loading ( {mgcm}^{- 2} ) ( cathode ) \times active fraction ( wt \% ) \\ ( cathode ) \times first delithiation capacity ( {mAhg}^{- 1} ) ( cathode )\end{matrix}}$$
wherein:
areal loading (mgcm⁻²) is the dry loading of the electrode composition, not taking into account the current collector;
active fraction (wt %) is the percentage of the dry electrode composition that is active material;
first lithiation/delithiation capacity (mAhg⁻¹) is the specific capacity at C/10 at 25° C. for the first lithiation cycle for the anode or the first delithiation cycle for the cathode measured on an equivalent half-cell with a Li-metal counter electrode.

2. The electrochemical cell of claim 1, wherein the N/P ratio is >1-2, or 1.01-1.5, or 1.05-1.3.

3. The electrochemical cell of claim 1, wherein the crystal structure of the oxide comprising niobium corresponds to the crystal structure of M^{II}₂Nb₃₄O₈₇, M^{III}Nb₁₁O₂₉, M^{V}Nb₉O₂₅, or H—Nb₂O₅; or corresponds to the crystal structure of M^{II}₂Nb₃₄O₈₇, M^{III}Nb₁₁O₂₉, or H—Nb₂O₅; or corresponds to the crystal structure of M^{II}₂Nb₃₄O₈₇.

4. The electrochemical cell of claim 1, wherein the oxide comprising niobium forms at least 10 wt. %, 50 wt. %, or 75 wt. % of the total active anode material in the anode.

5. The electrochemical cell of claim 1, wherein the anode comprises a further active anode material; wherein the further active anode material is selected from lithium titanium oxide, titanium niobium oxide, a different oxide comprising niobium, graphite, hard carbon, soft carbon, silicon, doped and/or carbon-coated versions thereof, and mixtures thereof.

6. The electrochemical cell of claim 1, wherein the oxide comprising niobium is the sole active anode material in the anode.

7. The electrochemical cell of claim 1, wherein the cathode comprises an active cathode material; wherein the active cathode material is selected from nickel-based layered oxides of the class LiNi₁₋ₓMₓO₂ where M=Co, Mn, Al such as NMCs—lithium nickel manganese cobalt oxides, NCAs—lithium cobalt aluminium oxides, and LCOs—lithium cobalt oxides; and LNMOs—lithium nickel manganese oxides.

8. The electrochemical cell of claim 1, wherein the oxide comprising niobium has the formula M1ₐM2₂₋ₐM3_{b}Nb_{34-b}O_{87-c-d}Q_{d}, wherein:
M1 and M2 are different;
M1 is selected from Mg, Ca, Sr, Y, La, Ce, Ti, Zr, Hf, V, Nb, Ta, Cr, Mo, W, Mn, Fe, Co, Ni, Cu, Zn, Cd, B, Al, Ga, In, Si, Ge, Sn, Pb, P, Sb, Bi and mixtures thereof;
M2 is Zn or Cu;
M3 is selected from Mg, Ca, Sr, Y, La, Ce, Ti, Zr, Hf, V, Ta, Cr, Mo, W, Mn, Fe, Co, Ni, Cu, Zn, Cd, B, Al, Ga, In, Si, Ge, Sn, Pb, P, Sb, Bi, and mixtures thereof;
Q is selected from F, Cl, Br, I, N, S, Se, and mixtures thereof;
0≤a≤1.0; 0≤b≤3.4; −0.5≤c≤4.35; 0≤d≤4.35;
one or more of a, b, c, and d does not equal 0; and
when a, b, and d equal zero, c is greater than zero.

9. The electrochemical cell of claim 8, wherein the oxide comprising niobium has the formula M1ₐZn₂₋ₐM3_{b}Nb_{34-b}O_{87-c}, wherein:
M1 is selected from Mg, Zr, V, Cr, Mo, W, Fe, Cu, Al, Ge, P, and mixtures thereof;
M3 is selected from Ti, Zr, V, Cr, Mo, W, Fe, Cu, Zn, Al, P, and mixtures thereof;
0<a<1.0; 0<b≤3.4; −0.5≤c≤4.35.

10. The electrochemical cell of claim 8, wherein the oxide comprising niobium has the formula M1ₐM2₂₋ₐM3_{b}Nb_{34-b}O_{87-c}, wherein:
M1 is selected from Cr, Al, Ge, and mixtures thereof;
M2 is Zn or Cu;
M3 is selected from Ti, Zr, Fe, and mixtures thereof;
0<a<1.0;
0<b≤1.5;
−0.5≤c≤4.35.

11. The electrochemical cell of claim 8, wherein the oxide comprising niobium has the formula CrₐZn₂₋ₐM3_{b}Nb_{34-b}O_{87-c}, wherein:
M3 is selected from Ti, Zr, and mixtures thereof;
0.01<a<1.0;
0.01<b<1.0;
−0.5≤c≤2.

12. The electrochemical cell of claim 1, wherein the oxide comprising niobium has the formula M4ₐAl₁₋ₐM5_{b}Nb_{11-b}O_{29-c-d}Q_{d}, wherein:
M4 is selected from Mg, Ca, Sr, Y, La, Ce, Zr, Hf, V, Nb, Ta, Cr, Mo, W, Mn, Fe, Co, Ni, Cu, Zn, Cd, B, Ga, In, Si, Ge, Sn, Pb, P, Sb, Bi and mixtures thereof;
M5 is selected from Mg, Ca, Sr, Y, La, Ce, Zr, Hf, V, Ta, Cr, Mo, W, Mn, Fe, Co, Ni, Cu, Zn, Cd, B, Al, Ga, In, Si, Ge, Sn, Pb, P, Sb, Bi, and mixtures thereof;
Q is selected from F, Cl, Br, I, N, S, Se, and mixtures thereof;
0≤a<0.5; 0≤b≤1; −0.5≤c≤1.45; 0≤d≤1.45;
one or more of a, b, and d does not equal 0.

13. The electrochemical cell of claim 12, wherein the oxide comprising niobium has the formula M4ₐAl₁₋ₐNb₁₁O_{29-c-d}Q_{d}, wherein:
M4 is selected from Mg, Zr, V, Cr, Mo, W, Mn, Fe, Co, Ni, Cu, Zn, B, Ga, Si, Ge, P, and mixtures thereof;
Q is selected from F, N, and mixtures thereof;
0<a<0.5; 0≤c≤1.45; 0≤d≤1.45.

14. The electrochemical cell of claim 1, wherein the oxide comprising niobium has the formula M6ₐPₓ₋ₐM7_{b}Nb_{9-b}O_{25-c-d}Q_{d}, wherein:
M6 is selected from Na, K, Mg, Ca, Sr, Y, Ti, Zr, Hf, V, Nb, Ta, Cr, Mo, W, Mn, Fe, Co, Ni, Cu, Zn, B, Al, Ga, Si, Ge, Sn, Bi, Sb, and mixtures thereof;
M7 is selected from Na, K, Mg, Ca, Sr, Y, Ti, Zr, Hf, V, Ta, Cr, Mo, W, Mn, Fe, Co, Ni, Cu, Zn, B, Al, Ga, Si, Ge, Sn, Bi, P, Sb, and mixtures thereof;
Q is selected from F, Cl, Br, I, N, S, Se, and mixtures thereof;
0≤a≤0.5; 0≤b≤2; −0.5≤c≤1.25; 0≤d≤5; 1≤x≤2;
one or more of a, b, c, and d does not equal 0;
with the proviso that if M6 consists of Nb and if M7 consists of P then c is >0.

15. The electrochemical cell of claim 14, wherein the oxide comprising niobium has the formula M6ₐP₁₋ₐM7_{b}Nb_{9-b}O_{25-c-d}Q_{d}, wherein:
M6 is selected from Ti, Zr, Hf, Cr, Mo, W, B, Al, Ga, Ge, Bi, Sb, and mixtures thereof;
M7 is selected from Ti, Zr, Hf, Cr, Mo, W, V, Ta, Ga, Ge, and mixtures thereof;
Q is selected from F, N, and mixtures thereof;
0≤a≤0.2; 0≤b≤1; 0≤c≤1.25; 0≤d≤2.5;
wherein at least one of a and b is >0.

16. The electrochemical cell of claim 1, wherein the oxide comprising niobium has the formula M8ₐM9₁₋ₐM10_{b}Nb_{12-b}O_{33-c-d}Q_{d} wherein:
M8 and M9 are different;
M8 is selected from Mg, Ca, Sr, Y, La, Ce, Ti, Zr, Hf, V, Nb, Ta, Cr, Mo, W, Mn, Fe, Co, Ni, Cu, Zn, Cd, B, Al, Ga, In, Si, Ge, Sn, Pb, P, Sb, Bi and mixtures thereof;
M9 is Mo or W;
M10 is selected from Mg, Ca, Sr, Y, La, Ce, Ti, Zr, Hf, V, Ta, Cr, Mo, W, Mn, Fe, Co, Ni, Cu, Zn, Cd, B, Al, Ga, In, Si, Ge, Sn, Pb, P, Sb, Bi, and mixtures thereof;
Q is selected from F, Cl, Br, I, N, S, Se, and mixtures thereof;
0≤a≤0.5; 0≤b≤2; −0.5≤c≤1.65; 0≤d≤1.65;
one or more of a, b, c and d does not equal zero; and
when a, b, and d equal zero, c is greater than zero.

17. The electrochemical cell of claim 16, wherein the oxide comprising niobium has the formula M8ₐM9₁₋ₐM10_{b}Nb_{12-b}O_{33-c-d}Q_{d}, wherein:
M8 and M9 are different;
M8 is selected from Ti, Zr, V, Cr, Mo, W, Fe, Cu, Zn, Al, P, and mixtures thereof;
M9 is Mo or W;
M10 is selected from Ti, Zr, V, Cr, Mo, W, Fe, Cu, Zn, Al, P, and mixtures thereof;
Q is selected from F, N, and mixtures thereof;
0<a≤0.45; 0≤b≤0.2; −0.25≤c≤1.65; 0≤d≤0.8.

18. The electrochemical cell of claim 1, wherein the oxide comprising niobium is H—Nb₂O₅.

19. The electrochemical cell of claim 1, wherein the electrochemical cell is a metal-ion battery; optionally a lithium-ion or a sodium-ion battery.
